(19) United States
(12) Patent Application Publication
(10) Pub. No.: US 2009/0058069 A1
(43) Pub. Date: Mar. 5, 2009

(54) FILE

(75) Inventors: Kanji TANAKA, Ashiya-shi (JP); Yoshiteru ARIMOTO, Hannan-shi (JP); Mitsunori MAEDA, Amagasaki-shi (JP)

Correspondence Address: OKADA;C/O KEATING & BENNETT, LLP, 1800 Alexander Bell Drive, SUITE 200, Reston, VA, 20191, US

(73) Assignee: LIHIT LAB., INC, Osaka-shi (JP)

(21) Appl. No.: 12/202,503

(22) Filed: Sep. 2, 2008

(30) Foreign Application Priority Data
Sep. 4, 2007 (JP) 2007-229449
Oct. 26, 2007 (JP) 2007-278860

(51) Int. Cl. B42D 1/04

(52) U.S. Cl. 281/27.1

(57) ABSTRACT

The file includes a binding body which is superimposed with a plurality of binding sheets, a curved retaining portion which is curved toward the direction of the pocket sheets as the binding body extending when opened the cover, a curved subsidiary portion which fixes its back into an optional form; the binding body is adjacently provided to the curved retaining portion by forming an arch-shape toward the direction of a front cover portion and back cover portion extending from the inner side of the spine portion and the curved retaining portion is connected with the width shorter than the width of the spine portion to the inner side of the curved subsidiary portion at the outer side of the curved retaining portion to enable the end edge adjacently provided on the binding body to curve.

### BACKGROUND OF THE INVENTION

1. Field of the Invention

This invention relates to files especially files with the front cover portion and the back cover portion adjacently provided on both sides of the spine portion and with the clear pockets fastened between the front cover portion and the back cover portion such as clear books and card albums.

2. Description of the Related Art

Conventionally, a file with clear pockets has pockets formed with clear films. The file with clear pockets is produced in an open state where pockets are welded and fixed to the cover and file binding pockets is produced by melting the central part of a pile of several pockets and welding to the back part of the cover.

In the said file, efficiency of page spread decreases when approaching both ends of the file by a structure of welding a pile. Japanese Patent Application Publication No. 5-32279, Japanese Utility Model Application Publication No. 7-11434, and Japanese Patent Application Publication No. 5-205490 disclose a file comprises a structure with improved uniform spread whether its center or both ends by welding each of pockets to the cover respectively as a method to solve this problem.

A conventional file with pockets increasingly forms a curve from the flat state as spread approaches its center by the thickness of the documents therein even a file with each of the pockets welded to the cover respectively, as a result, efficiency of spread decreases.

### SUMMARY OF THE INVENTION

To overcome the problems described above, preferred embodiments of the present invention provide a file with binding sheets which can be easily spread flat when spreading a binding body.

In accordance with a preferred embodiment of the present invention, a file comprises a binding body which is superimposed with a plurality of binding sheets; a curved retaining portion which is curved toward the direction of the pocket sheets as the binding body extending adhered and connected on the end edge of a group of pocket sheets as the binding body when opened the cover; and a curved subsidiary portion which fixes its back into an optional form in a region on a front cover side and a region on a back cover side of a spine portion between the front cover portion and the back cover portion; and wherein the binding body is adjacently provided to the curved retaining portion by forming an arch-shape toward the direction of a front cover portion and back cover portion extending from the inner side of the spine portion; and wherein the curved retaining portion is connected with the width shorter than the width of the spine portion to the inner side of the curved subsidiary portion at the outer side of the curved retaining portion to enable the end edge adjacently provided on the binding body to curve.

The binding body is preferably superimposed with a plurality of binding sheets and connected on the end edge which is connected to the front cover, wherein the curved retaining portion comprises a front cover portion connected to the cover body between the front cover portion and the back cover portion, wherein the cover body forms a hinge portion between the front cover side and the back cover side, wherein said binding body is formed for the end edge of the group of pocket sheets as the binging body connected to the cover body to curve toward the side of the binding sheets extending when opened the cover body, and wherein said curved subsidiary portion is optionally spaced from the binding body in the cross direction and connected with the width shorter than the width of the spine portion at the outer side of the hinge portion of said front cover portion and the hinge portion of said back cover portion to enable the end edge of the binding body which is connected to the cover to curve.

The curved retaining portion may preferably comprises the hinge portion on the front cover side adjacently provided on the front cover portion; the hinge portion on the back cover side adjacently provided on the back cover portion; and an interjacent connecting portion interposing between said hinge portion on the front cover side and said hinge portion on the back cover side, and wherein said interjacent connecting portion is formed to curve toward the direction of the binding sheets extending along with the end edge of the binging body connected to the cover by its weight when opened the cover body.

The curved retaining portion may preferably comprises the hinge portion on the front cover side connected to the front cover portion, the hinge portion on the back cover side connected to the back cover portion and the interjacent connecting portion interposing between the hinge portion on said front cover side and the hinge portion on said back cover side; and wherein the region on the front cover side leading to the hinge portion on the front cover side and the region on the back cover side leading to the hinge portion on the back cover side bisect at substantially right angles to the interjacent connecting portion when load is not applied and form the interjacent connecting portion toward the direction of the binding sheets as to be lifted with the elasticity adjacent to the hinge portion on the front cover side and the hinge portion on the back cover side when opened the cover.

The height between a folding portion of the curved subsidiary portion and the back cover portion may preferably be formed substantially the equal or shorter than the height between the hinge portion on the front cover side of said curved retaining portion and the inner surface of the curved subsidiary portion and between the hinge portion on the back cover side and the inner surface of the curved subsidiary portion, wherein the hinge portion on the front cover side and the hinge portion on the back cover side are positioned adjacent to the end edge in the cross direction of the back cover portion when closed the cover body, wherein the interjacent connecting portion between the hinge portion on the front cover side and the hinge portion on the back cover side is formed to curve toward the opposite side of the back cover portion when opened the cover body and also the width of between the hinge portion on the front cover side and the hinge portion on the back cover side is formed to be shorter than the width of the back cover portion.

The interjacent connecting portion of the curved retaining portion may preferably be deformed plastically by hot press onto a synthetic resin sheet body and comprises to be bestowed flexibility by reducing its thickness.

The binding body may preferably superimpose the plurality of binding sheets and is connected on the end edge which is connected to the cover, wherein the curved retaining portion is comprised of the end edge connected to said binding body and a connecting body connecting the cover, wherein the cover body has the front cover portion, the back cover portion and the spine portion between said front cover portion and said back cover portion, forms the folding portion formed to be optionally spaced from the spine portion between the front cover portion and the back cover portion, the binding sheets are connected via said connecting body and the curved subsidiary portion is comprised between the folding portion and the spine portion and in the spine portion, wherein said binding body is formed to curve along the end edge of the binging body connected to the cover toward the direction of the binding sheets extending when opened the cover body, and wherein said curved retaining portion is connected adjacent to the folding portion of said front cover portion and the folding portion of said back cover portion with optionally spacing from the binding body in the cross direction to enable the end edge connected to the cover of the binding body with the short width to curve.

The connecting body may preferably comprise a connecting portion on the front cover side connected to the side of the front cover portion, a connecting portion on the back cover side connected to the side of the back cover portion and the interjacent connecting portion interposing between said connecting portion on the front cover side and said connecting portion on the back cover side, wherein

said interjacent connecting portion connects the end edge connected to the cover of the binding body and is formed to curve toward the binding sheets extending along with the end edge connected to the cover of the binding body by tension of the connecting portion on the front cover side and the connecting portion on the back cover side when opened the cover body, and wherein the hinge portion is formed between the connecting portion on the front cover side and the interjacent connecting portion and between the connecting portion on the back cover side and the interjacent connecting portion.

The connecting body may preferably comprise the connecting portion on the front cover side connected to the side of the front cover portion, the connecting portion on the back cover side connected to the side of the back cover portion and the interjacent connecting portion interposing between said connecting portion on the front cover side and the connecting portion on the back cover side, wherein the hinge portion on the front cover side and the hinge portion on the back cover side are formed between the connecting portion on the front cover side and the interjacent connecting portion and between the connecting portion on the back cover side and the interjacent connecting portion, and wherein the connecting portion on the front cover side leading to the hinge portion on the front cover side and the connecting portion on the back cover side leading to the hinge portion on the back cover side bisect at substantially right angles to the interjacent connecting portion when load is not applied and form the interjacent connecting portion toward the direction of the binding sheets as to be lifted with the elasticity adjacent to the hinge portion on the front cover side and the hinge portion on the back cover side when opened the cover.

The height between the folding portion of said front cover portion and the folding portion of said back cover portion may preferably be formed substantially the equal or shorter than the height between the hinge portion on the front cover side of said connecting body and the inner surface of the front cover portion and between the hinge portion on the back cover side and the inner surface of the back cover portion, wherein the hinge portion on the front cover side and the hinge portion on the back cover side are positioned adjacent to the end edge in the cross direction of the back cover portion when closed the cover body, and wherein the interjacent connecting portion between the hinge portion on the front cover side and the hinge portion on the back cover side is formed to curve toward the opposite side of the back cover portion when opened the cover body and also the width of between the hinge portion on the front cover side and the hinge portion on the back cover side is formed to be shorter than the width of the back cover portion.

The interjacent connecting portion of the binding body may preferably be deformed plastically by hot press onto a synthetic resin sheet body and comprises to be bestowed flexibility by reducing its thickness.

The binding sheets may preferably comprise pockets combined with thermoplastic resin sheets, wherein each binding sheet is hot-adhered to another on the end edge connected to the cover thereof, and wherein the end edge connected to the cover is formed to curve inwardly when opened the binding sheets.

The connecting body may preferably comprise the sheet body of rigid body comprising thermoplastic synthetic resin, has through-holes drilled in the region connected to the binding body, and is formed to curve.

According to preferred embodiments of the present invention, a file comprises a binding body which is superimposed with a plurality of binding sheets; a curved retaining portion which is curved toward the direction of the pocket sheets as the binding body extending adhered and connected on the end edge of a group of pocket sheets as the binding body when opened the cover; and a curved subsidiary portion which fixes its back into an optional form in a region on a front cover side and a region on a back cover side of a spine portion between the front cover and the back cover. In this file, the binding body is adjacently provided to the curved retaining portion by forming an arch-shape toward the direction of a front cover portion and back cover portion extending from the inner side of the spine portion and the curved retaining portion is connected with the width shorter than the width of the spine portion to the inner side of the curved subsidiary portion at the outer side of the curved retaining portion to enable the end edge adjacently provided on the binding body to curve. Therefore, the file which can be easily spread flat when spread the binding body can be provided.

The binding body may preferably be superimposed with a plurality of binding sheets and connected on the end edge which is connected to the front cover. In this file, the curved retaining portion comprises a front cover portion connected to the cover body between the front cover portion and the back cover portion, the cover body forms a hinge portion between the front cover side and the back cover side, the binding body is formed for the end edge of the group of pocket sheets as the binging body connected to the cover body to curve toward the side of the binding sheets extending when opened the cover body, and the curved subsidiary portion is optionally spaced from the binding body in the cross direction and connected with the width shorter than the width of the spine portion at the outer side of the hinge portion of the front cover portion and the hinge portion of the back cover portion to enable the end edge of the binding body which is connected to the cover to curve. Therefore, the file which can be easily spread flat when spread the binding body can be provided.

The curved retaining portion may preferably comprise the hinge portion on the front cover side adjacently provided on the front cover portion, the hinge portion on the back cover side adjacently provided on the back cover portion, and an interjacent connecting portion interposing between the hinge portion on the front cover side and the hinge portion on the back cover side, and the intervenient assembly is formed to curve toward the direction of the binding sheets extending along with the end edge of the binging body connected to the cover by its weight when opened the cover body. Therefore, the file, which can be easily spread flat when spread the binding body by expanding the portion adjacently provided to the interjacent connecting portion of the binding body, can be provided.

The curved retaining portion may preferably comprise the hinge portion on the front cover side connected to the front cover portion, the hinge portion on the back cover side connected to the back cover portion and the interjacent connecting portion interposing between the hinge portion on the front cover side and the hinge portion on the back cover side, and the region on the front cover side leading to the hinge portion on the front cover side and the region on the back cover side leading to the hinge portion on the back cover side bisect at substantially right angles to the interjacent connecting portion when load is not applied and form the interjacent connecting portion toward the direction of the binding sheets as to be lifted with the elasticity adjacent to the hinge portion on the front cover side and the hinge portion on the back cover side when opened the cover. Therefore, the binding sheets can be easily spread flat when spread the binding body by curving the curved retaining portion toward the opposite side of the spine portion and expanding the portion adjacently provided to the curved retaining portion of the binding body.

The height between a folding portion of the curved subsidiary portion and the back cover portion may preferably be formed substantially the equal or shorter than the height between the hinge portion on the front cover side of the curved retaining portion and the inner surface of the curved subsidiary portion and between the hinge portion on the back cover side and the inner surface of the curved subsidiary portion, and the hinge portion on the front cover side and the hinge portion on the back cover side are positioned adjacent to the end edge in the cross direction of the back cover portion when closed the cover body. In this file, the interjacent connecting portion interposing between the hinge portion on the front cover side and the hinge portion on the back cover side is formed to curve toward the opposite side of the back cover portion when opened the cover body and also the width of between the hinge portion on the front cover side and the hinge portion on the back cover side is formed to be shorter than the width of the back cover portion. Therefore, the binding sheets can be easily spread flat when spread the binding body by curving the curved retaining portion toward the opposite side of the spine portion and expanding the portion adjacently provided to the curved retaining portion of the binding body.

The interjacent connecting portion of the curved retaining portion may preferably be deformed plastically by hot press onto a synthetic resin sheet body and comprises to be bestowed flexibility by reducing its thickness. By partially processing a region of the interjacent connecting portion, flexibility of the region can easily increase.

The binding body may preferably superimpose the plurality of binding sheets and is connected on the end edge which is connected to the cover, and the curved retaining portion is comprised of the end edge connected to the binding body and a connecting body connecting the cover. In this file, the cover body has the front cover portion, the back cover portion and the spine portion between the front cover portion and the back cover portion, forms the folding portion formed to be optionally spaced from the spine portion between the front cover portion and the back cover portion, the binding sheets are connected via said connecting body and the curved subsidiary portion is comprised between the folding portion and the spine portion and in the spine portion; the binding body is formed to curve along the end edge of the binging body connected to the cover toward the direction of the binding sheets extending when opened the cover body; and the curved retaining portion is connected adjacent to the folding portion of the front cover portion and the folding portion of the back cover portion with optionally spacing from the binding body in the cross direction to enable the end edge connected to the cover of the binding body with the short width to curve. Therefore, the binding sheets can be easily spread flat when spread the binding body by curving the curved retaining portion toward the opposite side of the spine portion and expanding the portion adjacently provided to the curved retaining portion of the binding body.

The connecting body may preferably comprise a connecting portion on the front cover side connected to the side of the front cover portion, a connecting portion on the back cover side connected to the side of the back cover portion and the interjacent connecting portion interposing between the connecting portion on the front cover side and the connecting portion on the back cover side; the interjacent connecting portion connects the end edge connected to the cover of the binding body and is formed to curve toward the binding sheets extending along with the end edge connected to the cover of the binding body by tension of the connecting portion on the front cover side and the connecting portion on the back cover side when opened the cover body; and the hinge portion is formed between the connecting portion on the front cover side and the interjacent connecting portion and between the connecting portion on the back cover side and the interjacent connecting portion. Therefore, the binding sheets can be easily spread flat when spread the binding body by expanding the portion adjacently provided to the interjacent connecting potion of the binding body.

The connecting body may preferably comprise the connecting portion on the front cover side connected to the side of the front cover portion, the connecting portion on the back cover side connected to the side of the back cover portion and the interjacent connecting portion interposing between said connecting portion on the front cover side and the connecting portion on the back cover side; the hinge portion on the front cover side and the hinge portion on the back cover side are formed between the connecting portion on the front cover side and the interjacent connecting portion and between the connecting portion on the back cover side and the interjacent connecting portion; and the connecting portion on the front cover side leading to the hinge portion on the front cover side and the connecting portion on the back cover side leading to the hinge portion on the back cover side bisect at substantially right angles to the interjacent connecting portion when load is not applied and form the interjacent connecting portion toward the direction of the binding sheets as to be lifted with the elasticity adjacent to the hinge portion on the front cover side and the hinge portion on the back cover side when opened the cover. Therefore, the binding sheets can be easily spread flat when spread the binding body by curving the interjacent connecting portion toward the opposite side of a spine portion and expanding the portion adjacently provided to the interjacent connecting portion of the binding body.

The height between the folding portion of the front cover portion and the folding portion of the back cover portion may preferably be formed substantially the equal or shorter than the height between the hinge portion on the front cover side of the connecting body and the inner surface of the front cover portion and between the hinge portion on the back cover side and the inner surface of the back cover portion; the hinge portion on the front cover side and the hinge portion on the back cover side are positioned adjacent to the end edge in the cross direction of the back cover portion when closed the cover body; and the interjacent connecting portion between the hinge portion on the front cover side and the hinge portion on the back cover side is formed to curve toward the opposite side of the back cover portion when opened the cover body and also the width of between the hinge portion on the front cover side and the hinge portion on the back cover side is formed to be shorter than the width of the back cover portion. Therefore, the binding sheets can be easily spread flat when spread the binding body by curving the connecting body toward the opposite side of the spine portion and expanding the portion adjacently provided to the curved retaining portion of the binding body.

The interjacent connecting portion of the binding body may preferably be deformed plastically by hot press onto a synthetic resin sheet body and comprises to be bestowed flexibility by reducing its thickness. By partially processing a region of the interjacent connecting portion, flexibility of the region can easily increase.

According to claim 12 of the present invention, the binding sheets comprise pockets combined with thermoplastic resin sheets; each binding sheet is hot-adhered to another on the end edge connected to the cover thereof, and the end edge connected to the cover is formed to curve inwardly when opened the binding sheets. Therefore, the binding sheets can be easily spread flat when spread the binding body by expanding the connecting portion of the binding body adjacently provided to the curved retaining portion.

The connecting body may preferably comprise the sheet body of rigid body comprising thermoplastic synthetic resin, has through-holes drilled in the region connected to the binding body, and is formed to curve. Therefore, the binding sheets can be easily spread flat when spread the binding body by expanding the connecting portion of the binding body adjacently provided to the connecting body.

The above and other objects, features, and advantages of this invention will become more readily apparent from the following description of detailed description of preferred embodiments with reference to the accompanying drawings

In this specification and scope of the claims, the terms generally used are adopted for the cover height of the file and the cover width of the spine and the width of the spine; H is for the cover height, W is for the cover width and T, for the width of the spine in FIG. 66 for your reference.

Other features, elements, steps, characteristics and advantages of the present invention will become more apparent from the following detailed description of preferred embodiments of the present invention with reference to the attached drawings.

### BRIEF DESCRIPTION OF THE DRAWINGS

FIG. 1 is a schematic perspective view of a pocket file in accordance with an embodiment of the present invention;

FIG. 2 is a schematic perspective view, of the file of FIG. 1 in an opened state;

FIG. 3 is a schematic longitudinal sectional view of the file of FIG. 1 in a closed state;

FIG. 4 is a schematic transverse sectional view of the file of FIG. 1 in a closed state;

FIG. 5 is a schematic transverse sectional view of the file of FIG. 1 in an opened state;

FIG. 6 is a schematic perspective view of a method of manufacturing the file of FIG. 1;

FIGS. 7A and 7B are schematic perspective views of the method of manufacturing the file of FIG. 1;

FIG. 8 is a schematic perspective view of the method of manufacturing the file of FIG. 1;

FIG. 9 is a schematic perspective view of the method of manufacturing the file of FIG. 1;

FIG. 10 is a schematic cross-sectional view of the method of manufacturing the file of FIG. 1; in a view, a group of pocket sheets in a preparatory state;

FIG. 11 is a schematic cross-sectional view of the method of manufacturing the file of FIG. 1; in a view, a connecting method of the group of pocket sheets and a connecting body;

FIG. 12 is a schematic cross-sectional view of the method of manufacturing the file of FIG. 1; in a view, the connecting method of the group of pocket sheets and the connecting body;

FIG. 13 is a schematic transverse sectional view of a fastening method of a cover body and the connecting body;

FIG. 14 is a schematic perspective view of the method of manufacturing the file of FIG. 1;

FIG. 15 is a schematic transverse sectional view of an operation of the file of FIG. 1;

FIG. 16 is a modified example of a schematic view of the file of FIG. 1; in a schematic transverse sectional view, a closed state of a cover;

FIG. 17 is a modified example of a schematic view of the file of FIG. 1; in a schematic transverse sectional view, an opened state of the cover;

FIG. 18 is a modified example of a schematic view of the file of FIG. 1, in a schematic transverse sectional view, the closed state of the cover;

FIG. 19 is a modified example of a schematic view of the fir of FIG. 1, in a schematic transverse sectional view, the opened state of the cover;

FIG. 20 is a schematic perspective view of the use of the file of the present invention;

FIG. 21 is a schematic perspective view of the file pocket in an embodiment of the present invention;

FIG. 22 is a schematic perspective view of the pocket file of FIG. 21 in an opened state;

FIG. 23 is a schematic transverse sectional view of the pocket file of FIG. 21 in a closed state;

FIG. 24 is a schematic transverse sectional view of the pocket file of FIG. 21 in the closed state;

FIG. 25 is a schematic transverse sectional view of the pocket file of FIG. 21 in an opened state;

FIG. 26 is a schematic transverse sectional view of the pocket file of FIG. 21 in the opened state;

FIG. 27 is a schematic perspective view of the method of manufacturing the file of FIG. 21;

FIG. 28 is a schematic cross-sectional view of the method of manufacturing the of FIG. 21; in a view, a connecting method of a group of pocket sheets and a curved retaining portion;

FIG. 29 is a schematic cross-sectional view of the method of manufacturing the of FIG. 21; in a view, the connecting method of the group of pocket sheets and the curved retaining portion;

FIG. 30 is a schematic cross-sectional view of the method of manufacturing the of FIG. 21; in a view, the connecting method of the group of pocket sheets and the curved retaining portion;

FIG. 31 is a schematic cross-sectional view of the method of manufacturing the of FIG. 21; in a view, the connecting method of the group of pocket sheets and the curved retaining portion;

FIG. 32 is a schematic cross-sectional view of the method of manufacturing the of FIG. 21; in a view, the connecting method of the group of pocket sheets and the curved retaining portion;

FIG. 33 is a schematic transverse sectional view of a fastening method of the cover and a curved subsidiary portion;

FIG. 34 is a schematic transverse sectional view of an operation of the file of FIG. 21;

FIG. 35 is a schematic perspective view of the pocket file of an embodiment of the present invention;

FIG. 36 is a schematic perspective view of the pocket file of FIG. 35 in an opened state;

FIG. 37 is a schematic transverse sectional view of the pocket file of FIG. 35 in a closed state;

FIG. 38 is a schematic transverse sectional view of the pocket file of FIG. 35 in the closed state;

FIG. 39 is a schematic transverse sectional view of the pocket file of FIG. 35 in an opened state;

FIG. 40 is a schematic transverse sectional view of the pocket file of FIG. 35 in the opened state;

FIG. 41 is a schematic perspective view of a method of manufacturing the file of FIG. 35;

FIG. 42 is a schematic cross-sectional view of a method of manufacturing the file of FIG. 35; a view, a connecting method of the group of pocket sheets and the curved retaining portion;

FIG. 43 is a schematic cross-sectional view of the method of manufacturing the file of FIG. 35; a view, the connecting method of the group of pocket sheets and the curved retaining portion;

FIG. 44 is a schematic cross-sectional view of the method of manufacturing the file of FIG. 35; a view, the connecting method of the group of pocket sheets and the curved retaining portion;

FIG. 45 is a schematic cross-sectional view of the method of manufacturing the file of FIG. 35; a view, the connecting method of the group of pocket sheets and the curved retaining portion;

FIG. 46 is a schematic cross-sectional view of the method of manufacturing the file of FIG. 35; a view, the connecting method of the group of pocket sheets and the curved retaining portion;

FIG. 47A is a schematic transverse sectional view of a formation of the curved retaining portion;

FIG. 47B is a schematic transverse sectional view of an operation of the curved retaining portion;

FIG. 48 is a schematic transverse sectional view of a connecting method of the cover and the curved subsidiary portion;

FIG. 49 is a schematic transverse sectional view of an operation of the file of FIG. 35;

FIG. 50 is a schematic perspective view of the pocket file as a modified example of the file of FIG. 1;

FIG. 51A is a schematic transverse sectional view of the pocket file of FIG. 50 in a closed state;

FIG. 51B is a schematic bottom view of the vicinity of the curved retaining portion showing the operating state of the curved retaining portion;

FIG. 52 is a schematic transverse sectional view of the pocket file of FIG. 50 in an opened state;

FIG. 53 is a schematic perspective view of the pocket file as a modified example of the pocket file of FIG. 21;

FIG. 54A is a schematic transverse sectional view of the pocket file of FIG. 53 in a closed state;

FIG. 54B is a schematic bottom view of the vicinity of the curved retaining portion showing an operating state of the curved retaining portion;

FIG. 55 is a schematic transverse sectional view of the pocket file of FIG. 53 in an opened state;

FIG. 56 is a schematic perspective view of the pocket file as a modified example of the pocket file of FIG. 1;

FIG. 57A is a schematic transverse sectional view of the pocket file of FIG. 56 in an opened state;

FIG. 57B is a schematic bottom view of the vicinity of the curved retaining portion showing an operating state of the curved retaining portion;

FIG. 58 is a schematic transverse sectional view of the pocket file of FIG. 56 in an opened state;

FIG. 59 us a schematic perspective view of the pocket file as a modified example of the pocket file of FIG. 21;

FIG. 60A is a schematic transverse sectional view of the pocket file of FIG. 59 in a close state,

FIG. 60B is a schematic bottom view of the adjacency of the curved retaining portion showing an operating state of the curved retaining portion;

FIG. 61 is a schematic transverse sectional view of the pocket file of 59 in an opened state;

FIG. 62 is a schematic perspective view of the pocket file as a modified example of the pocket file of FIG. 35;

FIG. 63 is a schematic transverse sectional view of the pocket file of FIG. 62 in a closed state;

FIG. 64 is a schematic transverse sectional view of the pocket file of FIG. 62 in an opened state;

FIG. 65 is a schematic perspective view of the method of manufacturing the file of FIG. 62; and

FIG. 66 is an illustration of the file of the present invention.

### DETAILED DESCRIPTION OF PREFERRED EMBODIMENTS

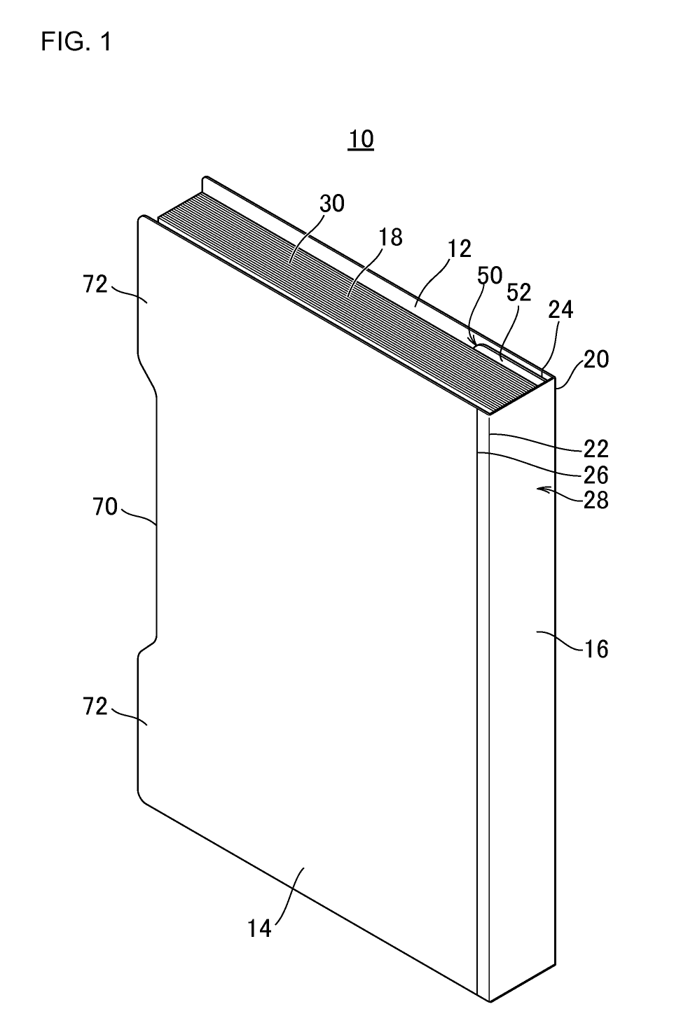

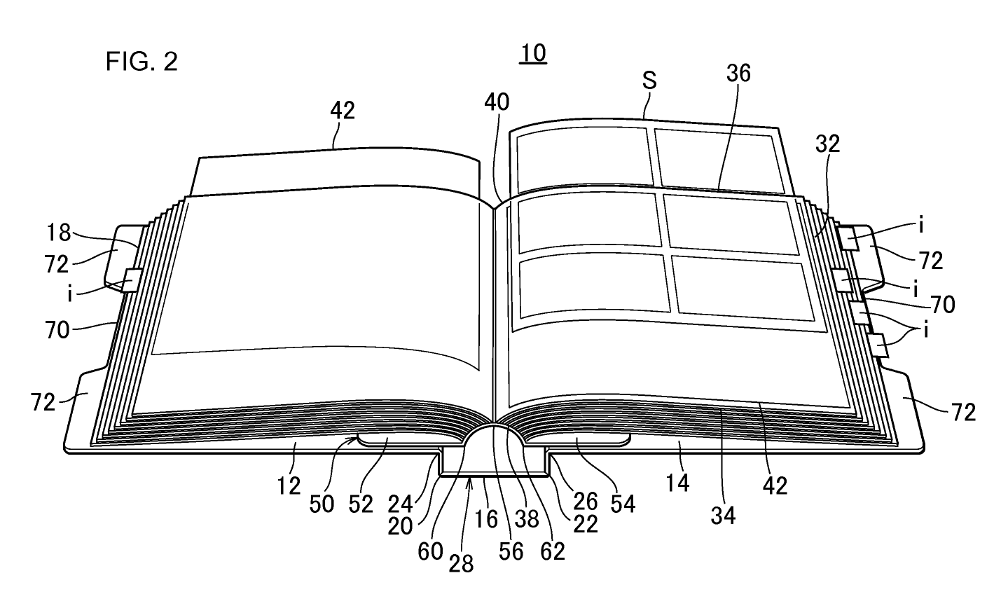

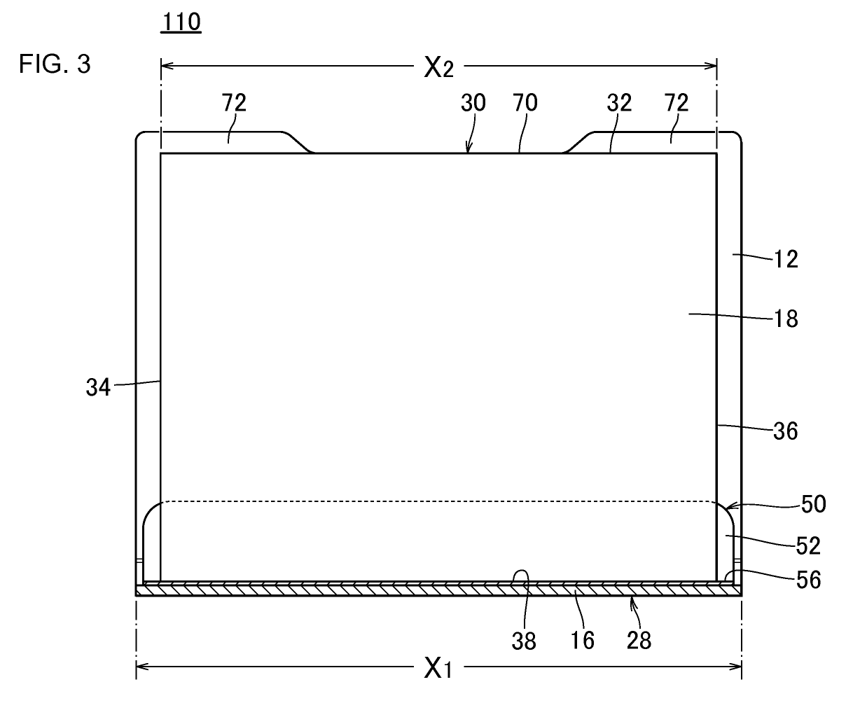

FIG. 1 is a schematic perspective view of a pocket file in accordance with an embodiment of the present invention and FIG. 2 is a schematic perspective view of the pocket file in an opened state as shown in FIG. 1. FIG. 3 is a schematic longitudinal section view of the pocket file in a close state as shown in FIG. 1.

A file 10 comprises a cover body having a front cover portion 12 comprising of synthetic-resin such as polypropylene, a back cover portion 14, and a spine portion 16 adjacently provided between the front cover portion 12 and the back cover portion. A group of pocket sheets 30 as a binding body superimposes a pocket sheet 18 as a binding sheet and is welded and connected to the a connecting end edge of the group of pocket sheets 30 as the binding body by being fastened the group of pocket sheets 30 as the binding body connected at a end edge which is connected to the spine portion 16.

The file 10 comprises a curved retaining portion formed to curve the end edge of the group of pocket sheets 30 as the binding body toward the side of the pocket sheet 18 as the binding sheet extending at the inner side of the spine portion 16 adjacently provided between the front cover portion 12 and the back cover portion 14 when opened the cover and also comprises a curved subsidiary portion which fixes the back of the cover body into an optional form in a region on a front cover side and a region on a back cover side of the spine portion 16 between the front cover portion 12 and the back cover portion 14.

The front cover portion 12 and the back cover portion 14 are adjacently provided the spine portion 16 to cross at a substantially right angle via a linear front adjacently providing portion 20 and a linear back adjacently providing portion 22 crossing from the top edge to the bottom edge in the direction of the height of the front cover portion 12 and the back cover portion 14.

The pocket sheet 18 are flexibly formed between a part where the pocket sheet 18 is fastened to the spine portion 16 and a part above a front folding portion 24 and a back folding portion 26.

The pocket sheet 18 comprises a linear outer end edge 32, a linear bottom edge 34 and a opening edge 36 formed at a top end edge which is opposite from the bottom edge 34 and is connected to the inner surface of the spine portion 16 at an inner end edge 38 opposite from the linear outer end edge 32.

The pocket sheet 18 comprises a pocket portion 40 to accommodate an object to be bound S such as documents and is fitted for a mount 42 extending in the direction away from a part where the spine portion 16 is fastened to be inserted from a part above the front folding portion 24 and the back folding portion 26 in the inner side of the pocket portion 40.

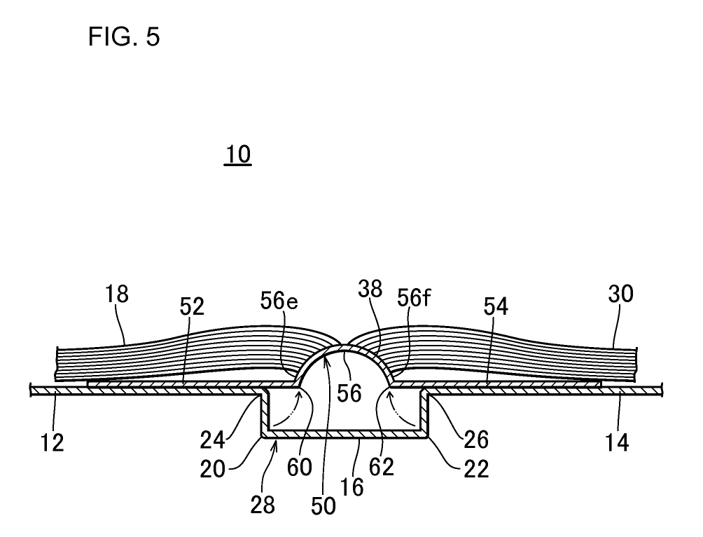

As shown in any one of FIGS. 3 to 6, the font folding portion 24 and the back folding portion 26 crossing from the top edge to the bottom edge are formed adjacent to the front connecting portion 20 and the back connecting portion 22 of the front cover portion 12, the back cover portion 14 and the spine portion 16, and the grip portion 28 is formed in the region from the front folding portion 24 on the front cover portion 12 to the spine portion 16, the region from the back folding portion 26 on the back cover portion 14 to the spine portion 16 and the spine portion 16.

In a grip portion 28, the connecting portion on a front cover side 52 having the front folding portion 24 as an axis sways upwardly in the region on the spine portion 16 on the front cover side between the front cover portion 12 and the back cover portion 14, and the connecting portion on a back cover side 54 having the back folding portion 26 as an axis sways upwardly and the grip portion 28 forms the curved subsidiary portion which enables a connecting portion 50 as a curved subsidiary portion to arch upwardly, i.e. toward the direction away from the spine portion 16, when the front cover portion 12 and the back cover portion 14 become substantially horizontal, and the grip portion 28 becomes parallel to the horizontal spine portion 16.

On the front cover portion 12 and the back cover portion 14, the front folding portion 24 and the back folding portion 26 are formed parallel to the front adjacently providing portion 20 and the back adjacently providing portion 22 in the direction of their heights crossing from the top edge to the bottom edge thereof adjacent to the front adjacently providing portion 20 and the back adjacently providing portion 22.

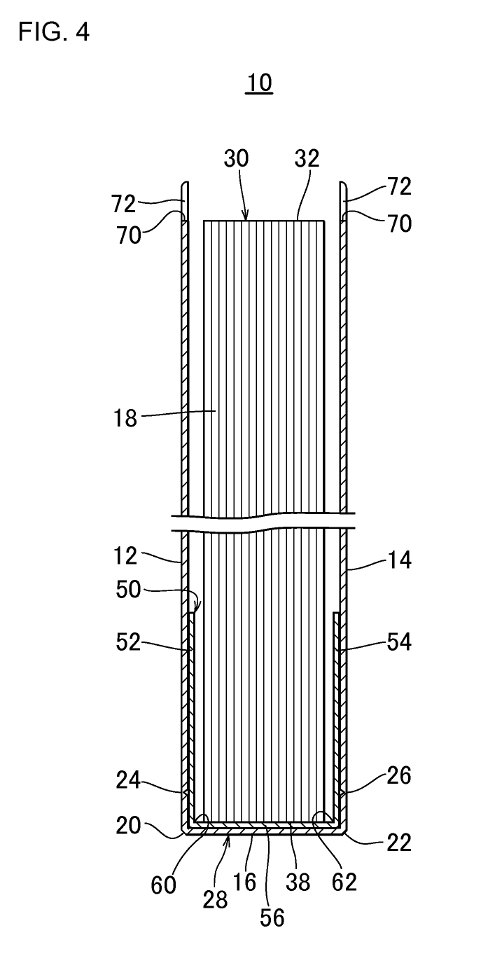

The length of the inner face of the spine portion 16 and the front folding portion 24 and the length of the inner face of the spine portion 16 and the back folding portion 26 are formed to be equal (shown in FIG. 4).

The mount 42 is provided such that the front folding portion 24 and the back folding portion 26 do not present adjacent to the mount 42.

The grip portion 28 has an angular structure such that the user can set the spine portion 16 on his palm, grip the grip portion 28 with his fingers and open the pocket sheet 18.

On the front cover portion 12 and the back cover portion 14, a recess for search 70 is formed on the free end edge opposite side from the spine portion 16, i.e. the left side end edge of the front cover portion 12 and the right side end edge of the back cover portion 14, in the middle of the direction of the height thereof.

The outer end edge of the recess for search 70 and the outer end edge 32 of the pocket sheet 18 are uniformed. Accordingly, with one hand, folding the file 10 with the cover closed, especially gripping the grip portion 28 and placing the other hand on the recess for search 70 enables to flip the front cover portion 12 or the back cover portion 14 and the pocket sheet 18.

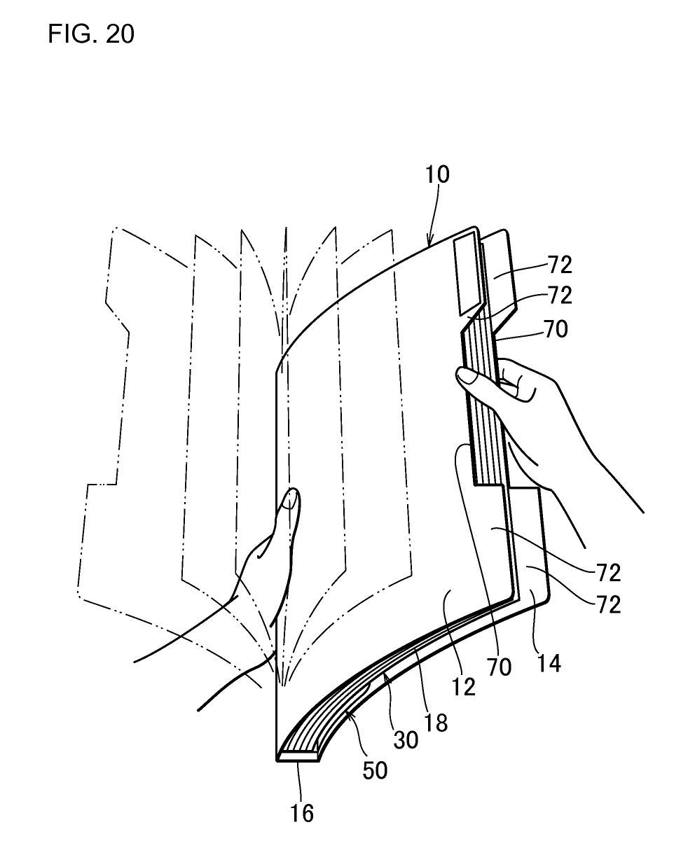

The file 10 can be flipped from the pocket sheet 18 positioned on the upper side to the pocket sheet positioned on the lower side with the user's fingers placed on the outermost part of the outer end edge 32 of the pocket sheet 18 and slightly bend the front cover portion 12 or the back cover portion 14 in the recess for search 70 as shown in FIG. 20.

On the front cover portion 12 and the back cover portion 14, a pair of a projection portion 72 on the upper side and the lower side is formed respectively to cover the index i formed on the pocket sheet 18 such that the projection portion 72 is projected toward the outer side from the end edge for spread, i.e. the outer end edge 32, of the pocket sheet 18 on the outside of the region that the recess portion for search 70 is formed.

The end edge of the group of pocket sheet 30 as the binding body connected to the spine portion 16 when opened the cover body is formed to curve toward the opposite side of the spine portion 16.

The pocket sheet 18 as the binding body comprises pockets combined with thermoplastic resin sheets, each pocket sheet 18 is hot-adhered to another on the end edge connected to the cover thereof, and the end edge connected to the spine portion 16 is formed to curve inwardly when opened the pocket sheet 18.

The group of pocket sheets 30 is connected by the end edge connected thereto and the connecting portion 50 connecting the front cover portion 12 and the back cover portion 14.

The connecting body 50 is comprised of substantially square rigid plate body in a planar view composed of thermoplastic synthetic resin and comprises the curved retaining portion which curves the group of pocket sheets 30 as the binding body, welded and connected at the connecting end edge of the group of pocket sheets 30 as the binding body, toward the direction of the pocket sheet 18 as the binding body extending.

The connecting body 50 is connected adjacent to the front folding portion 24 of the front cover portion 12 and the back folding portion 26 of the back cover portion 14 with optionally spaced from the group of the pocket sheets 30 in the cross direction such that the connecting body 50 enables the end edge connected to the cover of the group of pocket sheet 30 to curve with the width shorter than the width of the spine portion 16 of the cover body.

The connecting body 50 comprises a connecting portion on the front cover side 52 connected to the side of the front cover portion 12, a connecting portion on the back cover side 54 connected to the side of the back cover portion 14 and an interjacent connecting portion 56 interposing between the connecting portion on the front cover side 52 and the connecting portion on the back cover side 54. The interjacent connecting portion 56 is connected to the end edge connected to the cover of the group of pocket sheets 30 and is formed to curve toward the opposite side of the spine portion 16 along with the end edge connected to the cover of the group of the pocket sheets 30 by the tension of the connecting portion on the front cover side 52 and the connecting portion on the back cover side 54 when opened the cover.

The interjacent connecting portion 56 is relatively flexible and is formed to curve toward the opposite side of the spine portion 16 by the weight of the pocket sheet 18 being in a spread state.

The connecting body 50 has a through hole 58 drilled in the region connected to the binding body and is formed to curve.

The connecting body 50 has a plurality of rectangular planar shaped through holes 58 drilled which are optionally spaced from one another and flexibility is provided thereto on the whole. In this embodiment, there are 3 through holes drilled, an upper through hole 58a, a lower through hole 58b and a middle through hole 58c.

In this embodiment, in the interjacent connecting portion 56, bridge portions 56a and 56b as a pair are crosslinked between the connecting portion on the front cover side 52 and the connecting portion on the back cover side 54 at the upper edge and the lower edge respectively. A bridge portion 56c is crosslinked in between the upper through hole 58a and the middle through hole 58c and a bridge portion 56d is crosslinked in between the middle through hole 58c and the lower through hole 58b; therefore, the adhesion region of the connecting portion 50 and the group of pocket sheets 30 is formed.

Further, a longitudinal bridge portion 56e is formed between a hinge portion on the front cover side 60 and the upper through hole 58a, the lower through hole 58b and the middle through hole 58c, and a longitudinal bridge portion 56f is formed between a hinge portion on the back cover side 62 and the upper through hole 58a, the lower through hole 58b and the middle through hole 58c.

On the connecting portion 50, the hinge portion on the front cover side 60 formed between the connecting portion on the front cover side 52 and the interjacent connecting portion 56 and the hinge portion on the back cover side 62 formed between the connecting portion on the back cover side 54 and the interjacent connecting portion 56 are formed parallel to each other.

The height between the spine portion 16 and the front folding portion 24 of the front cover portion 12 and the back folding portion 26 of the back cover portion 14 respectively is formed to be substantially equal or shorter than the height between the hinge portion on the front cover side 60 of the connecting body 50 and the inner surface of the front cover portion 12 and between the hinge portion on the back cover side 62 and the inner surface of the back cover portion 14. The hinge portion in the front cover side 60 and the hinge portion on the back cover side 62 are formed to position adjacent to the end edge of the spine portion 16 in cross direction when closed the cover.

The interjacent connecting portion 56 between the hinge portion on the front cover side 60 and the hinge portion on the back cover side 62 is formed to curve toward the opposite side of the spine portion 16 when opened the front cover portion 12 and also the width between the hinge portion on the front cover side 60 and the hinge portion on the back cover side 62 is formed to be shorter than the width of the spine portion 16.

The hinge portion on the front cover side 60 is formed to be positioned inner than the front folding portion 24 and the hinge portion on the back cover side 62 is formed to be positioned inner than the back adjacently providing portion 22 so as the width (T2) between the hinge portion on the front cover side 60 and the hinge portion on the back cover side 62 is shorter than the width (T1) between the front adjacently providing portion 20 and the back adjacently providing portion 22 when opened the cover body, i.e. when the connecting portion on the front cover side 52 and the connecting portion on the back cover side 54 are apposed at the horizontal plane in a flat state and the front cover portion 12 and the back cover portion 14 are apposed at the horizontal plane in the flat state.

Additionally, although the width (T1) between the front adjacently providing 20 and the back adjacently providing portion 22 and the width (T3) between the hinge portion on the front cover side 60 and the hinge portion on the back cover side 62 are substantially equal, (T3) is shorter as much as the thickness of the front adjacently providing portion 20 and the back adjacently providing portion 22 than (T1) since the hinge portion on the front cover side 60 and the hinge portion on the back cover side 62 is fastened to the inner surface of the front adjacently providing portion 20 and the back adjacently providing portion 22 when closed the cover body, i.e. when the front cover portion 12 and the back cover portion 14 become parallel and the connecting portion on the front cover side 52 and the connecting portion on the back cover portion 54 become parallel.

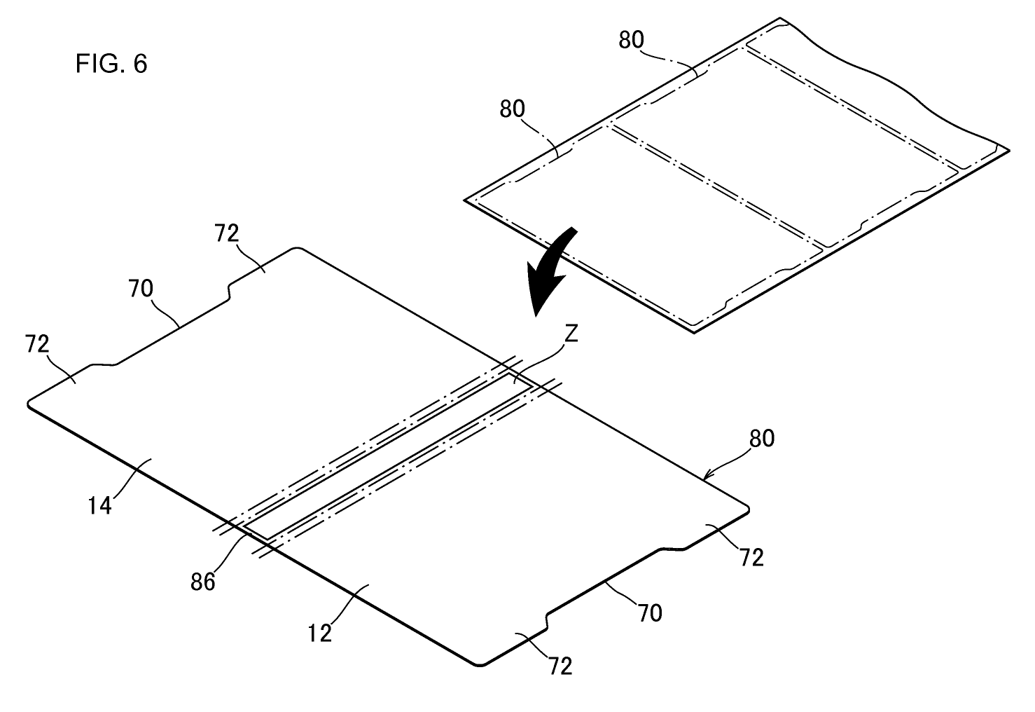

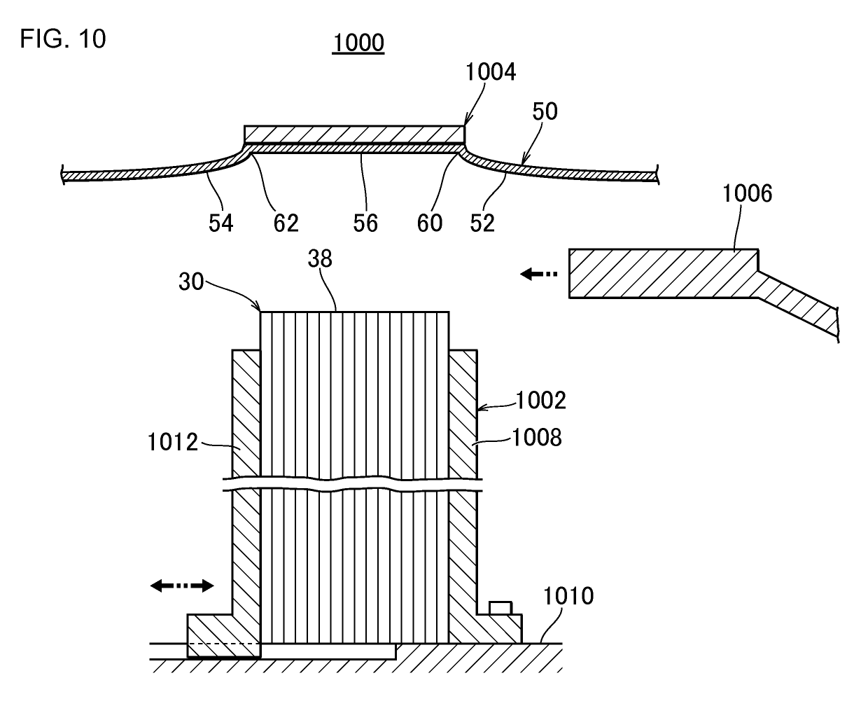

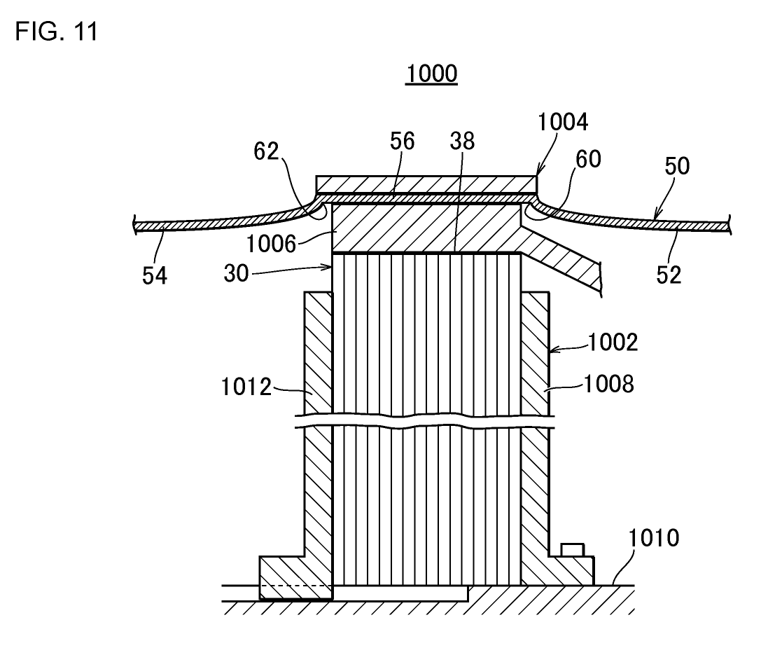

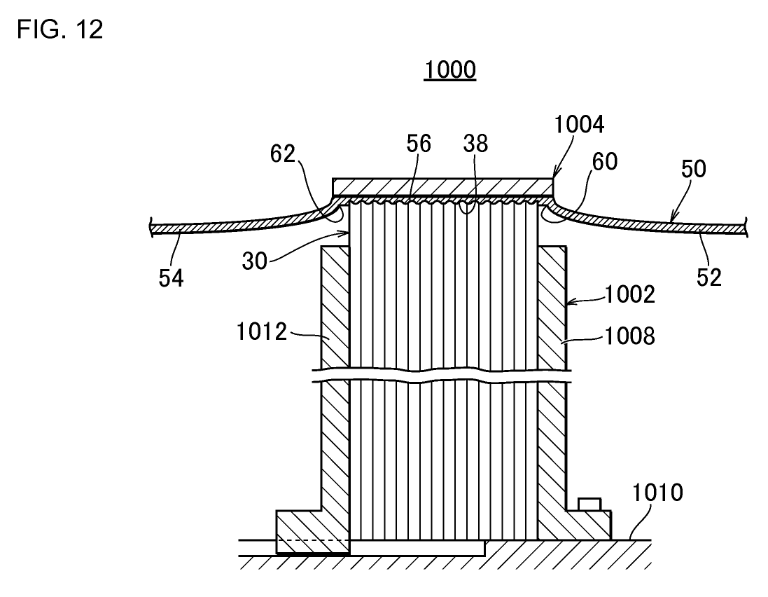

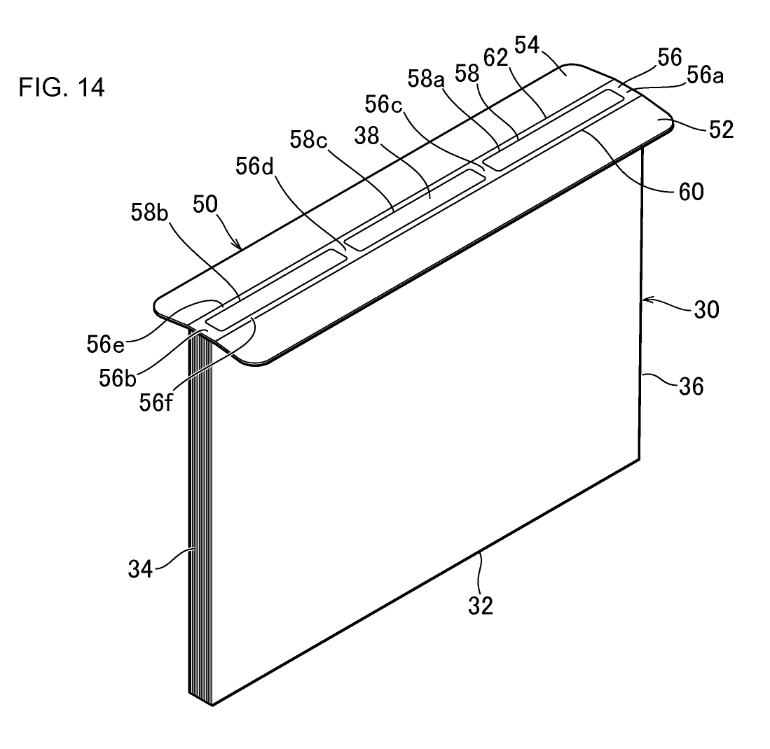

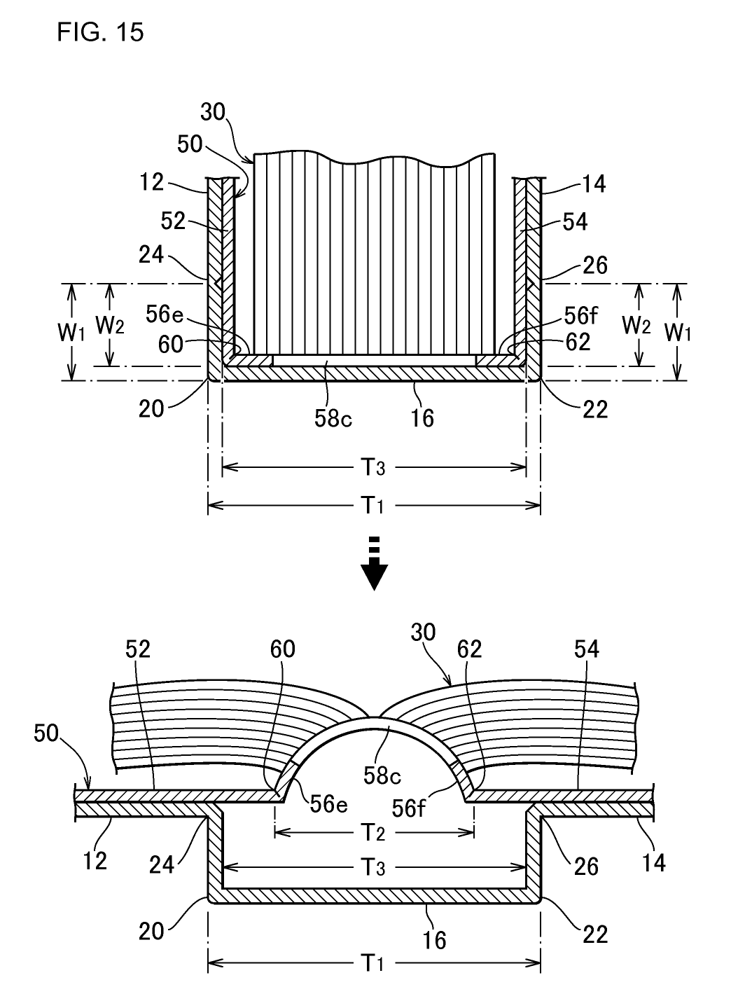

Next, the method of manufacturing the file 10 shown in FIG. 1 of the present invention will be described below with referring to FIGS. 6 through 14.

First, an original material (a synthetic resin sheet body such as polypropylene and the like) is prepared, Thompson processing is applied thereto and the cover material 80 is removed, which will be the cover of the file and will form a cover material 80 in a combined size of the front cover portion 12, the back cover portion 14 and the spine portion 16 together (Cover material molding step).

Next, a spine index paper Z is pasted to the surface of the spine area, which will later become the spine portion 16, a part of the cover material 80, with adhesive agent (Spine index paper pasting step).

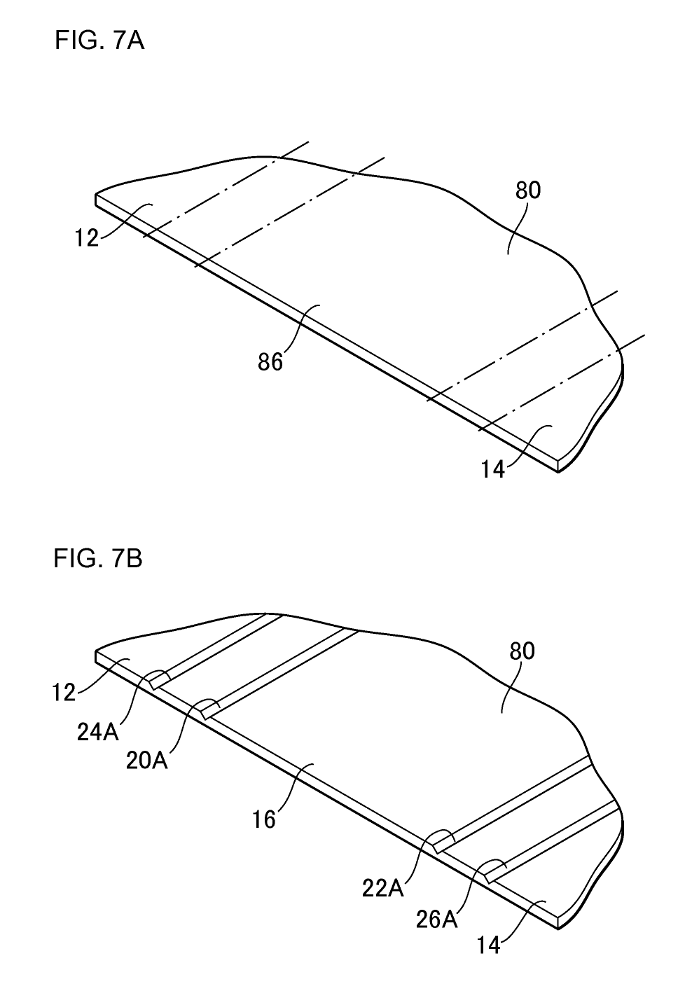

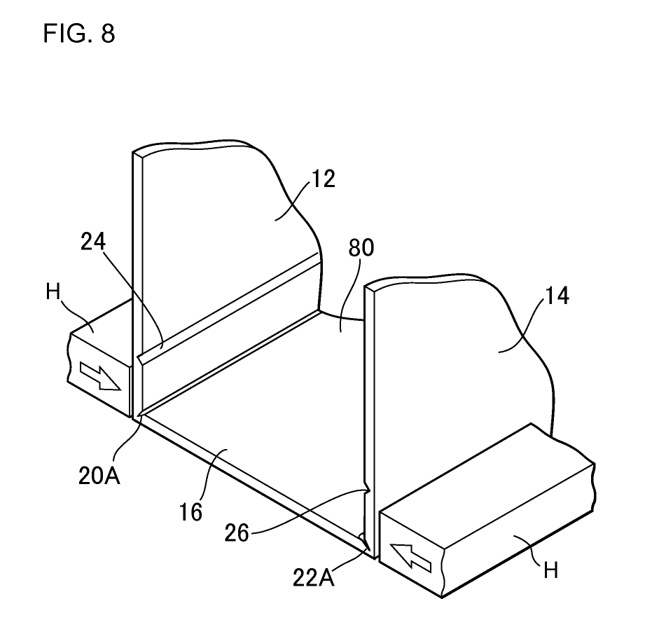

For example, as shown in FIGS. 6, 7A, and 7B, when a thermoplastic resin sheet is used as the cover material 80, the heat-press molding is applied with the V-shape heater (not shown) to V-shape slots 20A, 22A, 24A and 26A which have substantially V-shape section and are parallel to one another for forming the front adjacently providing portion 20, the back adjacently providing portion 22, the front folding portion 24 and the back folding portion 26. Then, the cover material 80 is formed to enable to fold (V-shape slot molding step).

Next, as shown in FIG. 8, heat the V-shape slots 20A, 22A, 24A and 26A, fold the V-shape slots 20A, 22A, 24A and 26A corresponding the front adjacently providing portion 22 and the back adjacently providing portion 24 and mold the front adjacently providing portion 20 and the back adjacently providing portion 22 by joining and solidifying the melted slot walls (adjacently providing portion formation step).

Then, the cover having the grip portion 28 is formed by comprising the front cover portion 12, the back cover portion 14 and the spine portion 16 between the front cover portion 12 and the back cover portion 14 and having the front folding portion 24 comprising of the V-shape slot 24A and the back folding portion 26 comprising of the V-shape slot 26A.

First, a plurality of pocket sheets 18 is superimposed, and the edge faces of the inner end edge 38 facing one another are heated. Consequently, the region which is slightly inner than the inner end edge 38 is melted to fasten. To apply hot welding to the inner end edge 38 of the pocket sheet 18, a hot plate is pressed to the inner end edge 38, the adjacency of the inner end edge 38 is welded and the edge faces of the inner end edge 38 facing one another are adhered to form the group of pocket sheets 30. Adhesion and welding can be done with hot-melt adhesive agent or by ultrasonic horn.

The group of pocket sheets 30 comprises pockets combined with thermoplastic resin sheets, each binding sheet is hot adhered to another on the end edge connected to the cover thereof, and the end edge connected to the cover is formed to curve inwardly when opened the pocket sheet 18.

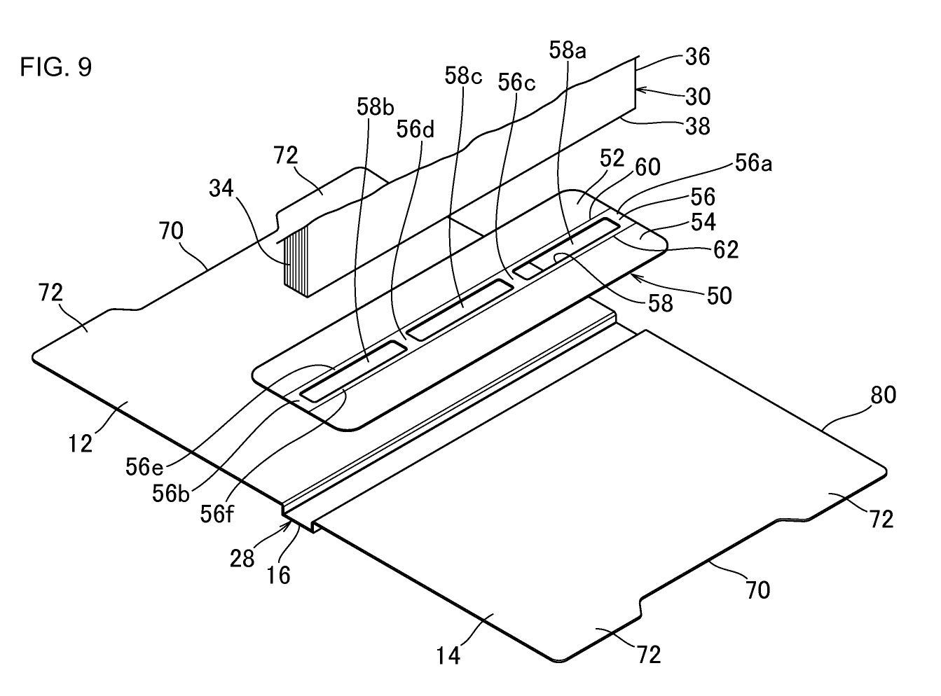

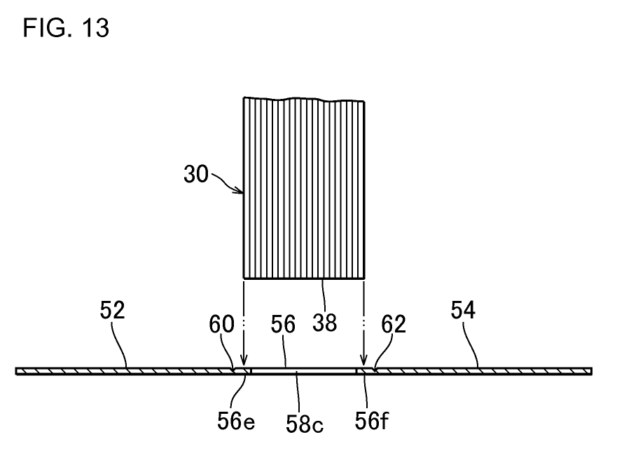

Next, the method for fixing the group of pocket sheets 30 to the spine portion 16 will be described with referring to FIGS. 9 and 13.

First, the connecting portion 50 in substantially square planar shape comprising of a synthetic resin sheet body such as polypropylene and the like is prepared.

The connecting body 50 comprises the connecting portion on the front cover side 52 connected to the side of the front cover portion 12, the connecting portion on the back cover side 54 connected to the side of the back cover portion 14 and the interjacent connecting portion 56 interposing between the connecting portion on the front cover side 52 and the connecting portion on the back cover portion 54.

The interjacent connecting portion 56 is connected to the end edge connected to the cover of the binding body and is formed to curve toward the opposite side of the spine portion 16 along with the end edge connected to the cover of the group of the pocket sheets 30 as the binding body by the tension of the connecting portion on the front cover portion 52 and the connecting portion on the back cover portion 54 when opened the cover.

The connecting body 50 has a through hole 58 drilled in the region connected to the group of pocket sheets 30 and is formed to curve. The group of pocket sheets 30 is adhered to the inner surface of the bridge portions 56a, 56b, 56c and 56d of the connecting body 50 and also to the inner surface of the longitudinal bridge portion 56e and 56f with slightly spaced between the hinge portion on the front cover side 60 and the hinge portion on the back cover side 62.

The group of pocket sheets 30 is applied hot welding to the upper surface of the interjacent connecting portion 56.

The hinge portion in the front cover side 60 and the hinge portion on the back cover side 62 are formed between the connecting portion on the front cover side 52 and the interjacent connecting portion 56 and between the connecting portion on the back cover side 54 and the interjacent connecting portion 56.

The height between the spine portion 16 and the front folding portion 24 of the front cover portion 12 and the back folding portion 26 of the back cover portion 14 respectively is formed to be substantially equal or shorter than the height between the hinge portion on the front cover side 60 of the connecting body 50 and the inner surface of the front cover portion 12 or the hinge portion on the back cover side 62 and the inner surface of the back cover portion 14. The hinge portion on the front cover side 60 and the hinge portion on the back cover side 62 are formed to position adjacent to the end edge of the spine portion 16 in cross direction when closed the cover.

The interjacent connecting portion 56 interposing between the hinge portion on the front cover side 60 and the hinge portion on the back cover side 62 is formed to curve toward the opposite direction of the spine portion 16 and also the width between the hinge portion on the front cover side 60 and the hinge portion on the back cover side 62 is formed to be shorter than the width of the spine portion 16 when opened the front cover portion 12.

Next, the method for adhering the group of pocket sheets 30 to the cover material 80 will be described.

The connecting body 50 is connected adjacent to the front folding portion 24 of the front cover portion 12 and the back folding portion 26 of the back cover portion 14 with optionally spaced from the group of the pocket sheets 30 in the cross direction such that the connecting body 50 enables the end edge connected to the cover of the group of pocket sheet 30 to curve with the width shorter than the width of the spine portion 16 of the cover body.

The connecting body 50 is welded to the connecting portion on the front cover side 52 connected to the side of the front cover portion 12 and the inner surface of the front cover portion 12 and also to the connecting portion on the back cover side 54 on the side of the back cover portion 14 and the inner surface of the back cover potion 14 and is crosslinked between the front cover portion 12 and the back cover portion 14.

In accordance with the embodiment previously described, the connecting body 50 comprises the connecting portion on the front cover side 52 connected to the side of the front cover portion 12, the connecting portion on the back cover side 54 connected to the side of the back cover portion 14 and the interjacent connecting portion 56 interposing between the connecting portion on the front cover side 52 and the connecting portion on the back cover portion 54. The interjacent connecting portion 56 is connected to the end edge connected to the cover of the binding body and is formed to curve toward the opposite side of the spine portion 16 along with the end edge connected to the cover of the binding body by the tension of the connecting portion on the front cover portion 52 as the rigid body and the connecting portion on the back cover portion 54 as the rigid body when opened the cover body.

In the connecting body 50, the hinge portion is formed between the connecting potion on the front cover side 52 and the interjacent connecting portion 56 and between the connection portion on the back cover side 54 and the interjacent connecting portion 56.

The height (W1) between the spine portion 16 and the front folding portion 24 of the front cover portion 12 and the back folding portion 26 of the back cover portion 14 respectively is formed to be substantially equal to the height (W2) between the hinge portion on the front cover side 60 of the connecting body 50 and the inner surface of the front cover portion 12 or the hinge portion on the back cover side 62 and the inner surface of the back cover portion 14 and (W2) is shorter as much as the thickness of the spine portion 16 than (W1).

The hinge portion in the front cover side 60 and the hinge portion on the back cover side 62 are positioned adjacent to the end edge of the spine portion 16 in cross direction when closed the cover body. The hinge portion on the front cover side 60 and the hinge portion on the back cover side 62 are formed to curve toward the opposite side of the spine portion 16 when opened the cover body and also the width between the hinge portion on the front cover side 60 and the hinge portion on the back cover side 62 is formed to be shorter than the width of the spine portion 16. Accordingly, when opened the cover body and spread the group of pocket sheets 30, the pocket sheet 18 can become flat.

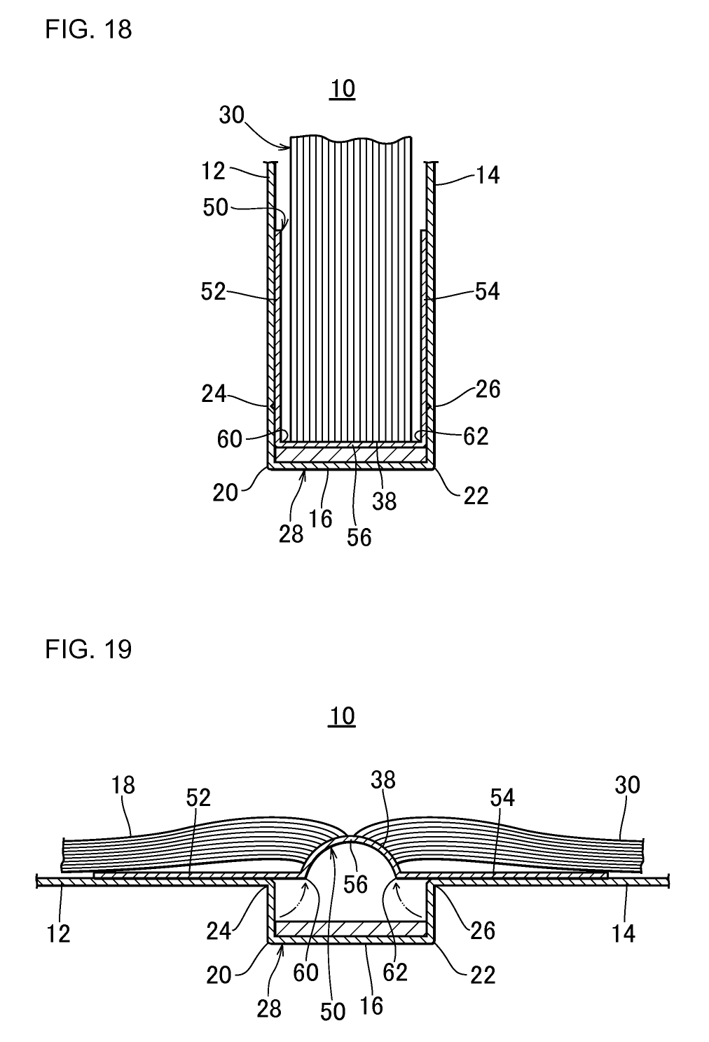

The present invention is not limited to the embodiments previously described. For example, in the connecting body 50, as shown in FIGS. 18 and 19, the height between the spine portion 16 and the front folding portion 24 of the front cover portion 12 and the back folding portion 26 of the back cover portion 14 respectively may be formed to be shorter than the height between the hinge portion on the front cover side 60 of the connecting body 50 and the inner surface of the front cover portion 12 or the hinge portion on the back cover side 62 and the inner surface of the back cover portion 14.

By implementing this method, the region of the interjacent connecting portion 56 may weighed down with the group of pocket sheets 30 toward the side of the spine portion 16. Therefore, to retain the interjacent connecting portion 56 and the spine portion 16 substantially parallel, void part between the interjacent connecting portion 56 and the spine portion 16 may be filled with foam or the like.

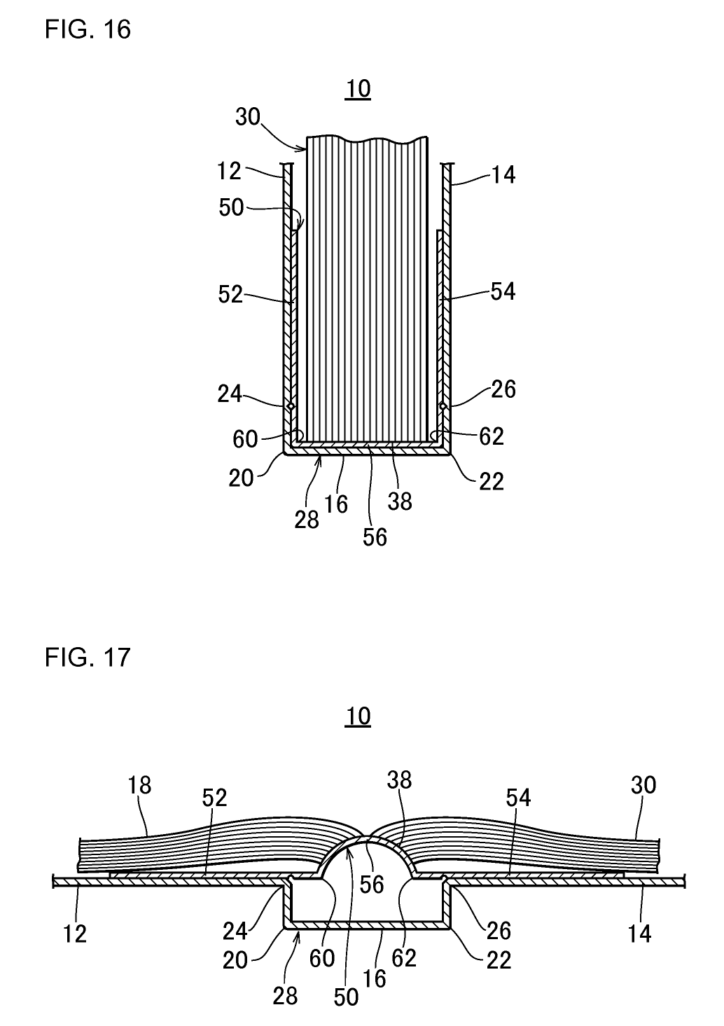

Additionally, as shown in FIGS. 16 and 17, the hinge portion is formed adjacent to the front folding portion 24 at the connecting portion on the front cover side 52 and the back folding portion 26 at the connecting portion on the back cover side 54. The group pocket sheets 30 may be comprised to be spread flat by curving the interjacent connecting portion 56 toward the opposite side of the spine portion 16 due to the weight of the pocket sheet 18 when opened the pocket sheet 18 toward the sides of the fornt cover portion 12 and the back cover portion 14.

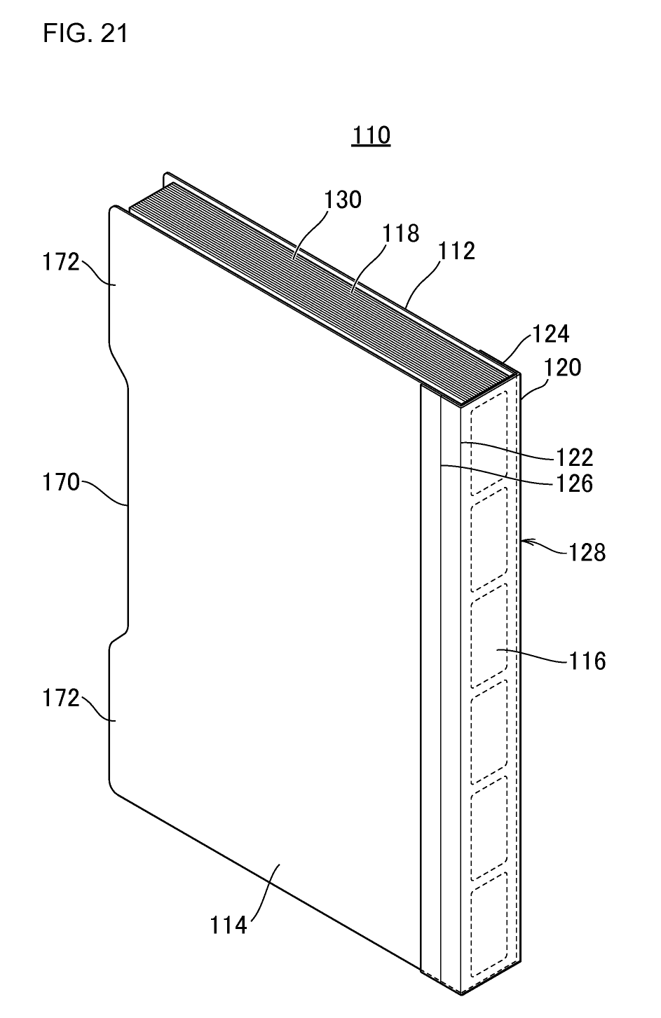

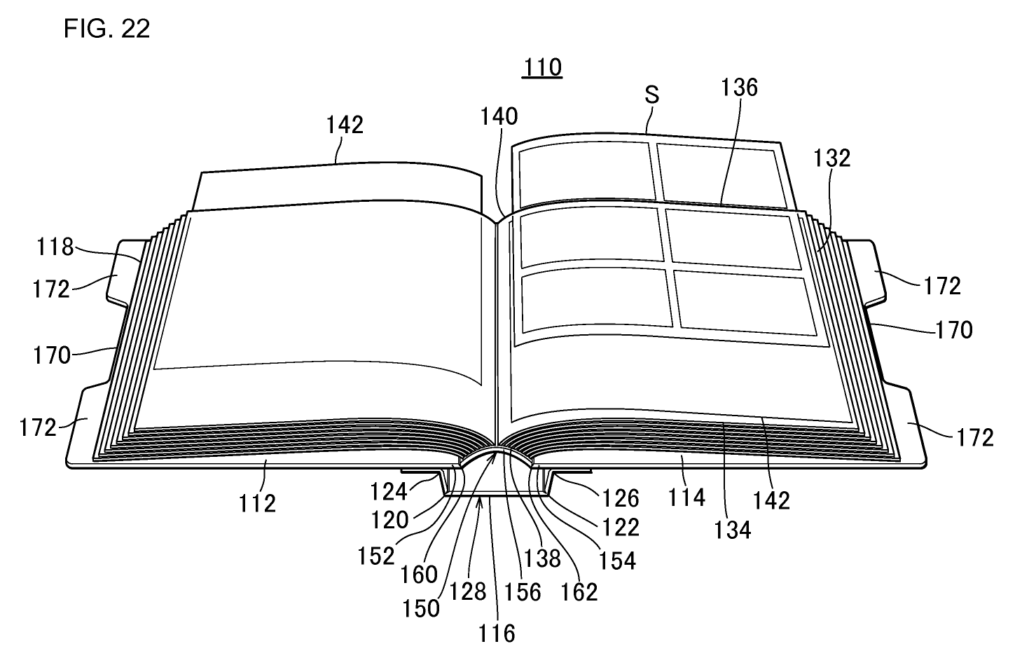

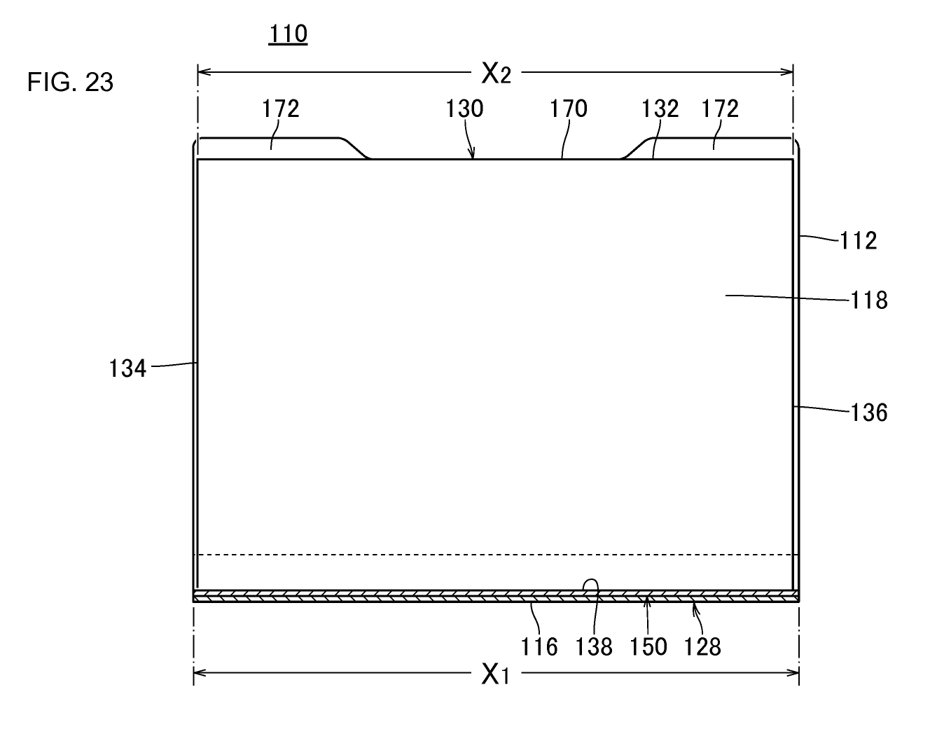

FIG. 21 is a schematic perspective view of the pocket file in accordance with an embodiment of the present invention, FIG. 22 is a schematic perspective view of the pocket file in accordance with an opened state as shown in FIG. 21. FIG. 23 is a schematic transverse sectional view of the pocket file in a closed state as shown in FIG. 21.

A file 110 comprises a cover body having a front cover portion 112 comprising of synthetic-resin such as polypropylene, a back cover portion 114, and a spine portion 116 adjacently provided between the front cover portion 112 and the back cover portion. A group of pocket sheets 130 as a binding body superimposes a pocket sheet 118 as a binding sheet and is welded and connected to the a connecting end edge of the group of pocket sheets 130 as the binding body by being fastened the group of pocket sheets 130 as the binding body connected at a end edge which is connected to the spine portion 116.

The file 110 comprises a curved subsidiary portion which fixes the back of the cover body into an optional form in regions on a front cover side and on a back cover side of the spine portion 116 between the front cover portion 112 and the back cover portion 114 and the curved retaining portion formed to curve the end edge of the group of pocket sheets 130 as the binding body toward the direction of the pocket sheet 118 as the binding sheet extending at the inner side of the spine portion 116 adjacently provided between the front cover portion 112 and the back cover portion 114 when opened the cover.

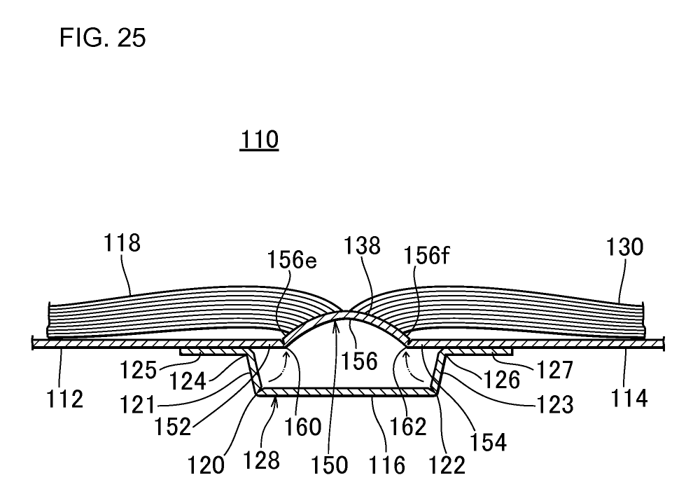

The front cover portion 112 and the back cover portion 114, as shown in FIGS. 23 through 26, form a curved subsidiary portion which fixes the back of the binding body into an optional form in a region on a front cover side and a region on a back cover side of the spine portion 116 between the front cover portion 112 and the back cover portion 114. In this embodiment, the curved subsidiary portion is comprised as an independent curved subsidiary member 128.

The front cover portion 112 and the back cover portion 114 are adjacently provided to the spine portion 116 to cross at a substantially right angle via a linear front folding portion 124 and a linear back folding portion 126 and a linear front adjacently providing portion 120 and a linear back adjacently providing portion 122 crossing from the top edge to the bottom edge in the direction of the height of the front cover portion 112 and the back cover portion 114 when closed the cover body.

The pocket sheet 118 are flexibly formed between a part where the pocket sheet 118 is fastened to the inner side of the spine portion 116 between the front cover portion 112 and the back cover portion 114 and a part at least above a front folding portion 124 and a back folding portion 126 (when closed the cover body).

The pocket sheet 118 comprises a linear outer end edge 132, a linear bottom edge 134 and an opening edge 136 formed at a top end edge which is opposite from the bottom edge 134 and is connected to the inner surface of the spine portion 116 at an inner end edge 138 opposite from the linear outer end edge 132.

The pocket sheet 118 comprises a pocket portion 140 to accommodate an object to be bound S such as documents and is fitted for a mount 142 extending in the direction away from a part where the spine portion 116 is fastened to be inserted from a part above the front folding portion 124 and the back folding portion 126 (when closed the cover body) in the inner side of the pocket portion 140.

The group of pocket sheets 130 is connected by a curved retaining portion 150 adjacently provided at the front cover portion 112 and the back cover portion 114 at the connecting end edge connected to the group of pocket sheets 130.

The curved retaining portion 150 is comprised of substantially square rigid plate body in a planar view composed of thermoplastic synthetic resin and comprises the curved retaining portion which curves the group of pocket sheets 130 as the binding body, welded and connected at the connecting end edge of the group of pocket sheets 130 as the binding body, toward the direction of the pocket sheet 118 as the binding body extending, i.e. toward the direction away from the spine portion 116, when opened the cover body.

The curved retaining portion 150 is connected adjacent to the outer side of the hinge portion on a front cover side 160 and the outer side of the hinge portion on a back cover side 162 with optionally spaced from the group of the pocket sheets 130 in the cross direction such that the curved retaining portion 150 enables the end edge connected to the cover of the group of pocket sheet 130 to curve with the width shorter than the width of the spine portion 116 of the curved subsidiary portion 128.

The curved retaining portion 150 comprises the connecting portion on a front cover side 152 adjacently provided in the side of the front cover portion 112, the connecting portion on a back cover side 154 adjacently provided in the side of the back cover portion 114 and an interjacent connecting portion 156 interposing between the connecting portion on the front cover side 152 and the connecting portion on the back cover portion 154. The interjacent connecting portion 156 is connected to the end edge connected to the cover of the group of pocket sheets 130 and is formed to curve toward the opposite side of the spine portion 116 along with the end edge connected to the cover of the group of the pocket sheets 130 by the tension of the connecting portion on the front cover side 152 and the connecting portion on the back cover side 154 when opened the cover.

The curved retaining portion 150 is relatively flexible and is formed to arch toward the opposite side of the spine portion 116 by the weight of the pocket sheet 118 being in a spread state.

The front cover portion 112 and the connecting portion on the front cover side 152 are formed as an unified flat plate, and the back cover portion 114 and the connecting portion on the back cover side 154 are also formed as an unified flat plate.

The curved retaining portion 150 comprises of a thermoplastic synthetic resin sheet body such as polypropylene and the like in a square planar shape and has a through hole 58 drilled in the region connected to the binding body and is formed to curve.

The curved retaining portion 150 has a plurality of rectangular planar shaped through holes 158 drilled which are optionally spaced from one another and flexibility is provided thereto on the whole. In this embodiment, there are 6 through holes drilled, an upper through hole 158a, a lower through hole 158b, middle through holes 158c1, 158c2, 158c3 and 158c4.

In this embodiment, in the interjacent connecting portion 156, bridge portions 156a and 156b as a pair are crosslinked between the connecting portion on the front cover side 152 and the connecting portion on the back cover side 154 at the upper edge and the lower edge respectively. Bridge portions 156c1, 156c2, 156c3 and 156c4 are crosslinked in between middle through holes 158c1 and 158c4 and the bridge portion 56c5 are crosslinked in between the middle through hole 158c4 and the lower through hole 158b; therefore, the adhesion region of the group of pocket sheets 130 and the interjacent connecting portion 156 is formed.

Further, a longitudinal bridge portion 156e is formed between a hinge portion on the front cover side 160 and the upper through hole 158a, the lower through hole 158b and the middle through holes 158c1, 158c2, 158c3, and 158c4, and a longitudinal bridge portion 156f is formed between a hinge portion on the back cover side 162 and the upper through hole 158a, the lower through hole 158b and the middle through holes 158c1, 158c2, 158c3 and 158c4.

The longitudinal bridge portion 156e and the longitudinal bridge portion 156f are successively formed to cross from the top edge to the bottom edge of the cover body.

On the curved retaining portion 150, the hinge portion on the front cover side 160 formed between the connecting portion on the front cover side 152 and the interjacent connecting portion 156 and the hinge portion on the back cover side 162 formed between the connecting portion on the back cover side 154 and the interjacent connecting portion 156 are formed parallel to each other.

The height between the spine portion 116 and the front folding portion 124 of the front cover portion 112 and the back folding portion 126 of the back cover portion 114 respectively is formed to be substantially equal or shorter than the height between the hinge portion on the front cover side 160 of the curved retaining portion 150 and the inner surface of the front cover portion 112 and the hinge portion on the back cover side 162 and the inner surface of the back cover portion 114. The hinge portion in the front cover side 160 and the hinge portion on the back cover side 162 are formed to position adjacent to the end edge of the spine portion 116 in cross direction when closed the cover body.

The interjacent connecting portion 156 between the hinge portion on the front cover side 160 and the hinge portion on the back cover side 162 is formed to curve toward the opposite side of the spine portion 116 when opened the front cover portion 112 and also the width between the hinge portion on the front cover side 160 and the hinge portion on the back cover side 162 is formed to be shorter than the width of the spine portion 116.

The front cover portion 112 and the back cover portion 114, as shown in FIGS. 23 through 26, form a curved subsidiary portion which fixes the back of the binding body into an optional form in a region on a front cover side and a region on a back cover side of the spine portion 116 between the front cover portion 112 and the back cover portion 114. In this embodiment, the curved subsidiary portion is comprised as an independent curved subsidiary member 128.

The curved subsidiary member 128 comprises of a thermoplastic synthetic resin sheet body such as polypropylene and the like in a square planar shape. The font folding portion 124 and the back folding portion 126 crossing from the upper edge to the lower edge are successively formed and the curved subsidiary portion 128 is formed in the region from the front folding portion 124 on the front cover portion 112 to the spine portion 116, the region from the back folding portion 126 on the back cover portion 114 to the spine portion 116 and the spine portion 116.

In curved subsidiary member 128, the connecting portion on the front cover side 152 having the front folding portion 124 as an axis sways upwardly in the region on the spine portion 116 on the front cover side crosslinked between the front cover portion 112 and the back cover portion 114, and the connecting portion on the back cover side 154 having the back folding portion 126 as an axis sways upwardly and the curved subsidiary portion 128 forms the curved subsidiary portion which enables the curved retaining portion 150 to arch upwardly, i.e. toward the direction away from the spine portion 116, when the front cover portion 112 and the back cover portion 114 become substantially horizontal and become parallel to the curved subsidiary member 128 of the horizontal spine portion 116.

On the front cover portion 112 and the back cover portion 114, the front folding portion 124 and the back folding portion 126 are formed parallel to the front adjacently providing portion 120 and the back adjacently providing portion 122 in the direction of their heights crossing from the top edge to the bottom edge thereof adjacent to the front adjacently providing portion 120 and the back adjacently providing portion 122.

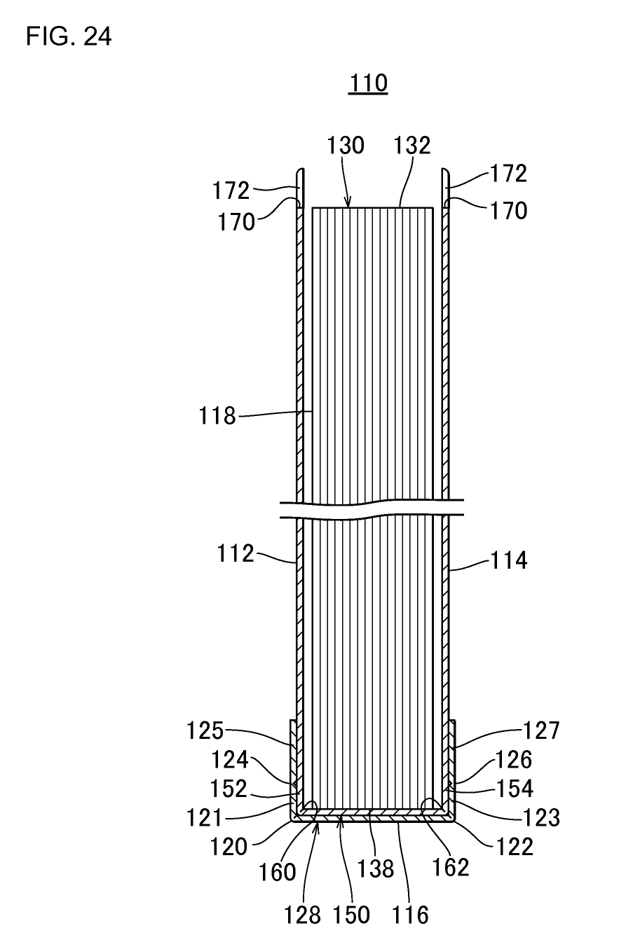

The length of the inner face of the spine portion 116 and the front folding portion 124 and the length of the inner face of the spine portion 116 and the back folding portion 126 are formed to be equal (shown in FIG. 24).

A square shape retaining portion 121 adjacently provided via the front adjacently providing portion 120 on the side of the front adjacently providing portion 120 of the spine portion 116 is formed and a square shape retaining portion 123 adjacently provided via the back adjacently providing portion 122 on the side of the back adjacently providing portion 122 is formed.

A square shape fastening portion on the front cover side 125 adjacently provided via the front folding portion 124 on the side of the front folding portion 124 of the shape retaining portion 121 is formed and a square shape fastening portion on the back cover side 127 adjacently provided via the back folding portion 126 on the side of the back folding portion 126 is formed.

The curved subsidiary member 128 has an angular structure such that the user can set the spine portion 116 on his palm, grip the grip portion 128 with his fingers and open the pocket sheet 118.

On the front cover portion 112 and the back cover portion 114, a recess for search 170 is formed on the free end edge opposite side from the spine portion 116, i.e. the left side end edge of the front cover portion 112 and the right side end edge of the back cover portion 114, in the middle of the direction of the height thereof.

The outer end edge of the recess for search 170 and the outer end edge 132 of the pocket sheet 118 are uniformed. Accordingly, with one hand, folding the file 110 with the cover closed, especially gripping the curved subsidiary portion 128 and placing the other hand to the recess for search 170 enables to flip the front cover portion 112 or the back cover portion 114 and the pocket sheet 118.

The file 110 can be flipped from the pocket sheet 118 positioned on the upper side to the pocket sheet positioned on the lower side with the user's fingers placed the outermost part of the outer end edge 132 of the pocket sheet 118 and slightly bend the front cover portion 112 or the back cover portion 114 in the recess for search 170 as shown in FIG. 20.

On the front cover portion 112 and the back cover portion 114, a pair of projection portions 172 on the upper side and the lower side is formed respectively to cover the index i formed on the pocket sheet 118 such that the projection portion 172 is projected toward the outer side from the end edge for spread, i.e. the outer end edge 132, of the pocket sheet 118 on the outside of the region that the recess portion for search 170 is formed.

The end edge of the group of pocket sheet 130 as the binding body connected to the spine portion 116 when opened the cover body is formed to curve toward the opposite side of the spine portion 116.

The pocket sheet 118 as the binding body comprises pockets combined with thermoplastic resin sheets, each pocket sheet 118 is hot-adhered to another on the end edge connected to the cover thereof, and the end edge connected to the spine portion 116 is formed to curve inwardly when opened the pocket sheet 118.

The hinge portion on the front cover side 160 is formed to be positioned inner than the front folding portion 124 and the hinge portion on the back cover side 162 is formed to be positioned inner than the back adjacently providing portion 122 so as the width (T2) between the hinge portion on the front cover side 160 and the hinge portion on the back cover side 162 is shorter than the width (T1) between the front adjacently providing portion 120 and the back adjacently providing portion 122 when opened the cover body, i.e. when the connecting portion on the front cover side 152 and the connecting portion on the back cover side 154 are apposed at the horizontal plane in a flat state and the front cover portion 112 and the back cover portion 114 are apposed at the horizontal plane in the flat state.

Additionally, although the width (T1) between the front adjacently providing portion 120 and the back adjacently providing portion 122 and the width (T3) between the hinge portion on the front cover side 160 and the hinge portion on the back cover side 162 are substantially equal, (T3) is shorter as much as the thickness of the front adjacently providing portion 120 and the back adjacently providing portion 122 than (T1) since the hinge portion on the front cover side 160 and the hinge portion on the back cover side 162 is fastened to the inner surface of the front adjacently providing portion 120 and the back adjacently providing portion 122 when closed the cover body, i.e. when the front cover portion 112 and the back cover portion 114 become parallel and the connecting portion on the front cover side 152 and the connecting portion on the back cover portion 154 become parallel.

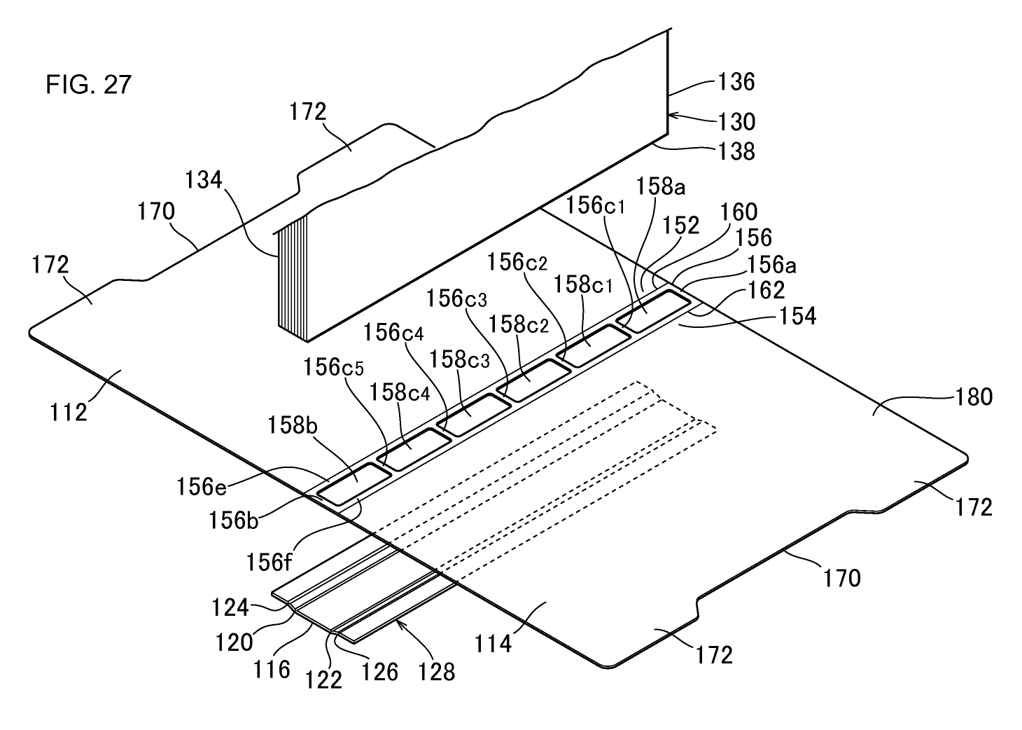

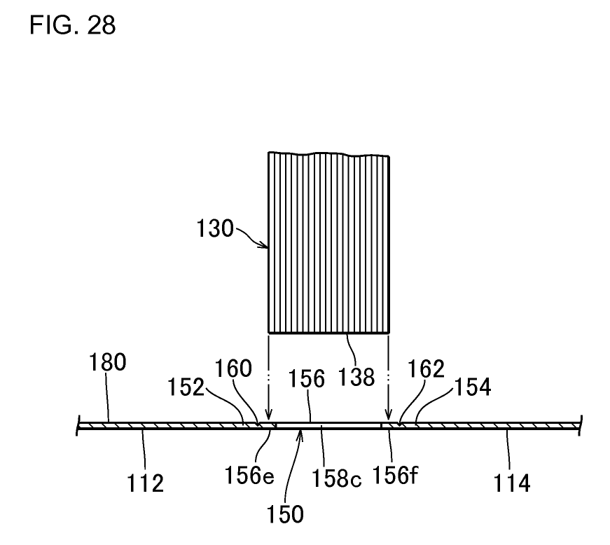

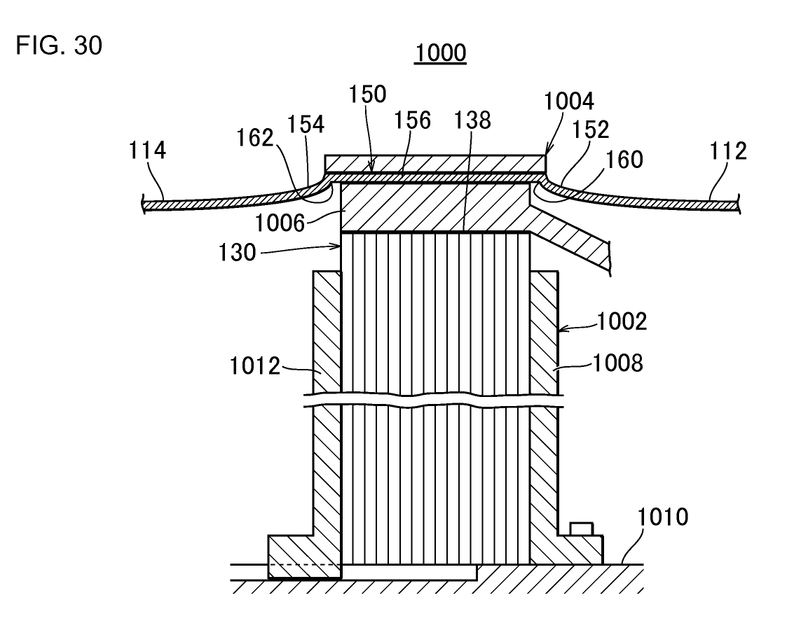

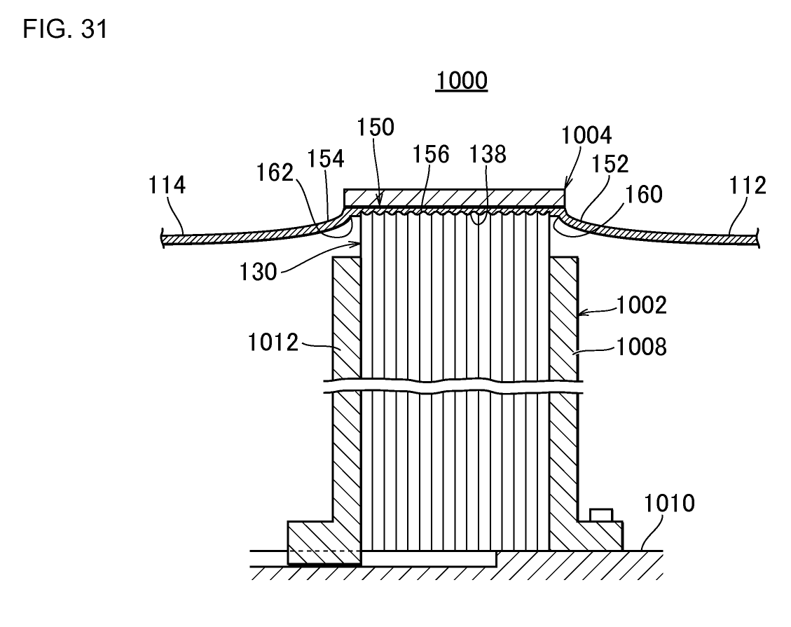

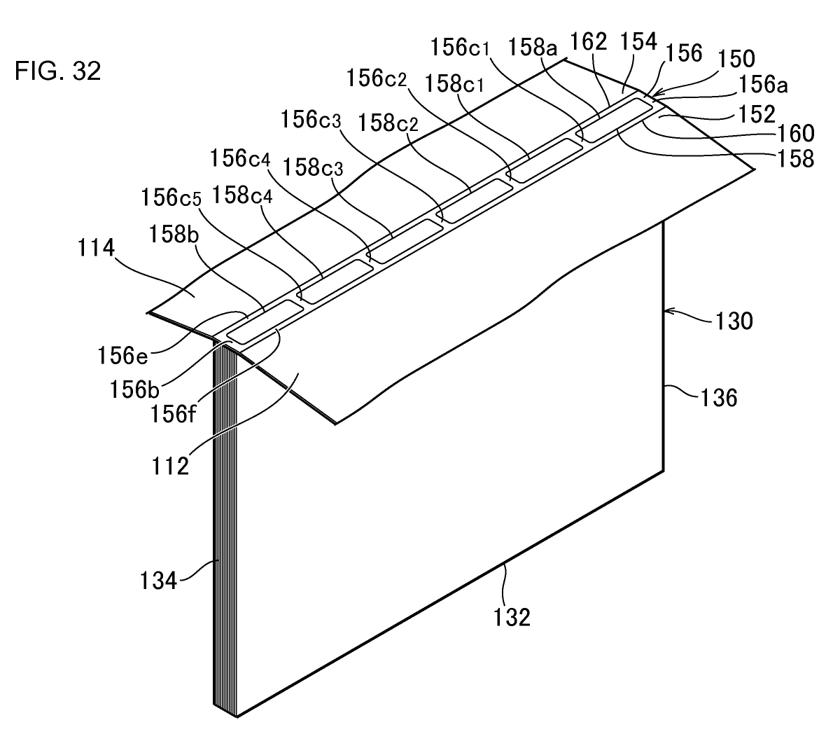

Next, the method of manufacturing the file 110 shown in FIG. 21 of the present invention will be described below with referring to FIGS. 27 through 32.

First, a plurality of pocket sheets 118 is superimposed, and the edge faces of the inner end edge 138 facing one another are heated. Consequently, the region which is slightly inner than the inner end edge 138 is melted to fasten. To apply hot welding to the inner end edge 138 of the pocket sheet 118, a hot plate is pressed to the inner end edge 138, the adjacency of the inner end edge 138 is welded and the edge faces of the inner end edge 138 facing one another is adhered to form the group of pocket sheets 130. Adhesion and welding can be done with hot-melt adhesive agent or by ultrasonic horn.

The group of pocket sheets 130 comprises pockets combined with thermoplastic resin sheets, each binding sheet is hot adhered to another on the end edge connected to the cover thereof, and the end edge connected to the cover is formed to curve inwardly when opened the pocket sheet 118.

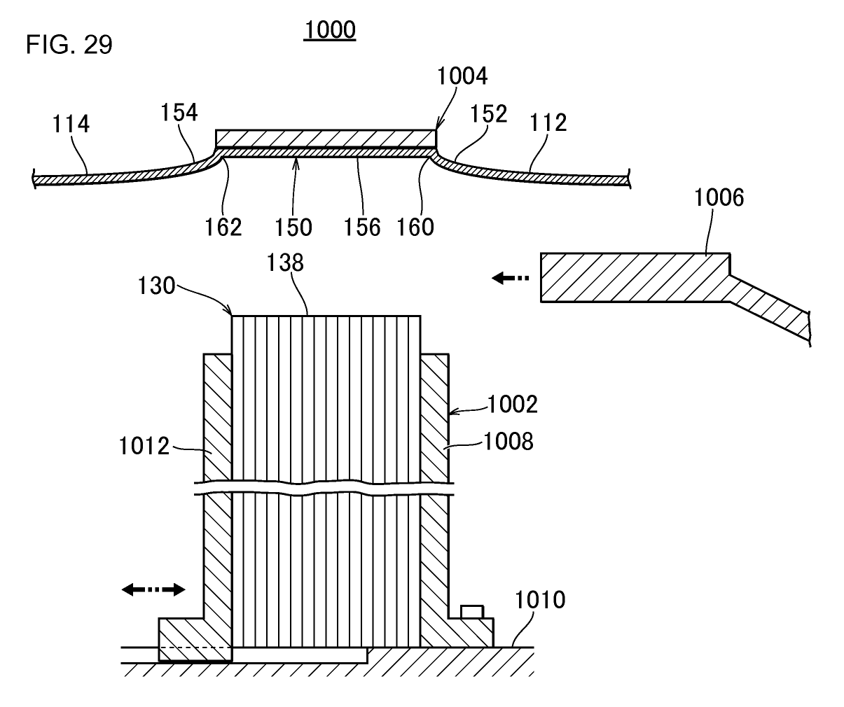

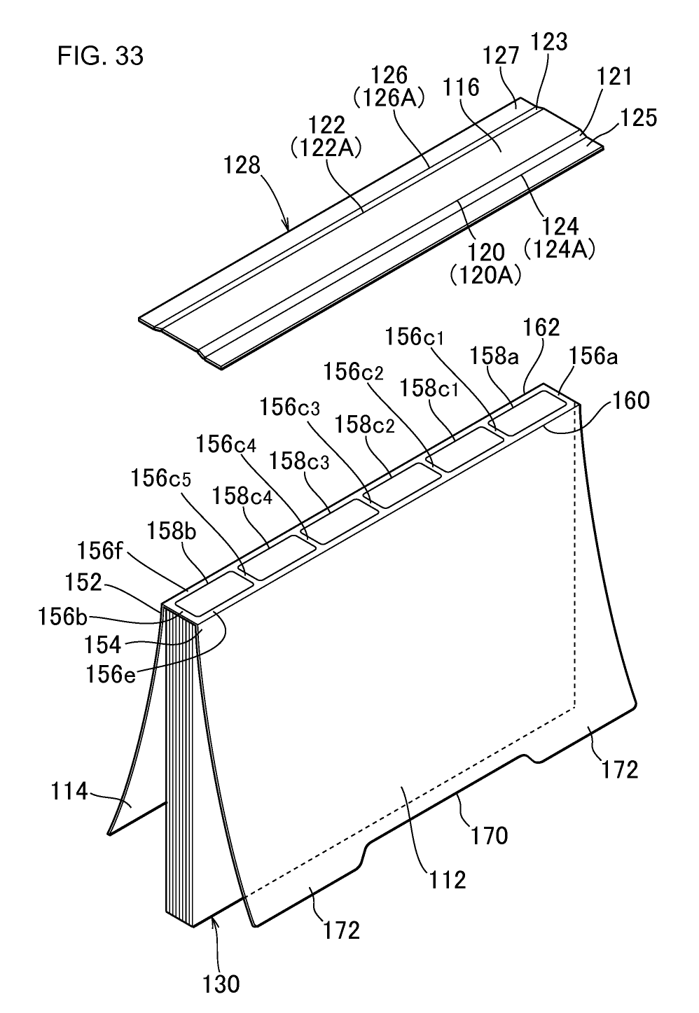

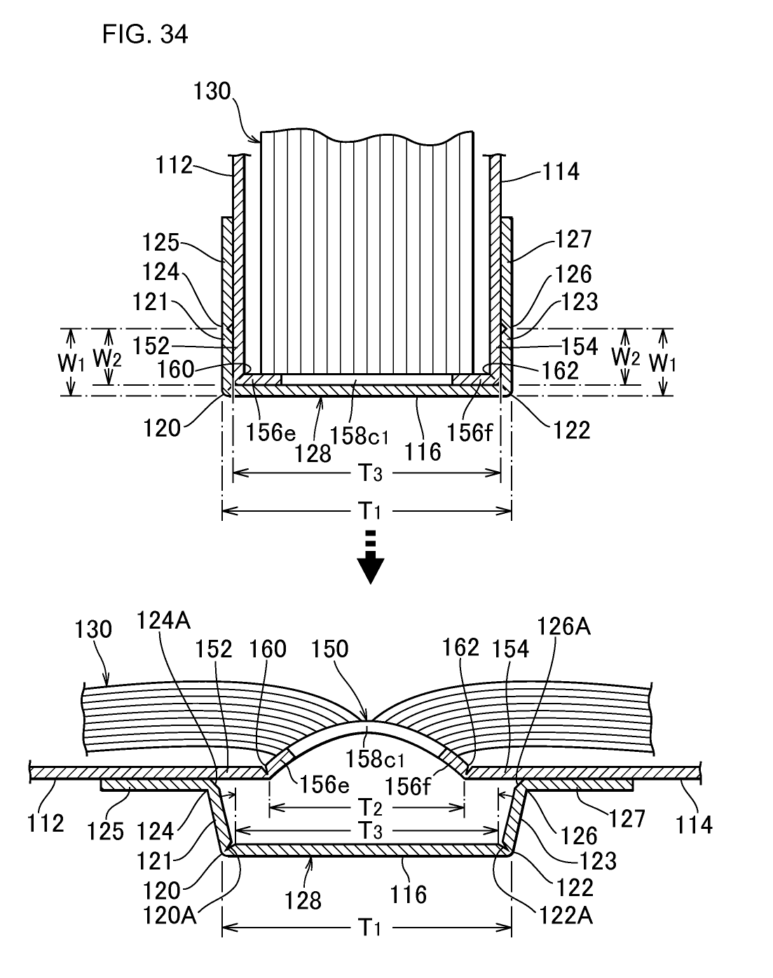

Next, the method for fixing the group of pocket sheets 130 to the curved retaining portion 150 of the cover body will be described with referring to FIGS. 29 through 34.

First, an original material (a synthetic resin sheet body such as polypropylene and the like) is prepared, Thompson processing is applied thereto and the cover material 180 is removed, which will be the cover of the file and will form a cover material 180 in a combined size of the front cover portion 112, the back cover portion 114 and the curved retaining portion 150 together (Cover material molding step).

For forming the curved retaining portion 150 with the cover material 180 comprising of a thermoplastic synthetic resin sheet body such as polypropylene and the like in a square planar shape, the curved retaining portion 150 is formed by demarcating the interjacent connecting portion 156 interposed between the connecting portion on the front cover side 152 connected to the front cover portion 112 and the connecting portion on the back cover side 154 connected to the back cover portion 114 from the cover material 180.

The interjacent connecting portion 156 is connected to the end edge connected to the cover of the binding body and is formed to curve toward the opposite side of the spine portion 116 along with the end edge connected to the cover of the group of the pocket sheets 130 as the binding body by the tension of the connecting portion on the front cover portion 152 and the connecting portion on the back cover portion 154 when opened the cover.

The curved retaining portion 150 comprises of a thermoplastic synthetic resin sheet body such as polypropylene and the like in a square planar shape and has the through hole 158 drilled in the region connected to the group of pocket sheets 130 and is formed to curve. The group of pocket sheets 130 is adhered to the inner surface of the bridge portions 156a, 156b, 156c1, 156c2, 156c3, 156c4 and 156c5 of the curved retaining portion 150 and also to the inner surface of the longitudinal bridge portion 156e and 156f with slightly spaced between the hinge portion on the front cover side 160 and the hinge portion on the back cover side 162.

The group of pocket sheets 130 is applied hot welding to the upper surface of the interjacent connecting portion 156.

The curved retaining portion 150 is formed by the hinge portion on the front cover side 160 and the hinge portion on the back cover side 162 between the connecting portion on the front cover side 152 and the interjacent connecting portion 156 and between the connecting portion on the back cover side 154 and the interjacent connecting portion 156.

The height between the spine portion 116 and the front folding portion 124 of the front cover portion 112 and the back folding portion 126 of the back cover portion 114 respectively is formed to be substantially equal or shorter than the height between the hinge portion on the front cover side 160 of the curved retaining portion 150 and the inner surface of the front cover portion 112 or the hinge portion on the back cover side 162 and the inner surface of the back cover portion 114. The hinge portion on the front cover side 160 and the hinge portion on the back cover side 162 are formed to position adjacent to the end edge of the spine portion 116 in cross direction when closed the cover.

The interjacent connecting portion 156 interposing between the hinge portion on the front cover side 160 and the hinge portion on the back cover side 162 is formed to curve toward the opposite side of the spine portion 116 and also the width between the hinge portion on the front cover side 160 and the hinge portion on the back cover side 162 is formed to be shorter than the width of the spine portion 116 when opened the front cover portion 112.

Next, the method for adhering the group of pocket sheets 130 to the cover material 180 will be described.

The curved retaining portion 150 is connected adjacent to the hinge portion on the front cover side 160 of the front cover portion 112 and the hinge portion on the back cover side 162 of the back cover portion 114 with optionally spaced from the group of the pocket sheets 130 in the cross direction such that the connecting body 150 enables the end edge connected to the cover of the group of pocket sheet 130 to curve with the width shorter than the width of the spine portion 116 of the cover body.

The connecting body 150 is welded to the connecting portion on the front cover side 152 connected to the side of the front cover portion 112 and the outer surface of the front cover portion 112 and also to the connecting portion on the back cover side 154 on the side of the back cover portion 114 and the outer surface of the back cover potion 114 and is crosslinked between the front cover portion 112 and the back cover portion 114.

In accordance with the embodiment previously described, the curved retaining portion 150 comprises the connecting portion on the front cover side 152 connected to the side of the front cover portion 112, the connecting portion on the back cover side 154 connected to the side of the back cover portion 114 and the interjacent connecting portion 156 interposing between the connecting portion on the front cover side 152 and the connecting portion on the back cover portion 154. The interjacent connecting portion 156 is connected to the end edge connected to the cover of the binding body and is formed to curve toward the opposite side of the spine portion 116 along with the end edge connected to the cover of the binding body by the tension of the connecting portion on the front cover portion 152 as the rigid body and the connecting portion on the back cover portion 154 as the rigid body when opened the cover body.

In the curved retaining portion 150, the hinge portion on the front cover side 160 and the hinge portion on the back cover side 162 are formed between the connecting potion on the front cover side 152 and the interjacent connecting portion 156 and between the connection portion on the back cover side 154 and the interjacent connecting portion 156.

Next, for forming the curved subsidiary portion 128, a thermoplastic synthetic resin sheet is prepared; Thompson processing is applied thereto; and the curved subsidiary portion 128 is punched out in a square planar shape.

Further, a spine index paper Z is pasted to the surface of the spine area, which will later become the spine portion 116 with adhesive agent (Spine index paper pasting step).

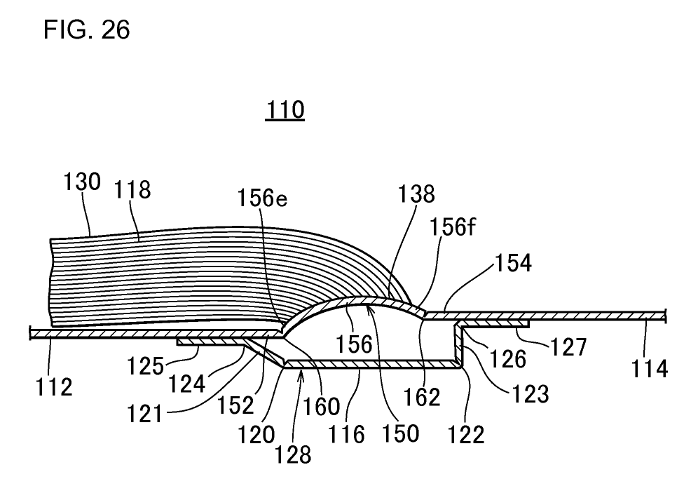

For example, as shown in FIGS. 26 and 27, when a thermoplastic resin sheet is used as the curved retaining portion 128, the heat-press molding is applied with the V-shape heater (not shown) to V-shape slots 120A, 122A, 124A and 126A which have substantially V-shape section and are parallel to one another for forming the front adjacently providing portion 120, the back adjacently providing portion 122, the front folding portion 124 and the back folding portion 126. Then, the cover material 180 is formed to enable to fold (V-shape slot molding step).

Then, the cover body comprising the crosslinked curved subsidiary portion 128 is formed by fastening adjacency of the outer end edge of the front cover portion 120 at the outer surface of the front cover portion 112 and the outer side then the hinge portion on the front cover side 160 and also fastening adjacency of the back adjacently providing portion 122 at the outer surface of the back cover portion 114 and the outer side than the hinge portion on the back cover side 162.

The height (W1) between the spine portion 116 and the front folding portion 124 of the front cover portion 112 and the back folding portion 126 of the back cover portion 114 respectively is formed to be substantially equal to the height (W2) between the hinge portion on the front cover side 160 of the curved retaining portion 150 and the inner surface of the front cover portion 112 or the hinge portion on the back cover side 162 and the inner surface of the back cover portion 114 and (W2) is shorter as much as the thickness of the spine portion 116 than (W1).

The hinge portion in the front cover side 160 and the hinge portion on the back cover side 162 are positioned adjacent to the end edge of the spine portion 116 in cross direction when closed the cover body. The hinge portion on the front cover side 160 and the hinge portion on the back cover side 162 are formed to curve toward the opposite side of the spine portion 116 when opened the cover body and also the width between the hinge portion on the front cover side 160 and the hinge portion on the back cover side 162 is formed to be shorter than the width of the spine portion 116. Accordingly, when opened the cover body and spread the group of pocket sheets 130, the pocket sheet 118 can become flat.

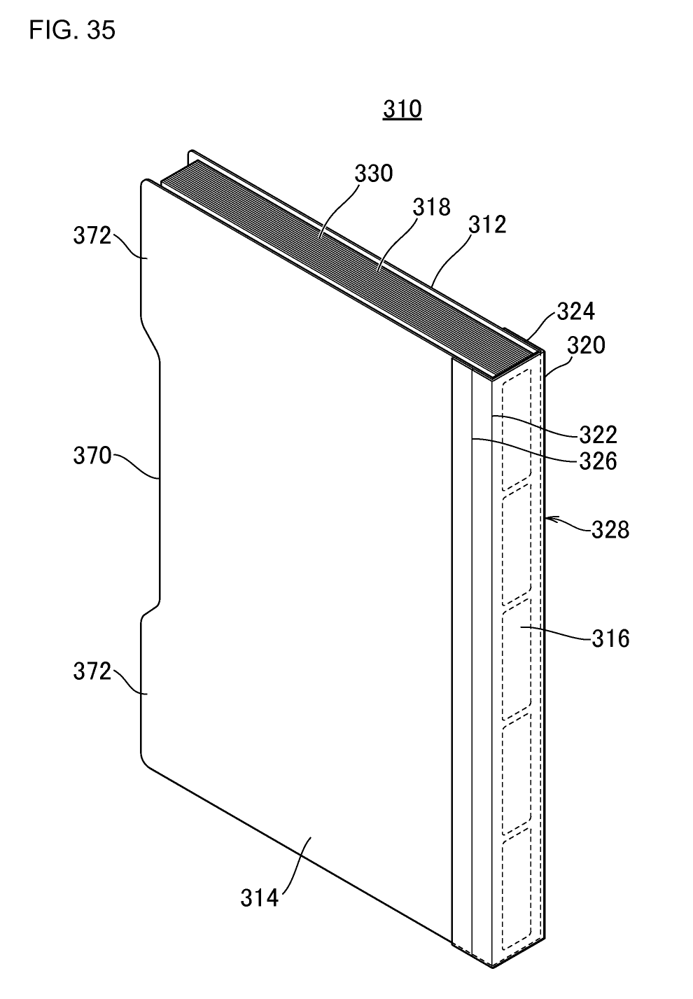

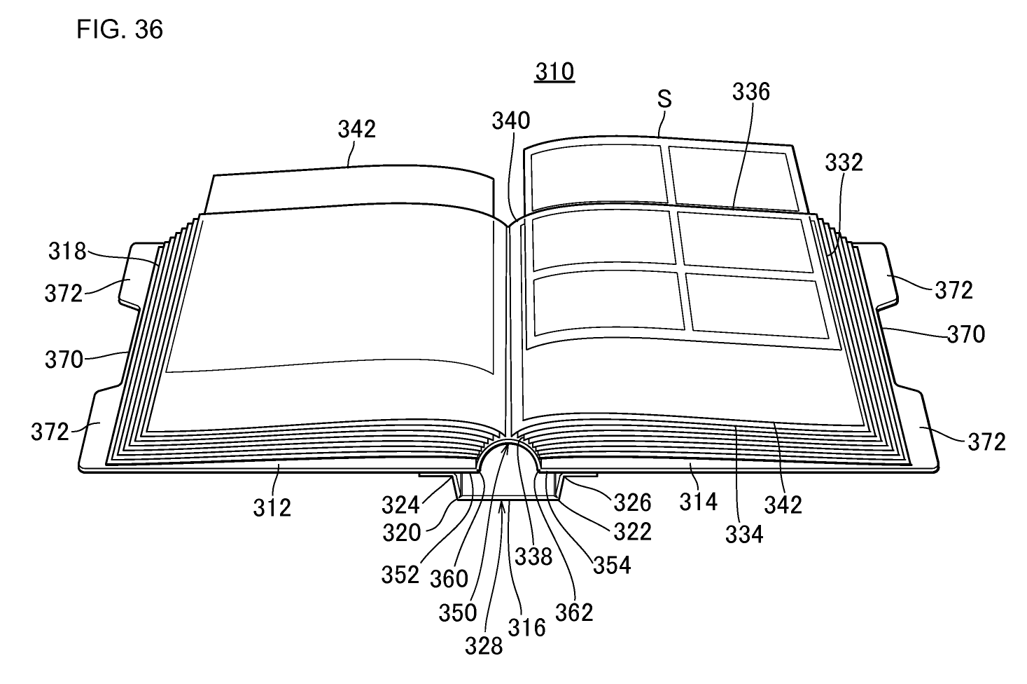

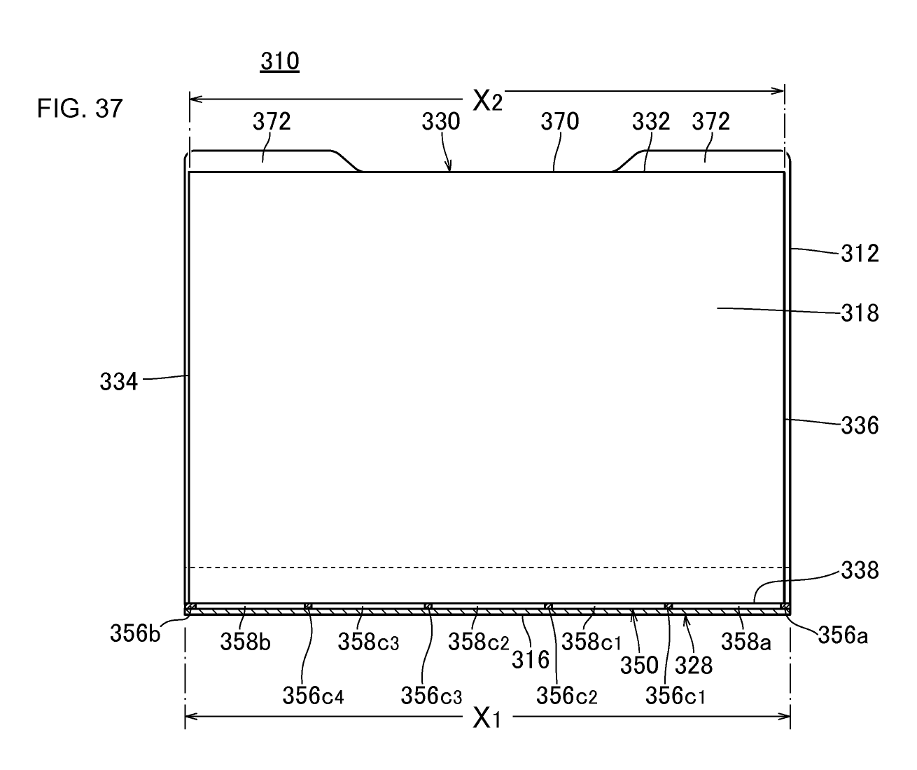

FIG. 35 is a perspective view of a pocket file in accordance with an embodiment of the present invention and FIG. 36 is a schematic perspective view of the pocket file in an open state as shown in FIG. 35. FIG. 37 is a schematic longitudinal section view of the pocket file in a close state as shown in FIG. 35.

A file 310 comprises a cover body having a front cover portion 312 comprising of synthetic-resin such as polypropylene, a back cover portion 314, and a spine portion 316 adjacently provided between the front cover portion 312 and the back cover portion. A group of pocket sheets 330 as a binding body superimposes a pocket sheet 318 as a binding sheet and is welded and connected to the a connecting end edge of the group of pocket sheets 330 as the binding body by being fastened the group of pocket sheets 330 as the binding body connected at a end edge which is connected to the spine portion 316.

The file 310 comprises a curved subsidiary portion which fixes the back of the cover body into an optional form in regions on a front cover side and on a back cover side of the spine portion 316 between the front cover portion 312 and the back cover portion 314 and the curved retaining portion formed to curve the end edge of the group of pocket sheets 330 as the binding body toward the direction of the pocket sheet 318 as the binding sheet extending at the inner side of the spine portion 316 adjacently provided between the front cover portion 312 and the back cover portion 314 when opened the cover.

The front cover portion 312 and the back cover portion 314 are adjacently provided to the spine portion 316 to cross at a substantially right angle via a linear front folding portion 324 and a linear back folding portion 326 and a linear front adjacently providing portion 320 and a linear back adjacently providing portion 322 crossing from the top edge to the bottom edge in the direction of the height of the front cover portion 312 and the back cover portion 314.

The pocket sheet 318 are flexibly formed between a part where the pocket sheet 318 is fastened to the inner side of the spine portion 316 between the front cover portion 312 and the back cover portion 314 and a part at least above the front folding portion 324 and the back folding portion 326 (when closed the cover body).

The pocket sheet 318 comprises a linear outer end edge 332, a linear bottom edge 334 and an opening edge 336 formed at a top end edge which is opposite from the bottom edge 334 and is connected to the inner surface of the spine portion 316 at the inner end edge 338 opposite from the linear outer end edge 332.

The pocket sheet 318 comprises a pocket portion 340 to accommodate an object to be bound S such as documents and is fitted for a mount 342 extending in the direction away from a part where the spine portion 316 is fastened to be inserted from a part above the front folding portion 324 and the back folding portion 326 (when closed the cover body) in the inner side of the pocket portion 340.

The group of pocket sheets 330 is connected by the curved retaining portion 350 adjacently provided at the front cover portion 312 and the back cover portion 314 at the connecting end edge connected to the group of pocket sheets 330.

A curved retaining portion 350 is comprised of substantially square rigid plate body in a planar view composed of thermoplastic synthetic resin and comprises the curved retaining portion which curves the group of pocket sheets 330 as the binding body, welded and connected at the connecting end edge of the group of pocket sheets 330 as the binding body, toward the direction of the pocket sheet 318 as the binding body extending, i.e. the direction away from the spine portion 316, when opened the cover body.

The curved retaining portion 350 is connected adjacent to the inner side of a hinge portion on the front cover side 360 and the inner side of a hinge portion on the back cover side 362 with optionally spaced from the group of the pocket sheets 330 in the cross direction such that the curved retaining portion 350 enables the end edge connected to the cover of the group of pocket sheet 330 to curve with the width shorter than the width of the spine portion 316 of the cover body.

The curved retaining portion 350 comprises a connecting portion on the front cover side 352 adjacently provided in the side of the front cover portion 312, a connecting portion on the back cover side 354 adjacently provided in the side of the back cover portion 314 and an interjacent connecting portion 356 interposing between the connecting portion on the front cover side 352 and the connecting portion on the back cover portion 354. The interjacent connecting portion 356 is connected to the end edge connected to the cover of the group of pocket sheets 330 and is formed to curve toward the opposite side of the spine portion 316 along with the end edge connected to the cover of the group of the pocket sheets 330 by the tension of the connecting portion on the front cover side 352 and the connecting portion on the back cover side 354 when opened the cover.

The curved retaining portion 350 is relatively flexible and is formed to arch toward the opposite side of the spine portion 316 by the weight of the pocket sheet 318 being in a spread state.

The front cover portion 312 and the connecting portion on the front cover side 352 are formed as an unified flat plate, and the back cover portion 314 and the connecting portion on the back cover side 354 are also formed as an unified flat plate.

The curved retaining portion 350 comprises of a thermoplastic synthetic resin sheet body such as polypropylene and the like in a square planar shape and has a through hole 358 drilled in the region connected to the binding body and is formed to curve.

The curved retaining portion 350 has a plurality of rectangular planar shaped through holes 358 drilled which are optionally spaced from one another and flexibility is provided thereto on the whole. In this embodiment, there are 6 through holes drilled, an upper through hole 358a, a lower through hole 358b, middle through holes 358c1, 358c2, 358c3 and 358c4.

In this embodiment, in the interjacent connecting portion 356, bridge portions 356a and 356b as a pair are crosslinked between the connecting portion on the front cover side 352 and the connecting portion on the back cover side 354 at the upper edge and the lower edge respectively. Bridge portions 356c1, 356c2 and 356c3 are crosslinked in between the middle through holes 358c1 and 358c3 and a bridge portion 356c4 is crosslinked in between the middle through hole 358c3 and the lower through hole 358b; therefore, the adhesion region of the group of pocket sheets 330 and the interjacent connecting portion 356 is formed.

Further, a longitudinal bridge portion 356e is formed between a hinge portion on the front cover side 360 and the upper through hole 358a, the lower through hole 358b and the middle through holes 358c1, 358c2 and 358c3, and a longitudinal bridge portion 356f is formed between a hinge portion on the back cover side 362 and the upper through hole 358a, the lower through hole 358b and the middle through holes 358c1, 358c2 and 358c3.

The longitudinal bridge portion 356e and the longitudinal bridge portion 356f are successively formed to cross from the top edge to the bottom edge of the cover body.

On the curved retaining portion 350, the hinge portion on the front cover side 360 formed between the connecting portion on the front cover side 352 and the interjacent connecting portion 356 and the hinge portion on the back cover side 362 formed between the connecting portion on the back cover side 354 and the interjacent connecting portion 356 are formed parallel to each other.

The height between the spine portion 316 and the front folding portion 324 of the front cover portion 312 and the back folding portion 326 of the back cover portion 314 respectively is formed to be substantially equal or shorter than the height between the hinge portion on the front cover side 360 of the curved retaining portion 350 and the inner surface of the front cover portion 312 and the hinge portion on the back cover side 362 and the inner surface of the back cover portion 314. The hinge portion in the front cover side 360 and the hinge portion on the back cover side 362 are formed to position adjacent to the end edge of the spine portion 316 in cross direction when closed the cover body.

The interjacent connecting portion 356 between the hinge portion on the front cover side 360 and the hinge portion on the back cover side 362 is formed to curve toward the opposite side of the spine portion 316 when opened the front cover portion 312 and also the width between the hinge portion on the front cover side 360 and the hinge portion on the back cover side 362 is formed to be shorter than the width of the spine portion 316.

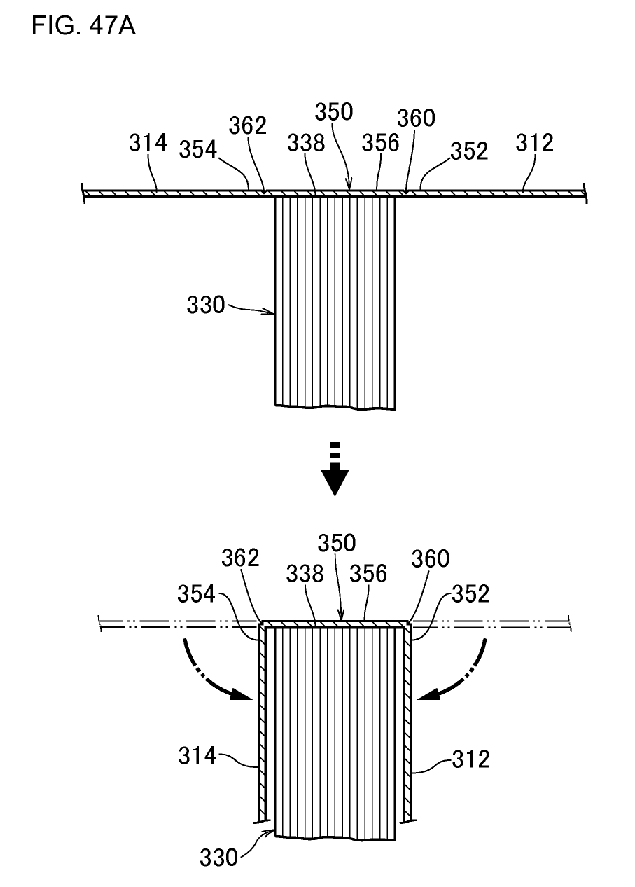

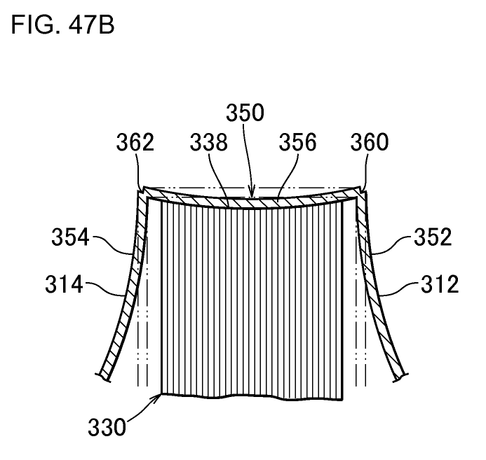

The longitudinal bridge portion 356e and the connecting portion on the front cover side 352 adjacently providing the hinge portion on the front cover side 360 in between bisect at substantially right angles to retain the shape when load is not applied and also the longitudinal bridge portion 356f and the connecting portion on the back cover side 354 adjacently providing the hinge portion on the back cover side 362 in between bisect at substantially right angles to retain the shape when load is not applied. When the connecting portion on the front cover side 352 side or the connecting portion on the back cover side 354 side opens corresponding when opened the front cover portion 312 or the back cover portion 314, degree of the angle between the longitudinal bridge portion 356e and the connecting portion on the front cover side 352 expands, and the angle between the longitudinal bridge portion 356f and the connecting portion on the back cover side 354 expands. When the expansion of those angles become substantially 120 to 130 degrees, and the curved retaining portion 350 is lifted toward the direction away from the spine portion 316 with the elasticity of the material comprising the curved retaining portion 350 and the elasticity adjacent to the both ends of the hinge portion on the front cover side 360 and the hinge portion on the back cover side 362 of the both sides (see FIG. 47B).

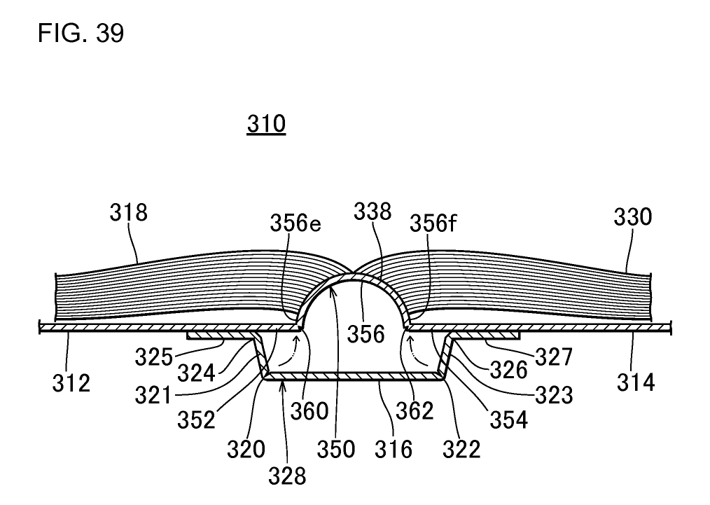

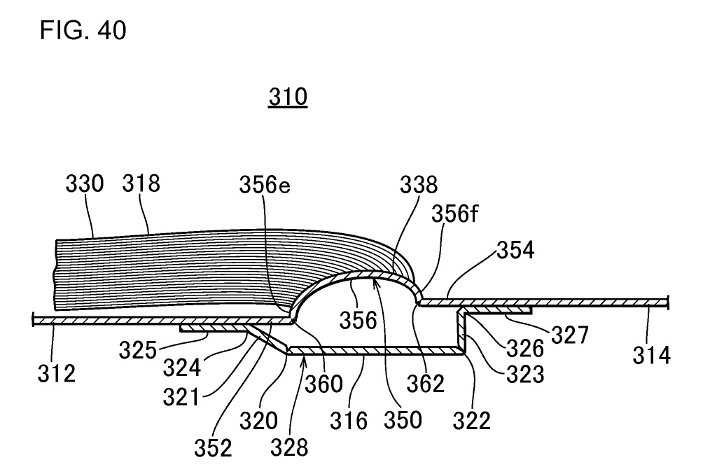

The front cover portion 312 and the back cover portion 314, as shown in FIGS. 36 through 40, form a curved subsidiary portion which fixes the back of the binding body into an optional form in a region on a front cover side and a region on a back cover side of the spine portion 316 between the front cover portion 312 and the back cover portion 314. In this embodiment, the curved subsidiary portion is comprised as an independent curved subsidiary member 328.

The curved subsidiary member 328 comprises of a thermoplastic synthetic resin sheet body such as polypropylene and the like in a square planar shape. The font folding portion 324 and the back folding portion 326 crossing from the upper edge to the lower edge are successively formed and the curved subsidiary portion 328 is formed in the region from the front folding portion 324 on the front cover portion 312 to the spine portion 316, the region from the back folding portion 326 on the back cover portion 314 to the spine portion 316 and the spine portion 316.

In curved subsidiary member 328, the connecting portion on the front cover side 352 having the front folding portion 324 as an axis sways upwardly in the region on the spine portion 316 on the front cover side crosslinked between the front cover portion 312 and the back cover portion 314, and the connecting portion on the back cover side 354 having the back folding portion 326 as an axis sways upwardly, and the curved subsidiary portion 328 forms the curved subsidiary portion which enables the curved retaining portion 350 to arch upwardly, i.e. toward the direction away from the spine portion 316, when the front cover portion 312 and the back cover portion 314 become substantially horizontal and become parallel to the curved subsidiary member 328 of the horizontal spine portion 316.

On the front cover portion 312 and the back cover portion 314, the front folding portion 324 and the back folding portion 326 are formed parallel to the front adjacently providing portion 320 and the back adjacently providing portion 322 in the direction of their heights crossing from the top edge to the bottom edge thereof adjacent to the front adjacently providing portion 320 and the back adjacently providing portion 322.

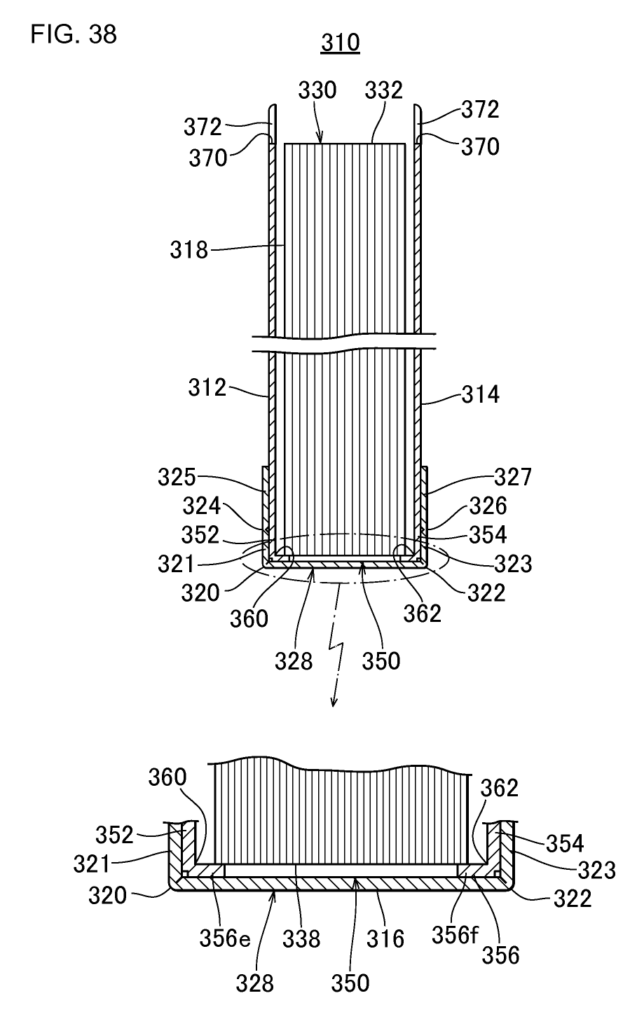

The length of the inner face of the spine portion 316 and the front folding portion 324 and the length of the inner face of the spine portion 316 and the back folding portion 326 are formed to be equal (shown in FIG. 38).

A square shape retaining portion 323 adjacently provided via the front adjacently providing portion 320 on the side of the front adjacently providing portion 320 of the spine portion 316 is formed and a square shape retaining portion 323 adjacently provided via the back adjacently providing portion 322 on the side of the back adjacently providing portion 322 is formed.

A square shape fastening portion on the front cover side 325 adjacently provided via the front folding portion 324 on the side of the front folding portion 324 of the shape retaining portion 321 is formed and a square shape fastening portion on the back cover side 327 adjacently provided via the back folding portion 326 on the side of the back folding portion 326 is formed.

The curved subsidiary member 328 has an angular structure and forms a grip portion such that the user can set the spine portion 316 on his palm, grip the curved subsidiary portion 328 with his fingers and open the pocket sheet 318.

On the front cover portion 312 and the back cover portion 314, a recess for search 370 is formed on the free end edge opposite side from the spine portion 316, i.e. the left side end edge of the front cover portion 312 and the right side end edge of the back cover portion 314, in the middle of the direction of the height thereof.

The outer end edge of the recess for search 370 and the outer end edge 332 of the pocket sheet 318 are uniformed. Accordingly, with one hand, folding the file 310 with the cover closed, especially gripping the curved subsidiary portion 328 and placing the other hand to the recess for search 370 enables to flip the front cover portion 312 or the back cover portion 314 and the pocket sheet 318.

The file 310 can be flipped from the pocket sheet 318 positioned on the upper side to the pocket sheet positioned on the lower side with the user's fingers placed the outermost part of the outer end edge 332 of the pocket sheet 318 and slightly bend the front cover portion 312 or the back cover portion 314 in the recess for search 370 as shown in FIG. 20.

On the front cover portion 312 and the back cover portion 314, a pair of projection portions 372 on the upper side and the lower side is formed respectively to cover the index i formed on the pocket sheet 318 such that the projection portion 372 is projected toward the outer side from the end edge for spread, i.e. the outer end edge 332, of the pocket sheet 318 on the outside of the region that the recess portion for search 370 is formed.

The end edge of the group of pocket sheet 330 as the binding body connected to the spine portion 316 when opened the cover body is formed to curve toward the opposite side of the spine portion 316.

The pocket sheet 318 as the binding body comprises pockets combined with thermoplastic resin sheets, each pocket sheet 318 is hot-adhered to another on the end edge connected to the cover thereof, and the end edge connected to the spine portion 316 is formed to curve inwardly when opened the pocket sheet 318.

The hinge portion on the front cover side 360 is formed to be positioned inner than the front folding portion 324 and the hinge portion on the back cover side 362 is formed to be positioned inner than the back adjacently providing portion 322 so as the width (T2) between the hinge portion on the front cover side 360 and the hinge portion on the back cover side 362 is shorter than the width (T1) between the front adjacently providing portion 320 and the back adjacently providing portion 322 when opened the cover body, i.e. when the connecting portion on the front cover side 352 and the connecting portion on the back cover side 354 are apposed at the horizontal plane in a flat state and the front cover portion 312 and the back cover portion 314 are apposed at the horizontal plane in the flat state.

Additionally, although the width (T1) between the front adjacently providing portion 320 and the back adjacently providing portion 322 and the width (T3) between the hinge portion on the front cover side 360 and the hinge portion on the back cover side 362 are substantially equal, (T3) is shorter as much as the thickness of the front adjacently providing portion 320 and the back adjacently providing portion 322 than (T1) since the hinge portion on the front cover side360 and the hinge portion on the back cover side 362 is fastened to the inner surface of the front adjacently providing portion 320 and the back adjacently providing portion 322 when closed the cover body, i.e. when the front cover portion 312 and the back cover portion 314 become parallel and the connecting portion on the front cover side 352 and the connecting portion on the back cover portion 354 become parallel.

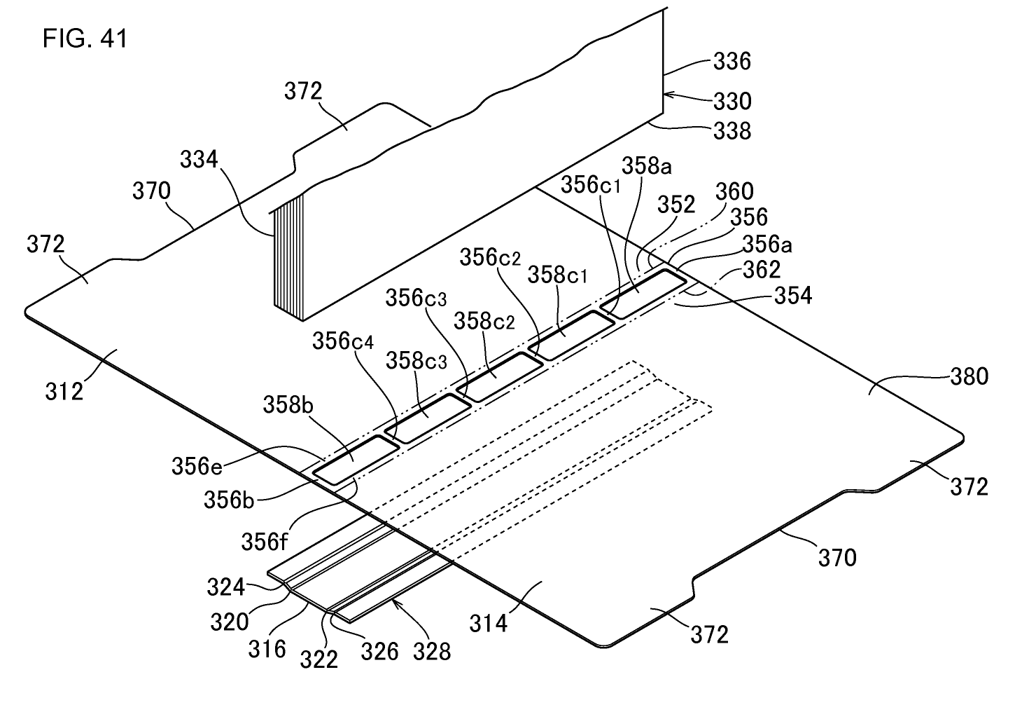

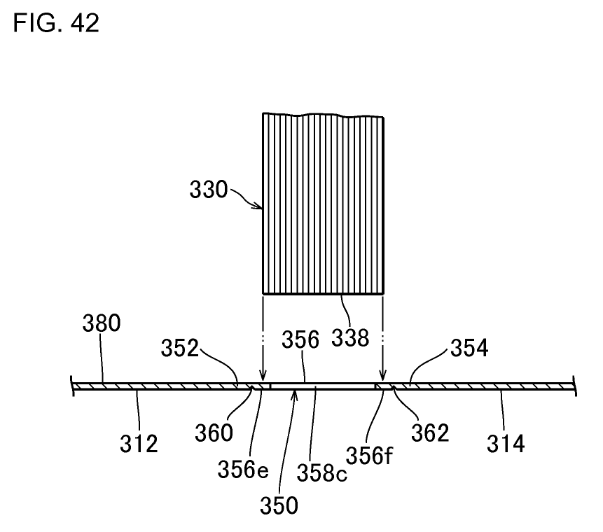

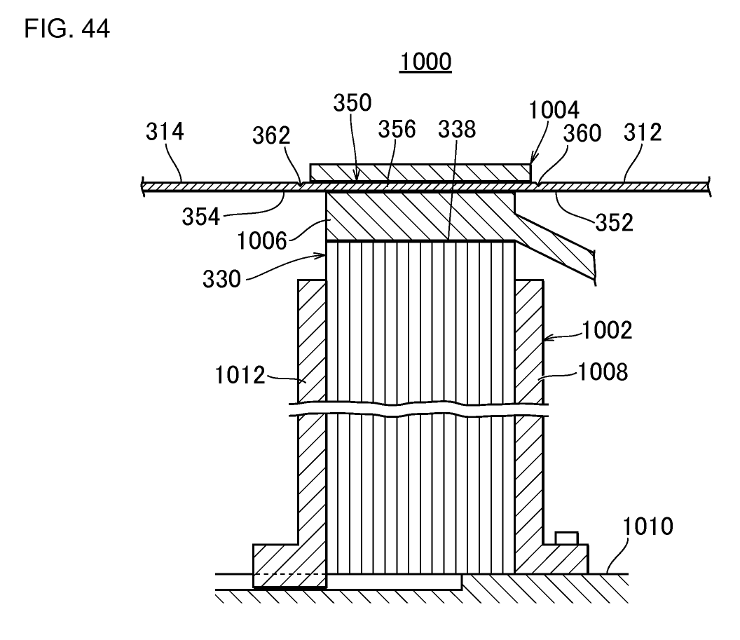

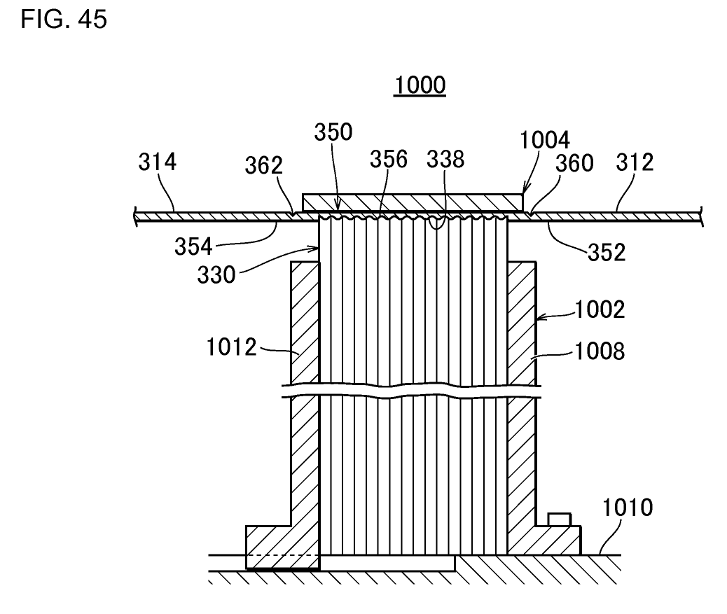

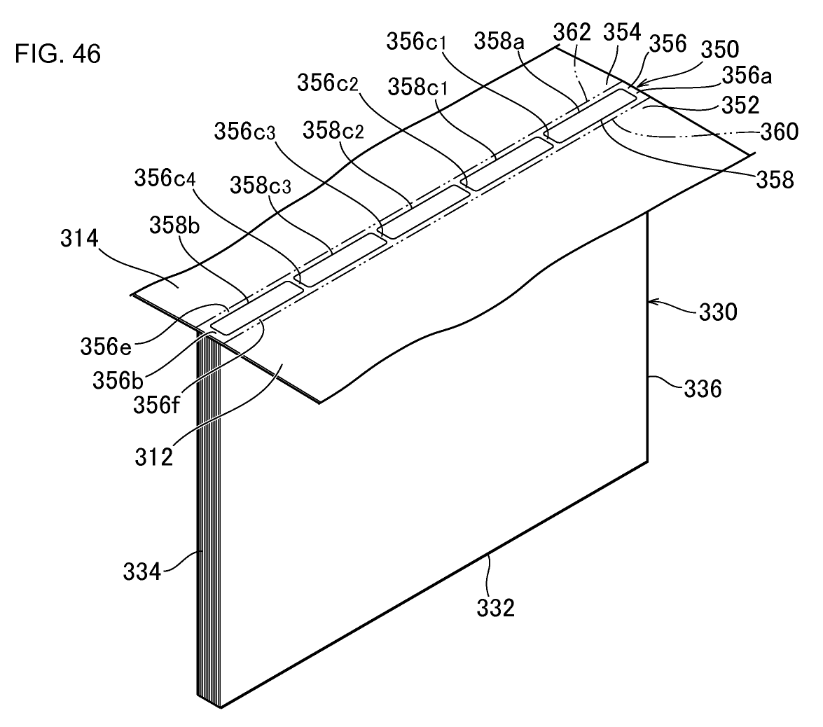

Next, the method of manufacturing the file 310 shown in FIG. 35 of the present invention will be described below with referring to FIGS. 41 through 46.

First, a plurality of pocket sheets 318 is superimposed, and the edge faces of the inner end edge 338 facing one another are heated. Consequently, the region which is slightly inner than the inner end edge 338 is melted to fasten. To apply hot welding to the inner end edge 338 of the pocket sheet 318, a hot plate is pressed to the inner end edge 338, the adjacency of the inner end edge 338 is welded and the edge faces of the inner end edge 338 facing one another are adhered to form the group of pocket sheets 330. Adhesion and welding can be done with hot-melt adhesive agent or by ultrasonic horn respectively.

The group of pocket sheets 330 comprises pockets combined with thermoplastic resin sheets, each binding sheet is hot adhered to another on the end edge connected to the cover thereof, and the end edge connected to the cover is formed to curve inwardly when opened the pocket sheet 318.

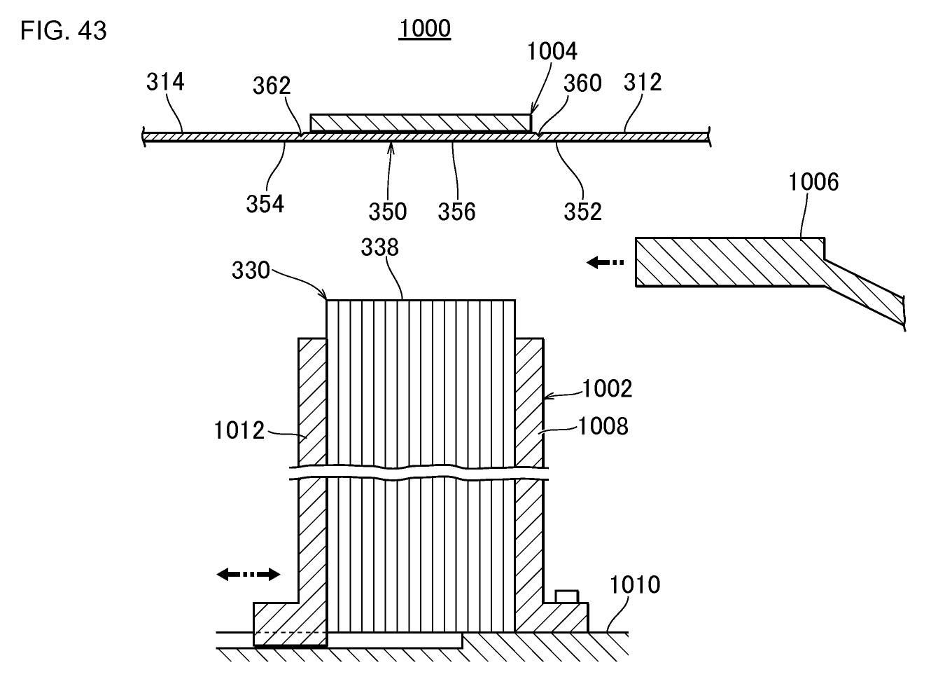

Next, the method for fixing the group of pocket sheets 33to the curved retaining portion 350 of the cover body will be described with referring to FIGS. 43 through 49.

First, an original material (a synthetic resin sheet body such as polypropylene and the like) is prepared, Thompson processing is applied thereto and the cover material 380 is removed, which will be the cover of the file and forms a cover material 380 in a combined size of the front cover portion 312, the back cover portion 314 and the curved retaining portion 350 together (Cover material molding step).

For forming the curved retaining portion 350 with the cover material 380 comprising of a thermoplastic synthetic resin sheet body such as polypropylene and the like in a square planar shape, the curved retaining portion 350 is formed by demarcating the interjacent connecting portion 356 interposed between the connecting portion on the front cover side 352 connected to the front cover portion 312 and the connecting portion on the back cover side 354 connected to the back cover portion 314 from the cover material 380.

The interjacent connecting portion 356 is connected to the end edge connected to the cover of the binding body and is formed to curve toward the opposite side of the spine portion 316 along with the end edge connected to the cover of the group of the pocket sheets 330 as the binding body by the tension of the connecting portion on the front cover portion 352 and the connecting portion on the back cover portion 354 when opened the cover.

The curved retaining portion 350 comprises of a thermoplastic synthetic resin sheet body such as polypropylene and the like in a square planar shape and has the through hole 358 drilled in the region connected to the group of pocket sheets 330 and is formed to curve. The group of pocket sheets 330 is adhered to the inner surface of the bridge portions 356a, 356b, 356c1, 356c2, 356c3 and 356c4 of the curved retaining portion 350 and also to the inner surface of the longitudinal bridge portion 356e and 356f with slightly spaced between the hinge portion on the front cover side 360 and the hinge portion on the back cover side 362.

The group of pocket sheets 330 is applied hot welding to the upper surface of the interjacent connecting portion 356.

The curved retaining portion 350 is formed by the hinge portion on the front cover side 360 and the hinge portion on the back cover side 362 between the connecting portion on the front cover side 352 and the interjacent connecting portion 356 and between the connecting portion on the back cover side 354 and the interjacent connecting portion 356.

The height between the spine portion 316 and the front folding portion 324 of the front cover portion 312 and the back folding portion 326 of the back cover portion 314 respectively is formed to be substantially equal or shorter than the height between the hinge portion on the front cover side 360 of the curved retaining portion 350 and the inner surface of the front cover portion 312 or the hinge portion on the back cover side 362 and the inner surface of the back cover portion 314. The hinge portion on the front cover side 360 and the hinge portion on the back cover side 362 are formed to position adjacent to the end edge of the spine portion 316 in cross direction when closed the cover.

In this embodiment, a cover material 180 which is originally a flat plate is applied folding process. The longitudinal bridge portion 356e and the connecting portion on the front cover side 352 adjacently providing the hinge portion on the front cover side 360 in between bisect at substantially right angles to retain the shape when load is not applied and also the longitudinal bridge portion 356f and the connecting portion on the back cover side 354 adjacently providing the hinge portion on the back cover side 362 in between bisect at substantially right angles to retain the shape when load is not applied.

Molding process is done by folding the connecting portion on the front cover side 352 having the hinge portion on the front cover side 360 in the middle until it is substantially at a right angle to the interjacent connecting portion 356 and folding the connecting portion on the back cover side 354 having the hinge portion on the back cover side 362 in the middle until it is substantially at a right angle to the interjacent connecting portion 356.

When the connecting portion on the front cover side 352 side or the connecting portion on the back cover side 354 side opens corresponding when opened the front cover portion 312 or the back cover portion 314, degree of the angle between the longitudinal bridge portion 356e and the connecting portion on the front cover side 352 expands, and the angle between the longitudinal bridge portion 356f and the connecting portion on the back cover side 354 expands. When the expansion of those angles become substantially 120 to 130 degrees, and the curved retaining portion 150 is formed to be lifted toward the direction away from the spine portion 316 with the elasticity of the material comprising the curved retaining portion 350 and the elasticity adjacent to the both ends of the hinge portion on the front cover side 360 and the hinge portion on the back cover side 362 of the both sides

The interjacent connecting portion 356 between the hinge portion on the front cover side 360 and the hinge portion on the back cover side 362 is formed to curve toward the opposite side of the spine portion 316 when opened the cover portion 312 and also the width of the interjacent connecting portion 356 is formed to be shorter than the width of the spine portion 316.

Next, the method for adhering the group of pocket sheets 330 to a cover material 380 will be described.

The curved retaining portion 350 is connected adjacent to the hinge portion on the front cover side 360 of the front cover portion 312 and the hinge portion on the back cover side 362 of the back cover portion 314 with optionally spaced from the group of the pocket sheets 330 in the cross direction such that the curved retaining portion 350 enables the end edge connected to the cover of the group of pocket sheet 330 to curve with the width shorter than the width of the spine portion 316 of the cover body.

The curved retaining portion 350 is welded to the connecting portion on the front cover side 352 connected to the side of the front cover portion 312 and the outer surface of the front cover portion 312 and also to the connecting portion on the back cover side 354 on the side of the back cover portion 314 and the outer surface of the back cover potion 314 and is crosslinked between the front cover portion 312 and the back cover portion 314.

In accordance with the embodiment previously described, the curved retaining portion 350 comprises the connecting portion on the front cover side 352 connected to the side of the front cover portion 312, the connecting portion on the back cover side 354 connected to the side of the back cover portion 314 and the interjacent connecting portion 356 interposing between the connecting portion on the front cover side 352 and the connecting portion on the back cover portion 354. The interjacent connecting portion 356 is connected to the end edge connected to the cover of the binding body and is formed to curve toward the opposite side of the spine portion 316 along with the end edge connected to the cover of the binding body by the tension of the connecting portion on the front cover portion 352 as the rigid body and the connecting portion on the back cover portion 354 as the rigid body when opened the cover body.

The hinge portion on the front cover side 360 and the hinge portion on the back cover side 362 are formed between the connecting potion on the front cover side 352 and the interjacent connecting portion 356 and between the connection portion on the back cover side 354 and the interjacent connecting portion 356.

Next, for forming the curved subsidiary portion 328, a thermoplastic synthetic resin sheet is prepared; Thompson processing is applied thereto; and the curved subsidiary portion 328 is punched out in a square planar shape.

Further, a spine index paper Z is pasted to the surface of the spine area, which will later become the spine portion 316 with adhesive agent (Spine index paper pasting step).

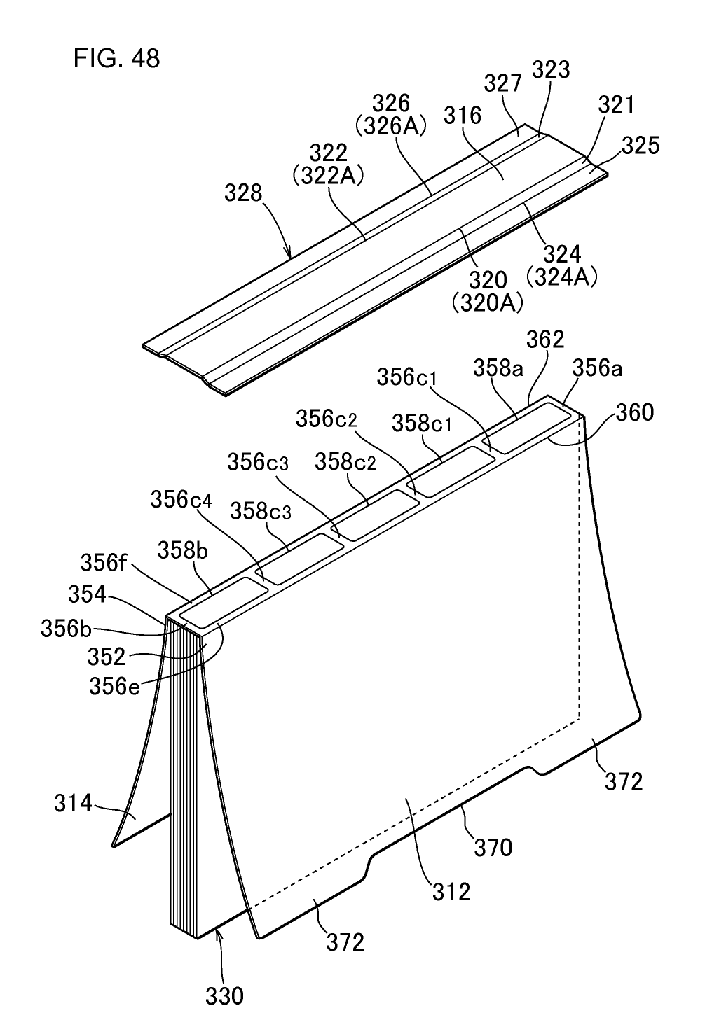

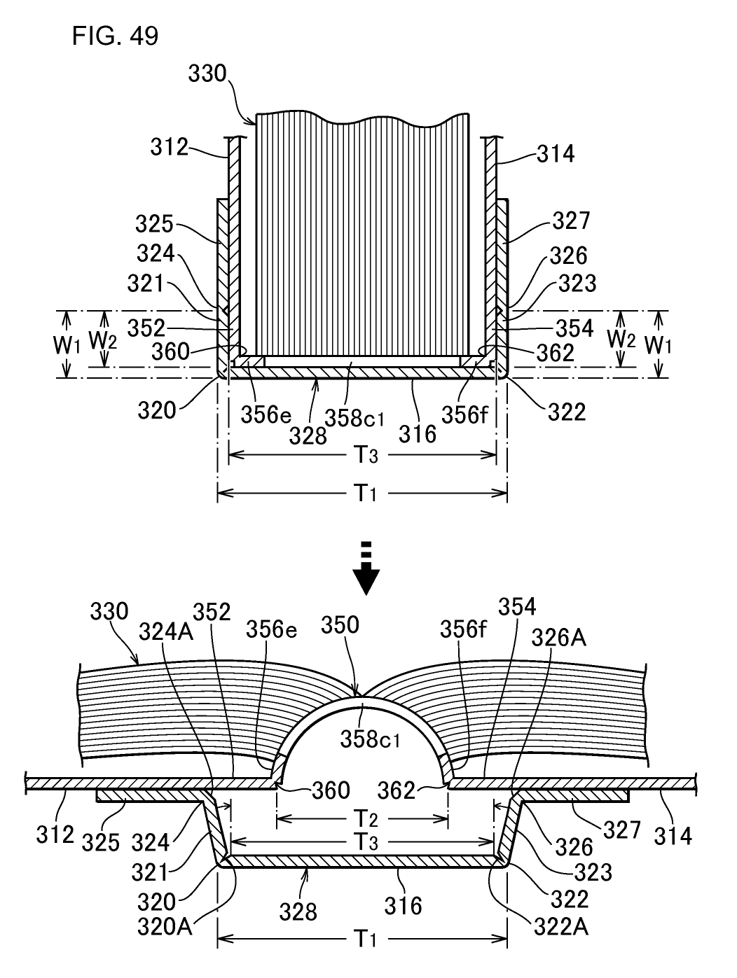

For example, as shown in FIGS. 48 and 49, when a thermoplastic resin sheet is used as the curved subsidiary member 328, the heat-press molding is applied with the V-shape heater (not shown) to V-shape slots 320A, 322A, 324A and 326A which have substantially V-shape section and are parallel to one another for forming the front adjacently providing portion 320, the back adjacently providing portion 322, the front folding portion 324 and the back folding portion 326. Then, the cover material 380 is formed to enable to fold (V-shape slot molding step).

Next, the longitudinal bridge portion 356e and the connecting portion on the front cover side 352 adjacently provided with the hinge portion on the front cover side 360 in between are formed to bisect at substantially right angles to retain the shape and also the retaining portion 321 and the retaining portion 323 of the curved subsidiary portion 328 formed to retain the shape as bisecting with the spine portion 316 in a state that the longitudinal bridge portion 356f and the connecting portion on the back cover side 354 adjacently provided with the hinge portion on the back cover side 362 in between bisect at substantially right angles to retain the shape. Then, a fastening portion on the front cover side 325, the connecting portion on the front cover side 352, a fastening portion on a back cover side 327 and the connecting portion on the back cover side 354 are adhered.

Then, the cover body comprising a crosslinked curved subsidiary portion 328 is formed by fastening adjacency of the outer end edge of the front cover portion 320 at the outer surface of the front cover portion 312 and the outer side then the hinge portion on the front cover side 360 and also fastening adjacency of the back adjacently providing portion 322 at the outer surface of the back cover portion 314 and the outer side than the hinge portion on the back cover side 362.

The height (W1) between the spine portion 316 and the front folding portion 324 of the front cover portion 312 and the back folding portion 326 of the back cover portion 314 respectively is formed to be substantially equal to the height (W2) between the hinge portion on the front cover side 360 of the curved retaining portion 350 and the inner surface of the front cover portion 312 or the hinge portion on the back cover side 362 and the inner surface of the back cover portion 314 and (W2) is shorter as much as the thickness of the spine portion 316 than (W1).

The hinge portion in the front cover side 360 and the hinge portion on the back cover side 362 are positioned adjacent to the end edge of the spine portion 316 in cross direction when closed the cover body. The hinge portion on the front cover side 360 and the hinge portion on the back cover side 362 are formed to curve toward the opposite side of the spine portion 316 when opened the cover body and also the width between the hinge portion on the front cover side 360 and the hinge portion on the back cover side 362 is formed to be shorter than the width of the spine portion 316. Accordingly, when opened the cover body and spread the group of pocket sheets 330, the pocket sheet 318 can become flat.

The present invention is not limited to the embodiments herein; however, the invention can be variously altered base on the idea of the present invention

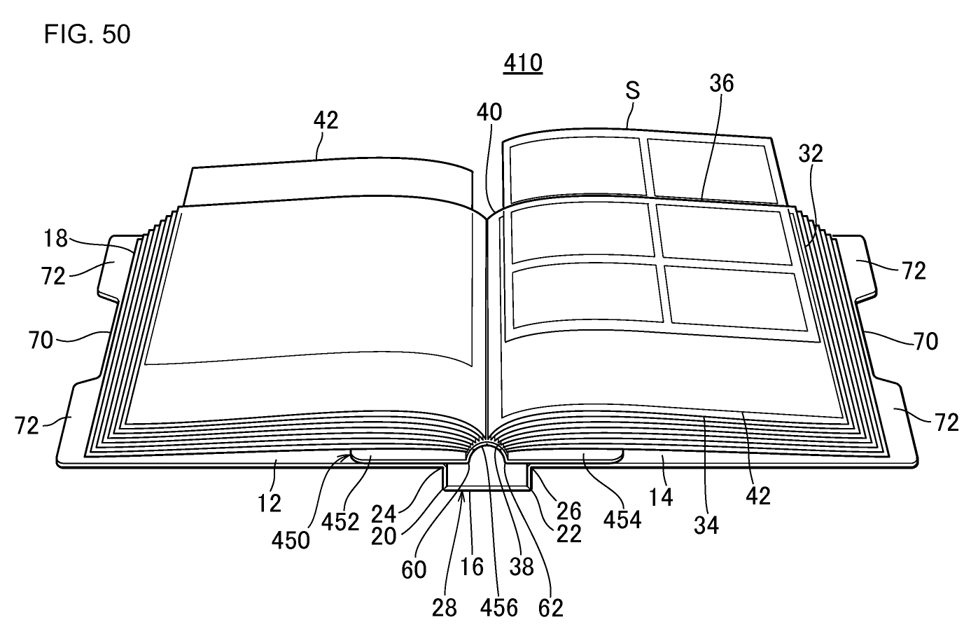

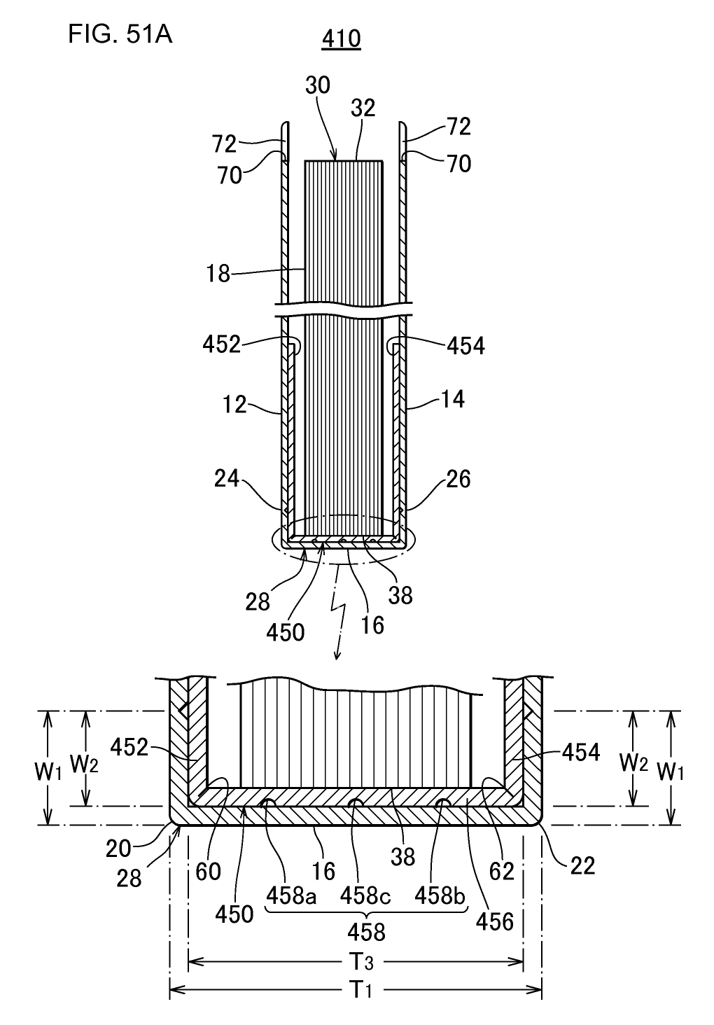

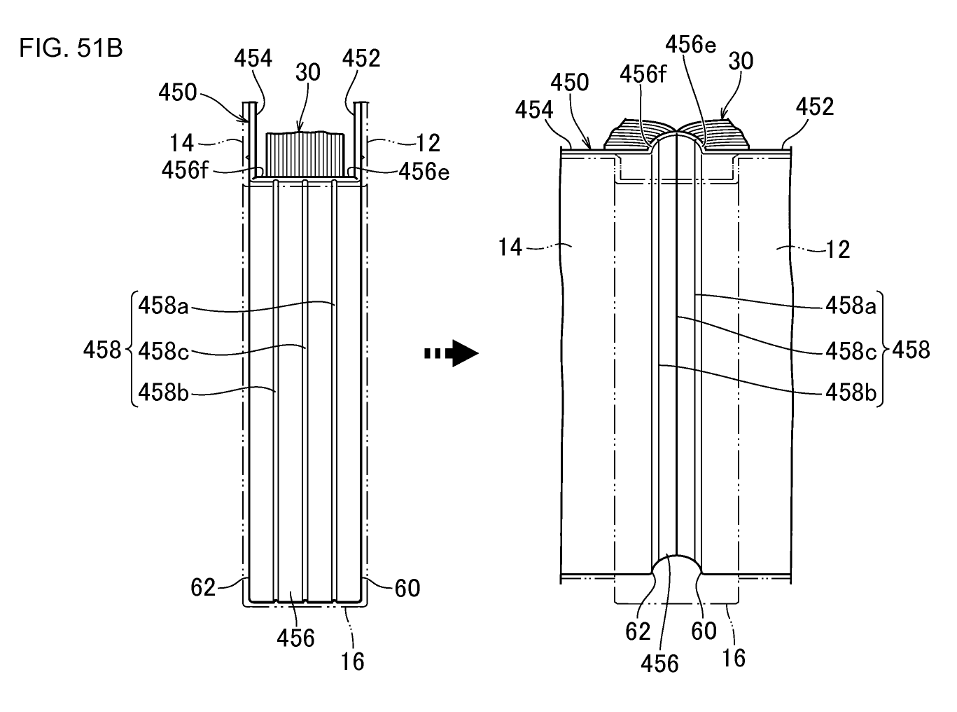

The pocket file shown in FIG. 1 can be altered as shown in FIGS. 50 through 52.

A file 410 comprises the curved retaining portion formed to curve the end edge of the group of pocket sheets 30 as the binding body toward the direction of the pocket sheet 18 as the binding sheet extending at the inner side of the spine portion 16 adjacently provided between the front cover portion 12 and the back cover portion 14 when opened the cover and also comprises a curved subsidiary portion which fixes the back of the cover body into an optional form in a region on a front cover side and a region on a back cover side of the spine portion 16 between the front cover portion 12 and the back cover portion 14.

As shown in FIGS. 50 through 52, the font folding portion 24 and the back folding portion 26 crossing from the top edge to the bottom edge are formed adjacent to the front connecting portion 20 and the back connecting portion 22 of the front cover portion 12, the back cover portion 14 and the spine portion 16, and the grip portion 28 is formed in the region from the front folding portion 24 on the front cover portion 12 to the spine portion 16, the region from the back folding portion 26 on the back cover portion 14 to the spine portion 16 and the spine portion 16.

In grip portion 28, the connecting portion on a front cover side 452 having the front folding portion 24 as an axis sways upwardly in the region on the spine portion 16 on the front cover side between the front cover portion 12 and the back cover portion 14, and the connecting portion on a back cover side 454 having the back folding portion 26 as an axis sways upwardly and the grip portion 28 forms the curved subsidiary portion which enables a connecting portion 450 as a curved subsidiary portion to arch upwardly, i.e. toward the direction away from the spine portion 16, when the front cover portion 12 and the back cover portion 14 become substantially horizontal, and the grip portion 28 becomes parallel to the horizontal spine portion 16.

On the front cover portion 12 and the back cover portion 14, the front folding portion 24 and the back folding portion 26 are formed parallel to the front adjacently providing portion 20 and the back adjacently providing portion 22 in the direction of their heights crossing from the top edge to the bottom edge thereof adjacent to the front adjacently providing portion 20 and the back adjacently providing portion 22.

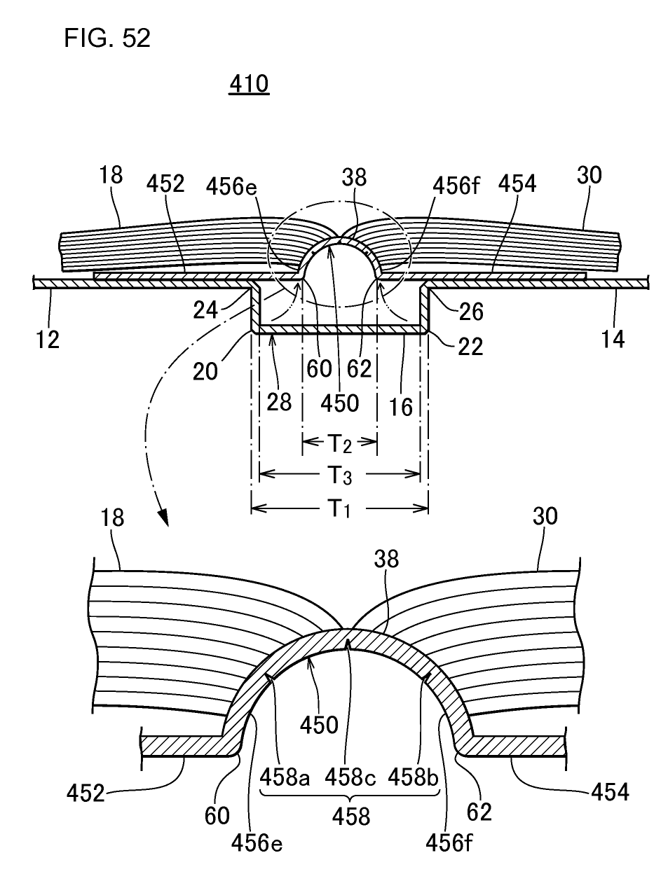

The length of the inner face of the spine portion 16 and the front folding portion 24 and the length of the inner face of the spine portion 16 and the back folding portion 26 are formed to be equal (shown in FIG. 52).

The mount 42 is provided such that the front folding portion 24 and the back folding portion 26 do not present adjacent to the mount 42.

The group of pocket sheets 30 is connected by the end edge connected thereto and the connecting portion 450 connecting the front cover portion 12 and the back cover portion 14.

The connecting body 450 is comprised of substantially square rigid plate body in a planar view composed of thermoplastic synthetic resin and comprises the curved retaining portion which curves the group of pocket sheets 30 as the binding body, welded and connected at the connecting end edge of the group of pocket sheets 30 as the binding body, toward the direction of the pocket sheet 18 as the binding body extending.

The connecting body 450 is connected adjacent to the front folding portion 24 of the front cover portion 12 and the back folding portion 26 of the back cover portion 14 with optionally spaced from the group of the pocket sheets 30 in the cross direction such that the connecting body 450 enables the end edge connected to the cover of the group of pocket sheet 30 to curve with the width shorter than the width of the spine portion 16 of the cover body.

The connecting body 450 comprises a connecting portion on the front cover side 452 connected to the side of the front cover portion 12, a connecting portion on the back cover side 454 connected to the side of the back cover portion 14 and an interjacent connecting portion 456 interposing between the connecting portion on the front cover side 452 and the connecting portion on the back cover side 454. The interjacent connecting portion 456 is connected to the end edge connected to the cover of the group of pocket sheets 30 and is formed to curve toward the opposite side of the spine portion 16 along with the end edge connected to the cover of the group of the pocket sheets 30 by the tension of the connecting portion on the front cover side 452 and the connecting portion on the back cover side 454 when opened the cover.

The interjacent connecting portion 456 is relatively flexible and is formed to curve toward the side the pocket sheet 18 as the binding sheet extending, i.e. toward the opposite side of the spine portion 16, by the weight of the pocket sheet 18 being in a spread state.

The interjacent connecting portion 456 of the connecting body 450 has a hinge slot 458 drilled in the region connected to the binding body and is formed to curve.

The interjacent connecting portion 456 of the connecting body 450 has a plurality of the hinge slots 458 on side of the spine portion 16 drilled which are optionally spaced from one another and flexibility is provided thereto on the whole. In this embodiment, there are 3 narrow slots drilled, an front hinge slot 458a, a back hinge slot 458b and a middle hinge slot 458c.

The connecting body 450 has the hinge slot 458 drilled parallel which are optionally spaced from the top edge to the bottom edge to provide flexibility and is formed to curve toward the opposite side of the back cover portion 16 when opened the pocket sheet 18. It differs from the embodiment shown in FIG. 1 in this respect.

On the connecting body 450, the hinge portion on the front cover side 60 formed between the connecting portion on the front cover side 452 and the interjacent connecting portion 456 and the hinge portion on the back cover side 62 formed between the connecting portion on the back cover side 454 and the interjacent connecting portion 456 are formed parallel to each other.

On the interjacent connecting portion 456, a longitudinal bridge portion 456e is successively formed adjacent to the hinge portion on the front cover side 60 to cross from the top edge to the bottom edge of the interjacent connecting portion 456 and a longitudinal bridge portion 456f is successively formed adjacent to the hinge portion on the back cover side 62 to cross from the top edge to the bottom edge of the interjacent portion 456.

The height between the spine portion 16 and the front folding portion 24 of the front cover portion 12 and the back folding portion 26 of the back cover portion 14 respectively is formed to be substantially equal or shorter than the height between the hinge portion on the front cover side 60 of the connecting body 450 and the inner surface of the front cover portion 12 and between the hinge portion on the back cover side 62 or the inner surface of the back cover portion 14. The hinge portion in the front cover side 60 and the hinge portion on the back cover side 62 are formed to position adjacent to the end edge of the spine portion 16 in cross direction when closed the cover.

The interjacent connecting portion 456 interposing between the hinge portion on the front cover side 60 and the hinge portion on the back cover side 62 is formed to curve toward the opposite side of the spine portion 16 and also the width between the hinge portion on the front cover side 60 and the hinge portion on the back cover side 62 is formed to be shorter than the width of the spine portion 16 when opened the front cover portion 12.

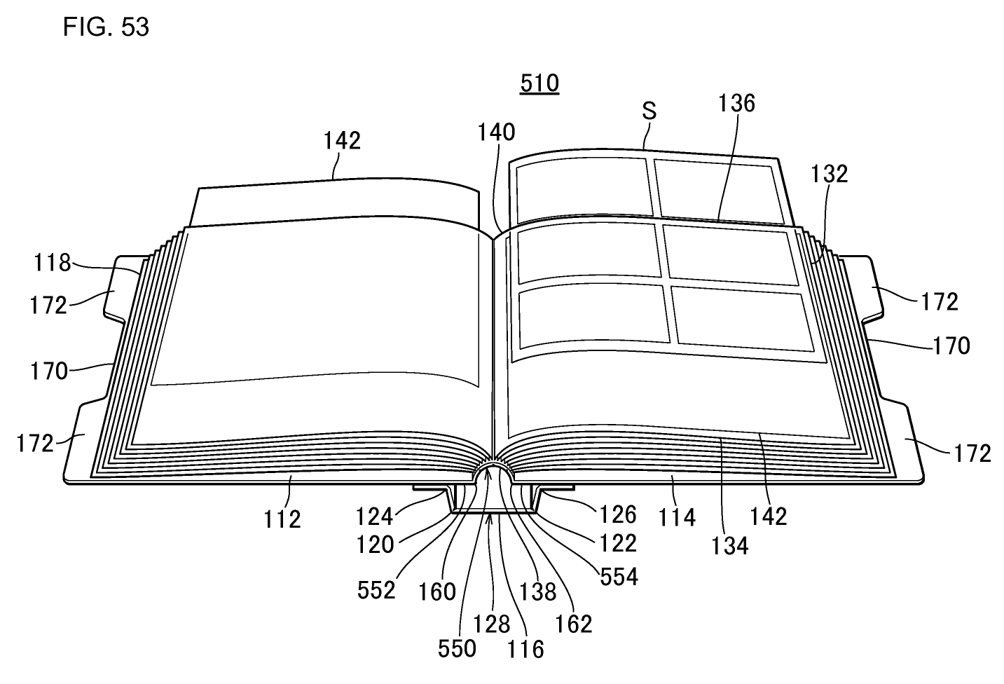

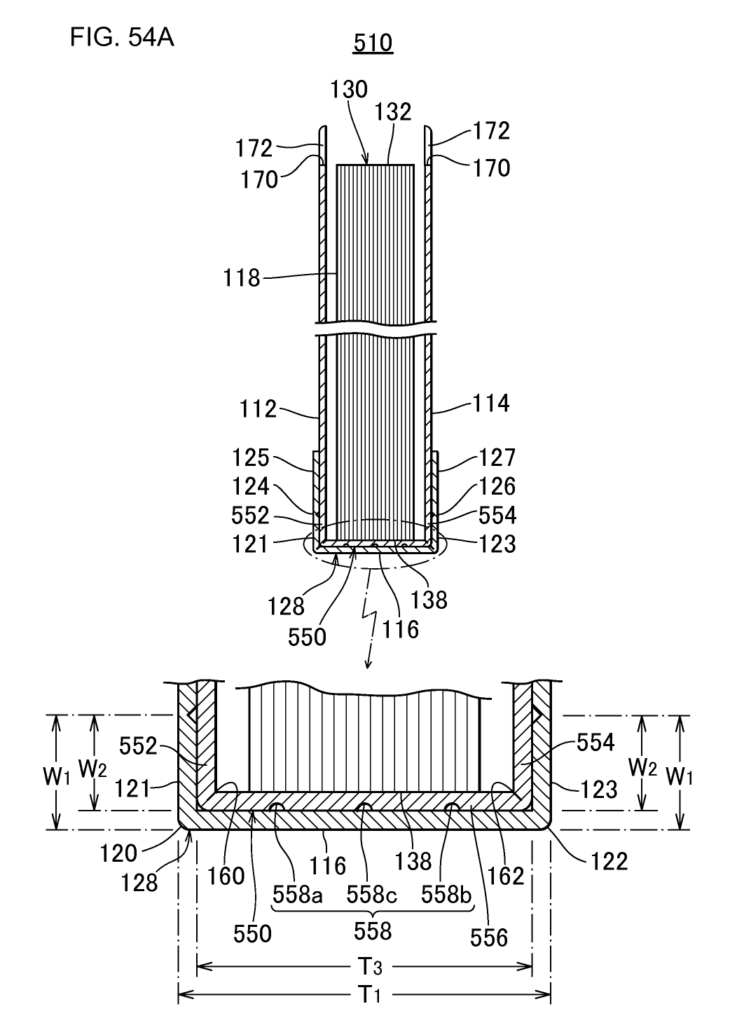

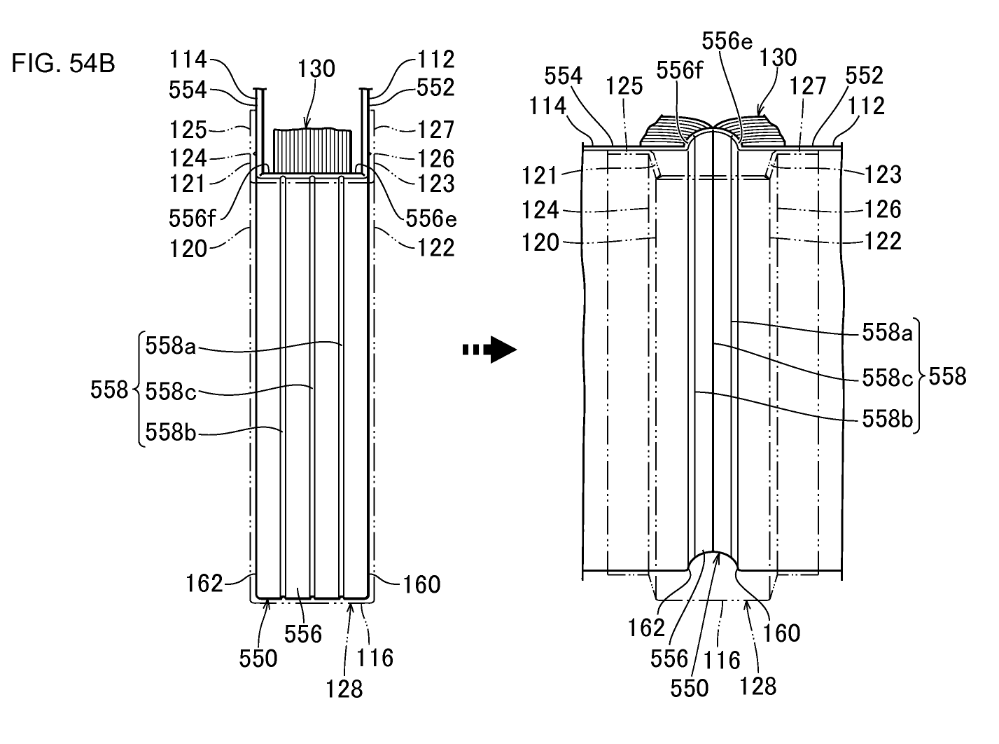

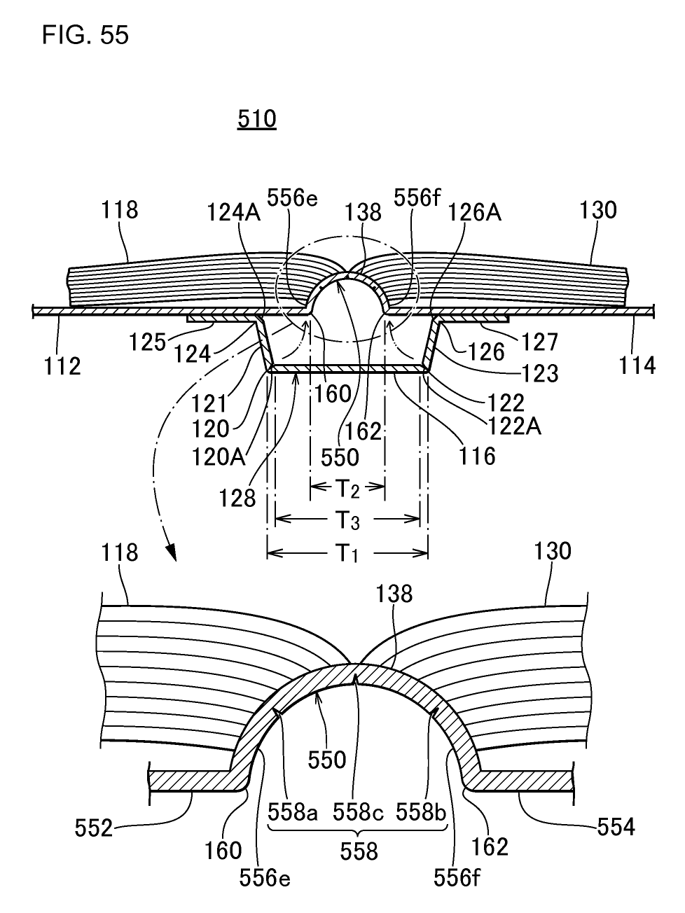

The pocket file shown in FIG. 21 can be altered as shown in FIGS. 53 through 55.

A file 510 comprises a curved subsidiary portion which fixes the back of the cover body into an optional form in regions on a front cover side and on a back cover side of the spine portion 116 between the front cover portion 112 and the back cover portion 114 and the curved retaining portion formed to curve the end edge of the group of pocket sheets 130 as the binding body toward the direction of the pocket sheet 118 as the binding sheet extending at the inner side of the spine portion 116 adjacently provided between the front cover portion 112 and the back cover portion 114 when opened the cover.

In this altered example, the curved subsidiary portion comprised as an independent curved subsidiary member 128 is equivalent to the pocket file shown in FIG. 21.

A curved retaining portion 550 is connected adjacent to the outer side of the hinge portion on the front cover side 160 and the outer side of the hinge portion on the back cover side 162 with optionally spaced from the group of the pocket sheets 130 in the cross direction such that the curved retaining portion 550 enables the end edge connected to the cover of the group of pocket sheet 130 to curve with the width shorter than the width of the spine portion 116 of the cover body.

The curved retaining portion 550 comprises the connecting portion on a front cover side 552 adjacently provided in the side of the front cover portion 112, the connecting portion on a back cover side 554 adjacently provided in the side of the back cover portion 114 and an interjacent connecting portion 556 interposing between the connecting portion on the front cover side 552 and the connecting portion on the back cover portion 554. The interjacent connecting portion 556 is connected to the end edge connected to the cover of the group of pocket sheets 130 and is formed to curve toward the opposite side of the spine portion 116 along with the end edge connected to the cover of the group of the pocket sheets 130 by the tension of the connecting portion on the front cover side 552 and the connecting portion on the back cover side 554 when opened the cover.

The curved retaining portion 550 is relatively flexible and is formed to arch toward the side of the pocket sheet 118 as the binding sheet extending, i.e. toward the opposite side of the spine portion 116, by the weight of the pocket sheet 118 being in a spread state.

The interjacent connecting portion 556 of the curved retaining portion 550 comprises of a thermoplastic synthetic resin sheet body such as polypropylene and the like in a square planar shape and has a hinge slot 558 drilled in the region connected to the group of pocket sheets 130 and is formed to curve.

The interjacent connecting portion 556 of the curved retaining portion 550 has a plurality of the hinge slots 558 on side of the spine portion 116 drilled which are optionally spaced from one another and flexibility is provided thereto on the whole. In this embodiment, there are 3 narrow slots drilled, a front hinge slot 558a, a back hinge slot 558b and a middle hinge slot 558c.

The connecting body 550 has the hinge slot 558 drilled parallel which are optionally spaced from the top edge to the bottom edge to provide flexibility and is formed to curve toward the opposite side of the back cover portion 116 when opened the pocket sheet 118. It differs from the embodiment shown in FIG. 2 in this respect.

On the curved retaining portion 550, the hinge portion on the front cover side 160 formed between the connecting portion on the front cover side 552 and the interjacent connecting portion 556 and the hinge portion on the back cover side 162 formed between the connecting portion on the back cover side 554 and the interjacent connecting portion 556 are formed parallel to each other.

On the interjacent connecting portion 556, a longitudinal bridge portion 556e is successively formed adjacent to the hinge portion on the front cover side 160 to cross from the top edge to the bottom edge of the interjacent connecting portion 556 and a longitudinal bridge portion 556f is successively formed adjacent to the hinge portion on the back cover side 162 to cross from the top edge to the bottom edge of the interjacent portion 556.

The height between the spine portion 116 and the front folding portion 124 of the front cover portion 112 and the back folding portion 126 of the back cover portion 114 respectively is formed to be substantially equal or shorter than the height between the hinge portion on the front cover side 160 of the curved retaining portion 550 and the inner surface of the front cover portion 112 and the hinge portion on the back cover side 162 and the inner surface of the back cover portion 114. The hinge portion in the front cover side 160 and the hinge portion on the back cover side 162 are formed to position adjacent to the end edge of the spine portion 116 in cross direction when closed the cover body.

The interjacent connecting portion 556 between the hinge portion on the front cover side 160 and the hinge portion on the back cover side 162 is formed to curve toward the opposite side of the spine portion 116 when opened the front cover portion 112 and also the width between the hinge portion on the front cover side 160 and the hinge portion on the back cover side 162 is formed to be shorter than the width of the spine portion 116.

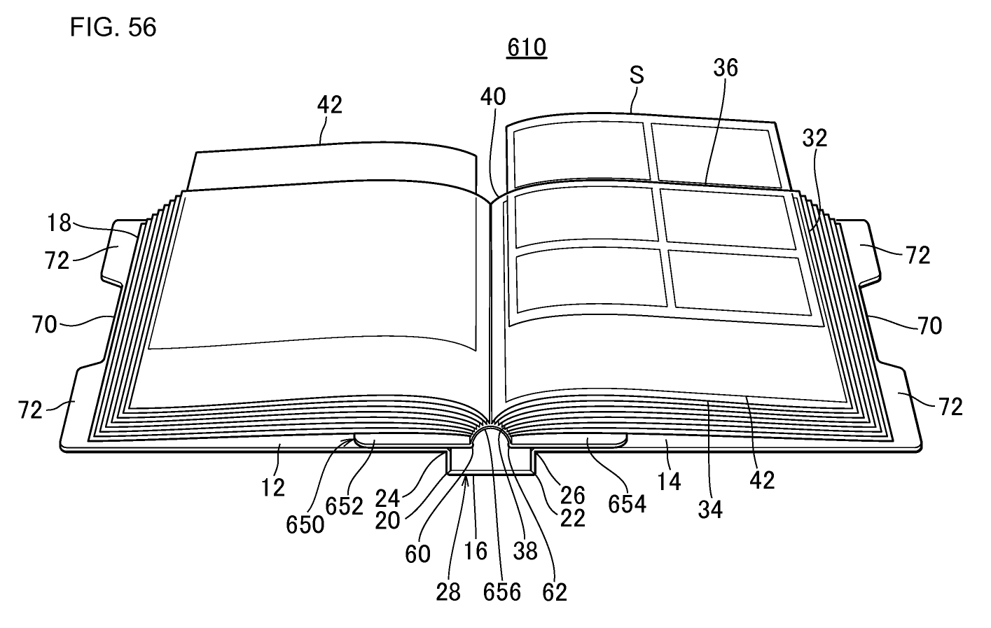

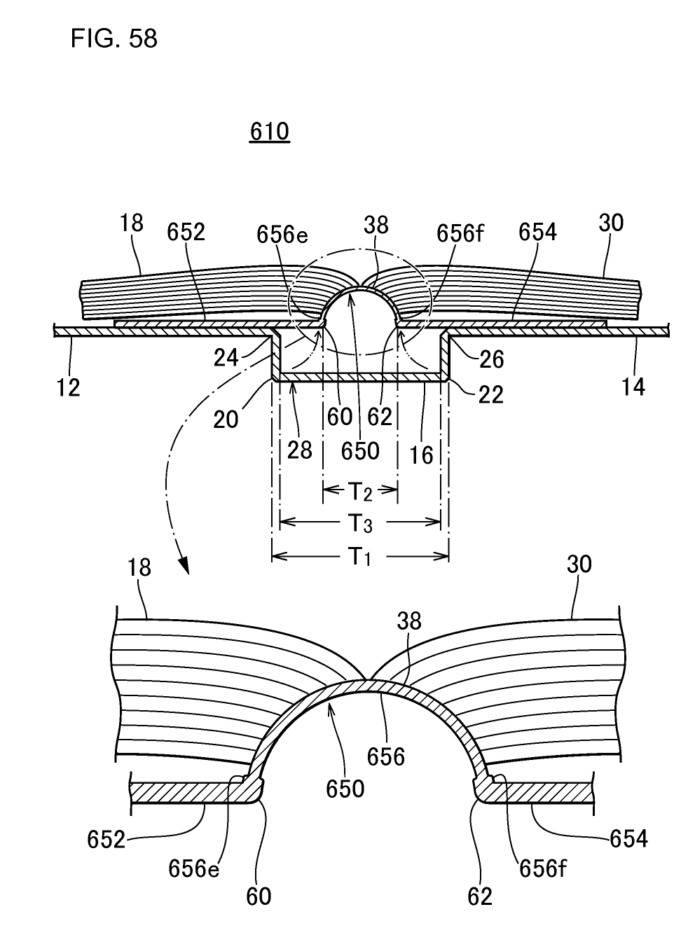

Further, the pocket file shown in FIG. 1 can be altered as shown in FIGS. 56 through 58.

A file 610 comprises a curved retaining portion formed to curve the end edge of the group of pocket sheets 30 as the binding body toward the side of the pocket sheet 18 as the binding sheet extending at the inner side of the spine portion 16 adjacently provided between the front cover portion 12 and the back cover portion 14 when opened the cover and also comprises a curved subsidiary portion which fixes the back of the cover body into an optional form in a region on a front cover side and a region on a back cover side of the spine portion 16 between the front cover portion 12 and the back cover portion 14.

As shown in FIGS. 56 through 58, the font folding portion 24 and the back folding portion 26 crossing from the top edge to the bottom edge are formed adjacent to the front connecting portion 20 and the back connecting portion 22 of the front cover portion 12, the back cover portion 14 and the spine portion 16, and the grip portion 28 is formed in the region from the front folding portion 24 on the front cover portion 12 to the spine portion 16, the region from the back folding portion 26 on the back cover portion 14 to the spine portion 16 and the spine portion 16.

In grip portion 28, the connecting portion on a front cover side 652 having the front folding portion 24 as an axis sways upwardly in the region on the spine portion 16 on the front cover side between the front cover portion 12 and the back cover portion 14, and the connecting portion on a back cover side 654 having the back folding portion 26 as an axis sways upwardly and the grip portion 28 forms the curved subsidiary portion which enables a connecting portion 650 as a curved subsidiary portion to arch toward the direction of the pocket sheet 18 as the binding sheet extending, i.e. toward the direction away from the spine portion 16, when the front cover portion 12 and the back cover portion 14 become substantially horizontal, and the grip portion 28 becomes parallel to the horizontal spine portion 16.

On the front cover portion 12 and the back cover portion 14, the front folding portion 24 and the back folding portion 26 are formed parallel to the front adjacently providing portion 20 and the back adjacently providing portion 22 in the direction of their heights from the top edge to the bottom edge thereof adjacent to the front adjacently providing portion 20 and the back adjacently providing portion 22.

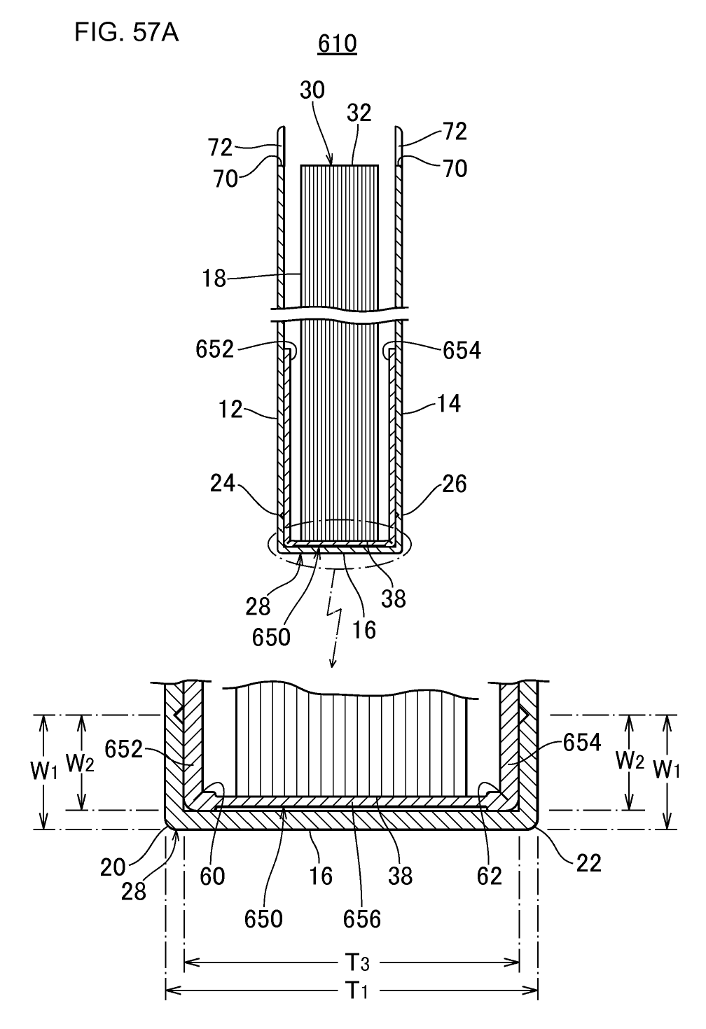

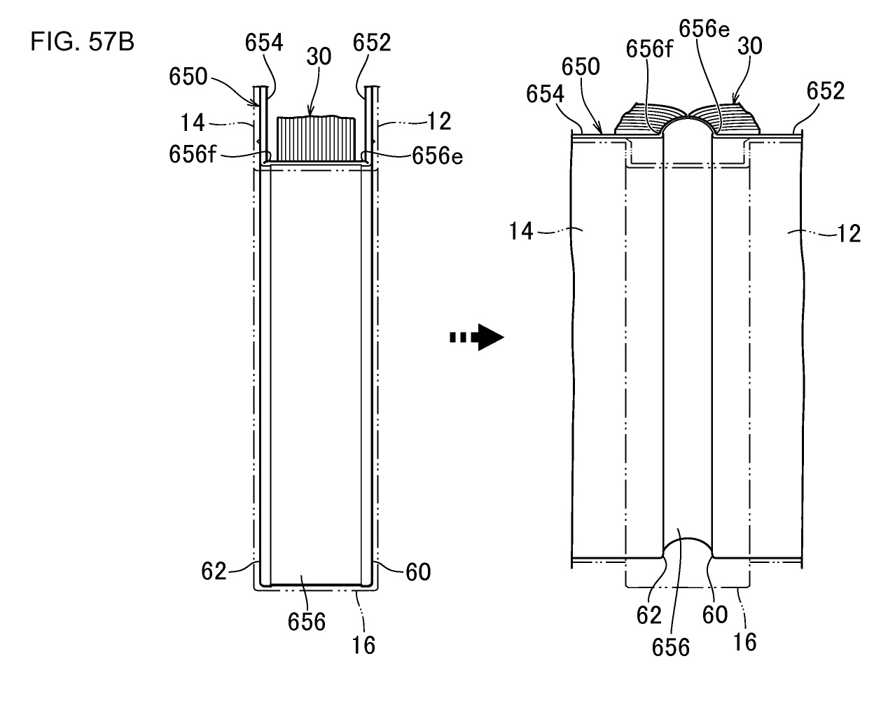

The length of the inner face of the spine portion 16 and the front folding portion 24 and the length of the inner face of the spine portion 16 and the back folding portion 26 are formed to be equal (shown in FIG. 57A).

The mount 42 is provided such that the front folding portion 24 and the back folding portion 26 do not present adjacent to the mount 42.

The group of pocket sheets 30 is connected by the end edge connected thereto and the connecting portion 650 connecting the front cover portion 12 and the back cover portion 14.

The connecting body 650 is comprised of substantially square rigid plate body in a planar view composed of thermoplastic synthetic resin and comprises the curved retaining portion which curves the group of pocket sheets 30 as the binding body, welded and connected at the connecting end edge of the group of pocket sheets 30 as the binding body, toward the direction of the pocket sheet 18 as the binding body extending.

The connecting body 650 is connected adjacent to the front folding portion 24 of the front cover portion 12 and the back folding portion 26 of the back cover portion 14 with optionally spaced from the group of the pocket sheets 30 in the cross direction such that the connecting body 650 enables the end edge connected to the cover of the group of pocket sheet 30 to curve with the width shorter than the width of the spine portion 16 of the cover body.

The connecting body 650 comprises the connecting portion on the front cover side 652 connected to the side of the front cover portion 12, the connecting portion on the back cover side 654 connected to the side of the back cover portion 14 and an interjacent connecting portion 656 interposing between the connecting portion on the front cover side 652 and the connecting portion on the back cover side 654. The interjacent connecting portion 656 is connected to the end edge connected to the cover of the group of pocket sheets 30 and is formed to curve toward the opposite side of the spine portion 16 along with the end edge connected to the cover of the group of the pocket sheets 30 by the tension of the connecting portion on the front cover side 652 and the connecting portion on the back cover side 654 when opened the cover.

The interjacent connecting portion 656 of the connecting body 650 has the thickness thereof thinner than the connecting portion on the front cover side 652 and the connecting portion on the back cover side 654 so that the interjacent connecting portion 656 has flexibility and is formed to arch toward the side of the pocket sheet 18 as the binding sheet extending, i.e. toward the opposite side of the spine portion 16, by the weight of the pocket sheet 18 being in a spread state.

In this embodiment, plastically deform the region, which comprises the connecting body 650, comprising the interjacent connecting portion 656 comprising of a synthetic resin sheet body having uniform thickness on the whole by hot press. By decreasing the thickness thereof, flexibility can be provided.

On the connecting body 650, the hinge portion on the front cover side 60 formed between the connecting portion on the front cover side 652 and the interjacent connecting portion 656 and the hinge portion on the back cover side 62 formed between the connecting portion on the back cover side 654 and the interjacent connecting portion 656 are formed parallel to each other.

On the interjacent connecting portion 656, a longitudinal bridge portion 656e is successively formed adjacent to the hinge portion on the front cover side 60 to cross from the top edge to the bottom edge of the interjacent connecting portion 656 and a longitudinal bridge portion 656f is successively formed adjacent to the hinge portion on the back cover side 62 to cross from the top edge to the bottom edge of the interjacent portion 656.

In this embodiment, the longitudinal bridge portions 656e and 656f have the substantially equivalent thickness to the connecting portion on the front cover side 652 and the connecting portion on the back cover side 654 and the portion between the longitudinal bridge portions 656e and 656f decreases the thickness thereof as described above.

The height between the spine portion 16 and the front folding portion 24 of the front cover portion 12 and the back folding portion 26 of the back cover portion 14 respectively is formed to be substantially equal or shorter than the height between the hinge portion on the front cover side 60 of the connecting body 650 and the inner surface of the front cover portion 12 and between the hinge portion on the back cover side 62 and the inner surface of the back cover portion 14. The hinge portion in the front cover side 60 and the hinge portion on the back cover side 62 are formed to position adjacent to the end edge of the spine portion 16 in cross direction when closed the cover.

The interjacent connecting portion 656 between the hinge portion on the front cover side 60 and the hinge portion on the back cover side 62 is formed to curve toward the opposite side of the spine portion 16 and also the width between the hinge portion on the front cover side 60 and the hinge portion on the back cover side 62 is formed to be shorter than the width of the spine portion 16 when opened the front cover portion 12.

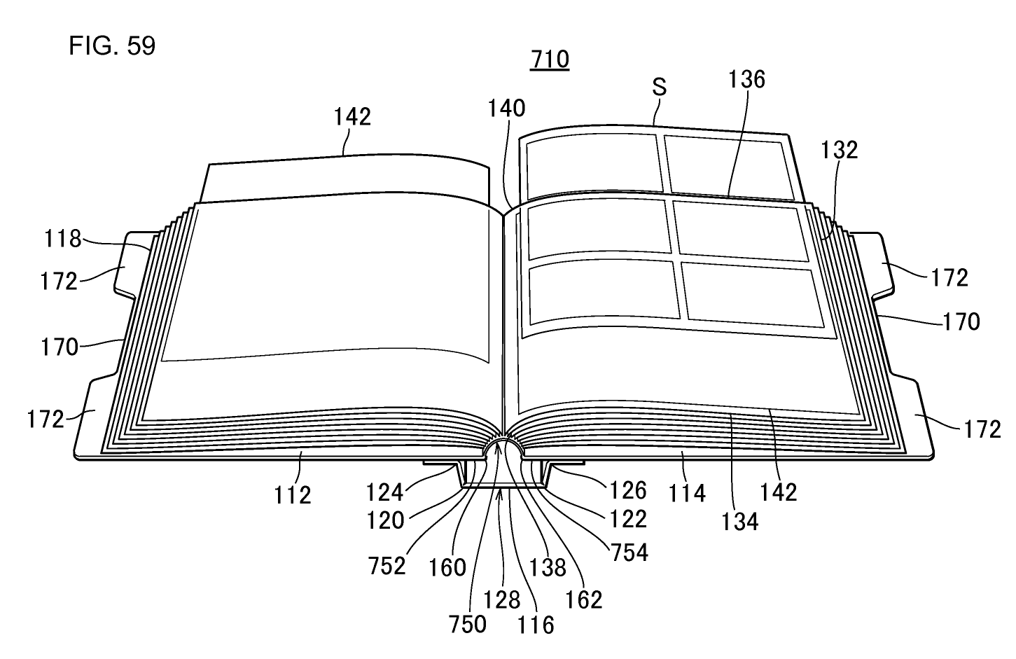

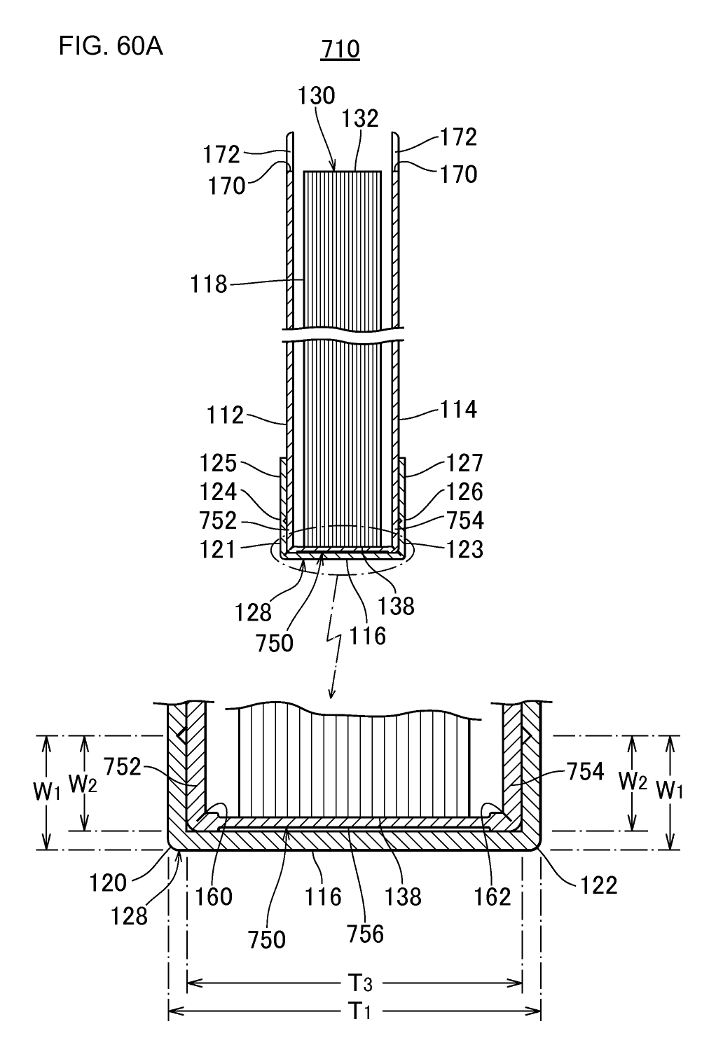

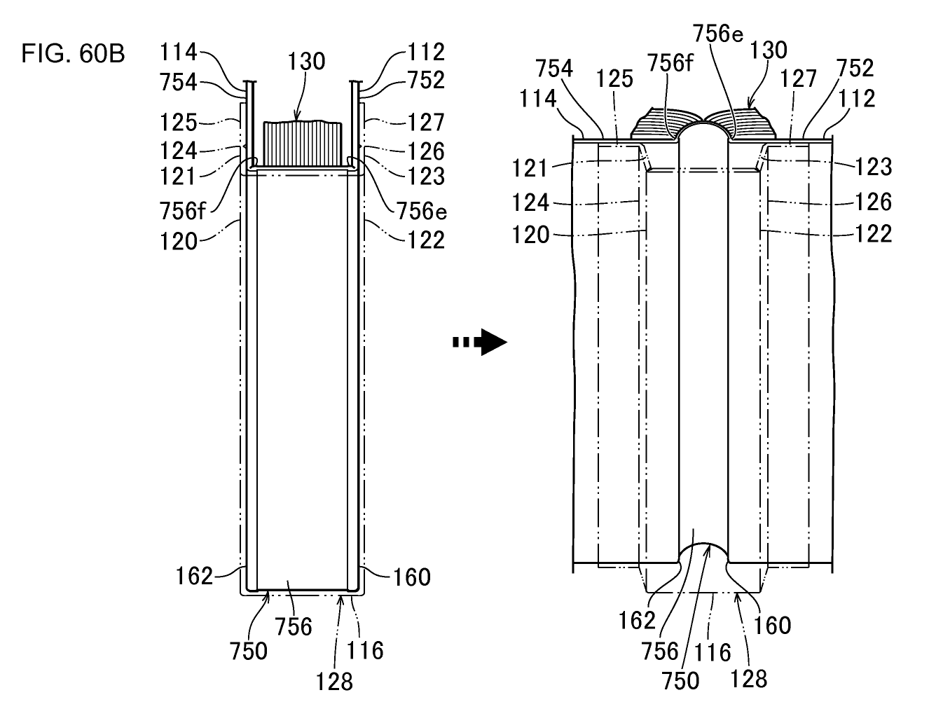

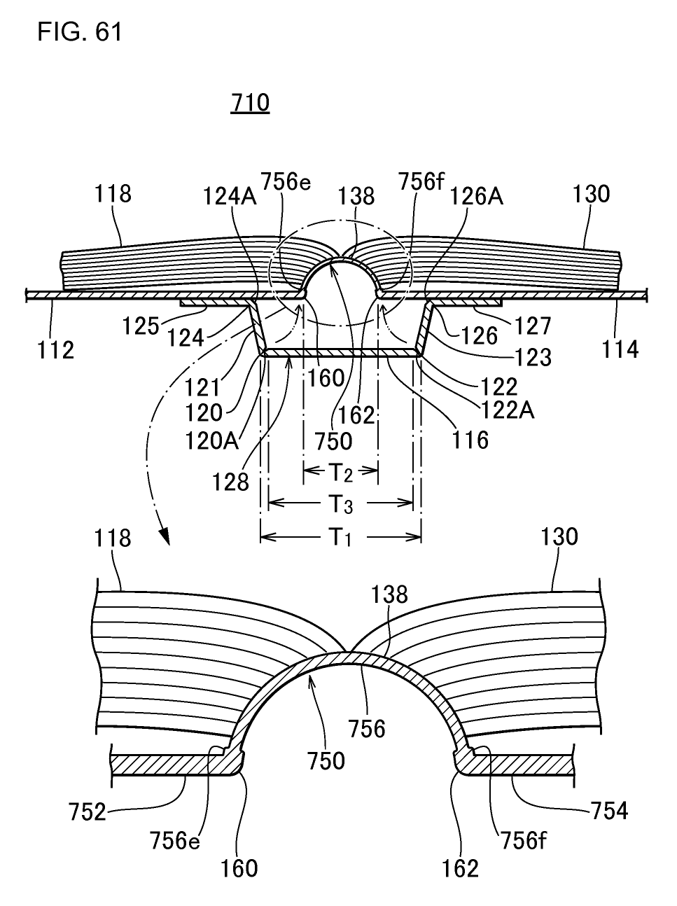

The pocket file shown in FIG. 21 can be altered as shown in FIGS. 59 through 61.

A file 710 comprises a curved subsidiary portion which fixes the back of the cover body into an optional form in regions on a front cover side and on a back cover side of the spine portion 116 between the front cover portion 112 and the back cover portion 114 and the curved retaining portion formed to curve the end edge of the group of pocket sheets 130 as the binding body toward the direction of the pocket sheet 118 as the binding sheet extending at the inner side of the spine portion 116 adjacently provided between the front cover portion 112 and the back cover portion 114 when opened the cover body. In this altered example, the curved subsidiary portion comprised as an independent curved subsidiary member 128 is equivalent to the pocket file shown in FIG. 21.

A curved retaining portion 750 is connected adjacent to the inner side of the hinge portion on the front cover side 160 and the inner side of the hinge portion on the back cover side 162 with optionally spaced from the group of the pocket sheets 130 in the cross direction such that the curved retaining portion 750 enables the end edge connected to the cover of the group of pocket sheet 130 to curve with the width shorter than the width of the spine portion 116 of the cover body.

The curved retaining portion 750 comprises a connecting portion on a front cover side 752 adjacently provided in the side of the front cover portion 112, a connecting portion on a back cover side 754 adjacently provided in the side of the back cover portion 114 and an interjacent connecting portion 756 lying between the connecting portion on the front cover side 752 and the connecting portion on the back cover portion 754. The interjacent connecting portion 756 is connected to the end edge connected to the cover of the group of pocket sheets 130 and is formed to curve toward the opposite side of the spine portion 116 along with the end edge connected to the cover of the group of the pocket sheets 130 by the tension of the connecting portion on the front cover side 752 and the connecting portion on the back cover side 754 when opened the cover.

The curved retaining portion 750 is relatively flexible and is formed to arch toward the opposite side of the spine portion 116 by the weight of the pocket sheet 118 being in a spread state.

The curved retaining portion 750 comprises of a thermoplastic synthetic resin sheet body in a square planar shape having uniform thickness on the whole and is formed to curve by decreasing the thickness of the region connected to the group of pocket sheets 130 as the binding body so that flexibility can be provided.

In this embodiment, plastically deform the region, which comprises the connecting body 750, comprising the interjacent connecting portion 756 comprising of a synthetic resin sheet body having uniform thickness on the whole by hot press. By decreasing the thickness thereof, flexibility can be provided.

The curved retaining portion 750 is formed to arch toward the side of the pocket sheet 118 as the binding sheet extending, i.e. toward the opposite side of the spine portion 116, by the weight of the pocket sheet 118 being in a spread state.

On the curved retaining portion 750, the hinge portion on the front cover side 160 formed between the connecting portion on the front cover side 752 and the interjacent connecting portion 756 and the hinge portion on the back cover side 162 formed between the connecting portion on the back cover side 754 and the interjacent connecting portion 756 are formed parallel to each other.

On the interjacent connecting portion 756, a longitudinal bridge portion 756e is successively formed adjacent to the hinge portion on the front cover side 160 to cross from the top edge to the bottom edge of the interjacent connecting portion 756 and a longitudinal bridge portion 756f is successively formed adjacent to the hinge portion on the back cover side 162 to cross from the top edge to the bottom edge of the interjacent portion 756.

In this embodiment, the longitudinal bridge portions 756e and 756f have the substantially equivalent thickness to the connecting portion on the front cover side 752 and the connecting portion on the back cover side 754 and the portion between the longitudinal bridge portions 756e and 756f decreases the thickness thereof as described above.

The height between the spine portion 116 and the front folding portion 124 of the front cover portion 112 and the back folding portion 26 of the back cover portion 114 respectively is formed to be substantially equal or shorter than the height between the hinge portion on the front cover side 160 of the curved retaining portion 750 and the inner surface of the front cover portion 112 and between the hinge portion on the back cover side 162 and the inner surface of the back cover portion 114. The hinge portion in the front cover side 160 and the hinge portion on the back cover side 162 are formed to position adjacent to the end edge of the spine portion 116 in cross direction when closed the cover body.

The interjacent connecting portion 756 between the hinge portion on the front cover side 160 and the hinge portion on the back cover side 162 is formed to curve toward the opposite side of the spine portion 116 and also the width between the hinge portion on the front cover side 160 and the hinge portion on the back cover side 162 is formed to be shorter than the width of the spine portion 116 when opened the front cover portion 112.

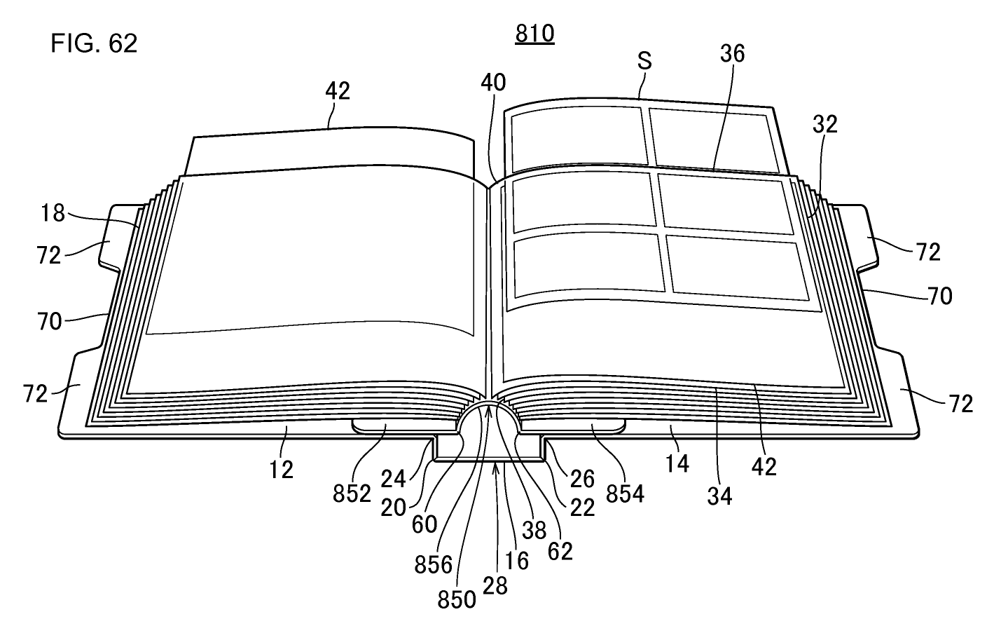

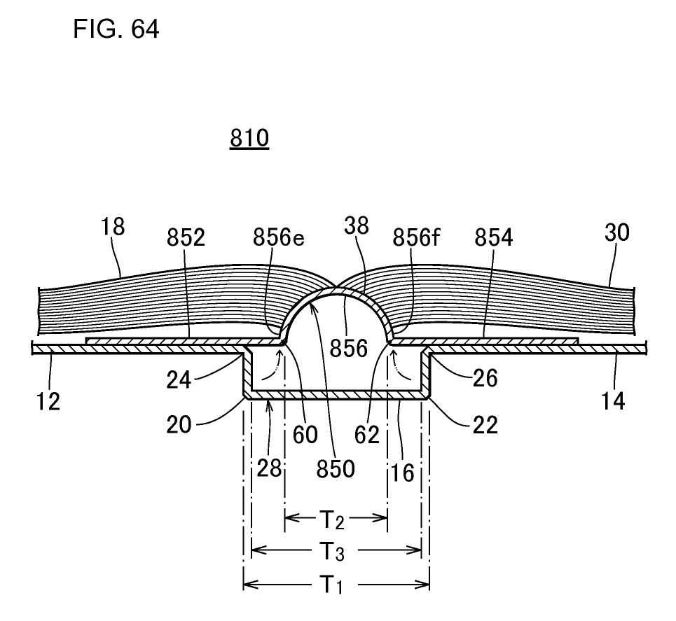

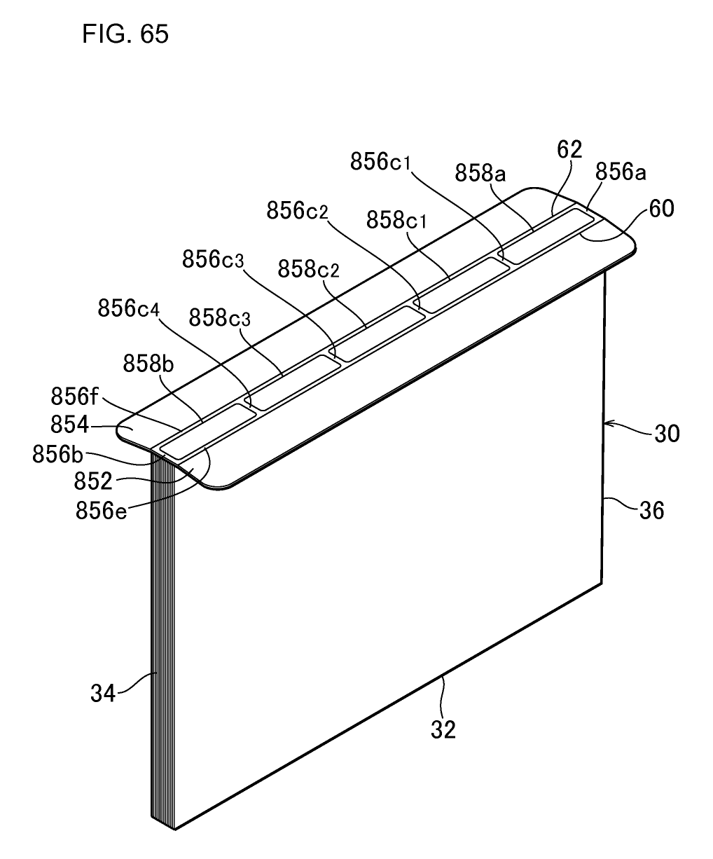

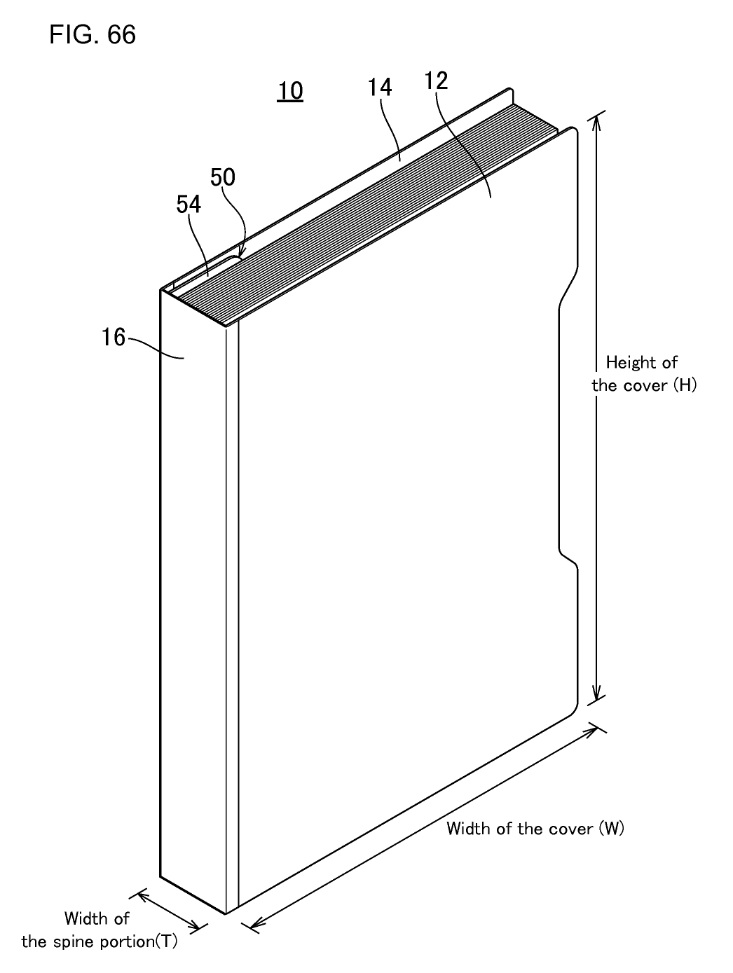

The pocket file shown in FIG. 1 can be altered as shown in FIGS. 62 through 64.

A file 810 comprises a curved retaining portion formed to curve the end edge of the group of pocket sheets 30 as the binding body toward the side of the pocket sheet 18 as the binding sheet extending at the inner side of the spine portion 16 adjacently provided between the front cover portion 12 and the back cover portion 14 when opened the cover and also comprises a curved subsidiary portion which fixes the back of the cover body into an optional form in a region on a front cover side and a region on a back cover side of the spine portion 16 between the front cover portion 12 and the back cover portion 14.

As shown in FIGS. 62 through 64, the font folding portion 24 and the back folding portion 26 crossing from the top edge to the bottom edge are formed adjacent to the front connecting portion 20 and the back connecting portion 22 of the front cover portion 12, the back cover portion 14 and the spine portion 16, and the grip portion 28 is formed in the region from the front folding portion 24 on the front cover portion 12 to the spine portion 16, the region from the back folding portion 26 on the back cover portion 14 to the spine portion 16 and the spine portion 16.

In grip portion 28, the connecting portion on a front cover side 852 having the front folding portion 24 as an axis sways upwardly in the region on the spine portion 16 on the front cover side between the front cover portion 12 and the back cover portion 14, and the connecting portion on a back cover side 854 having the back folding portion 26 as an axis sways upwardly and the grip portion 28 forms the curved subsidiary portion which enables a connecting portion 850 as a curved subsidiary portion to arch toward the direction of the pocket sheet 18 as the binding sheet extending, i.e. toward the direction away from the spine portion 16, when the front cover portion 12 and the back cover portion 14 become substantially horizontal, and the grip portion 28 becomes parallel to the horizontal spine portion 16.

On the front cover portion 12 and the back cover portion 14, the front folding portion 24 and the back folding portion 26 are formed parallel to the front adjacently providing portion 20 and the back adjacently providing portion 22 in the direction of their heights from the top edge to the bottom edge thereof adjacent to the front adjacently providing portion 20 and the back adjacently providing portion 22.

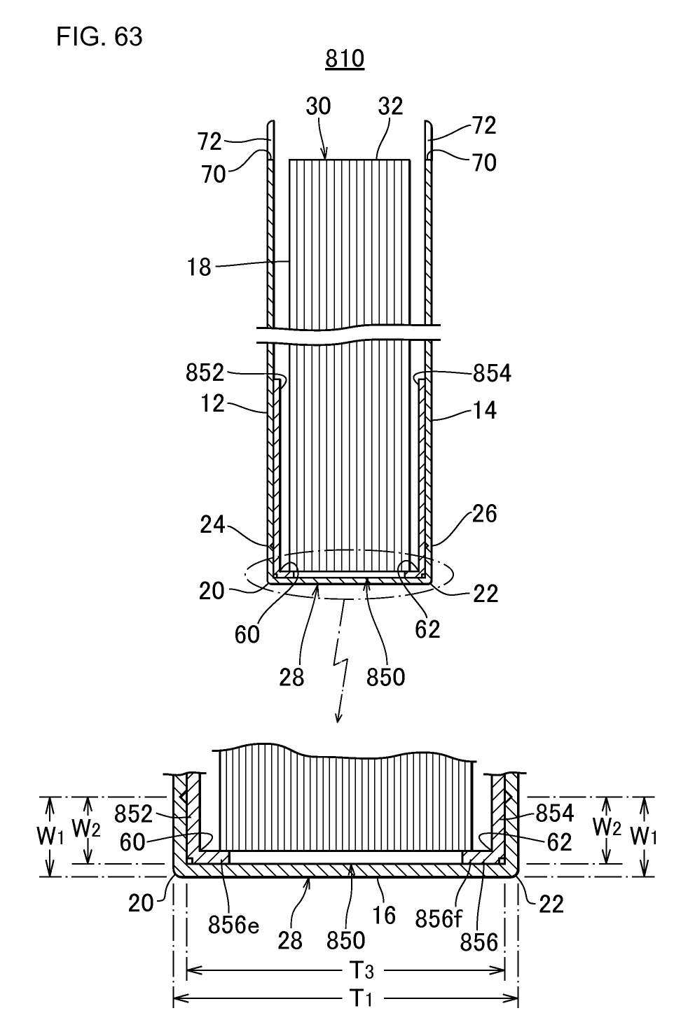

The length of the inner face of the spine portion 16 and the front folding portion 24 and the length of the inner face of the spine portion 16 and the back folding portion 26 are formed to be equal (shown in FIG. 63).

The mount 42 is provided such that the front folding portion 24 and the back folding portion 26 do not present adjacent to the mount 42.

The group of pocket sheets 30 is connected by the end edge connected thereto and the connecting portion 850 connecting the front cover portion 12 and the back cover portion 14.

The connecting body 850 is comprised of substantially square rigid plate body in a planar view composed of thermoplastic synthetic resin and comprises the curved retaining portion which curves the group of pocket sheets 30 as the binding body, welded and connected at the connecting end edge of the group of pocket sheets 30 as the binding body, toward the direction of the pocket sheet 18 as the binding body extending.

The connecting body 850 is connected adjacent to the front folding portion 24 of the front cover portion 12 and the back folding portion 26 of the back cover portion 14 with optionally spaced from the group of the pocket sheets 30 in the cross direction such that the connecting body 650 enables the end edge connected to the cover of the group of pocket sheet 30 to curve with the width shorter than the width of the spine portion 16 of the cover body.

The connecting body 850 comprises the connecting portion on the front cover side 852 connected to the side of the front cover portion 12, the connecting portion on the back cover side 854 connected to the side of the back cover portion 14 and an interjacent connecting portion 856 interposing between the connecting portion on the front cover side 852 and the connecting portion on the back cover side 854. The interjacent connecting portion 856 is connected to the end edge connected to the cover of the group of pocket sheets 30 and is formed to curve toward the opposite side of the spine portion 16 along with the end edge connected to the cover of the group of the pocket sheets 30 by the tension of the connecting portion on the front cover side 852 and the connecting portion on the back cover side 854 when opened the cover.

The interjacent connecting portion 856 is relatively flexible and is formed to arch toward the side of the pocket sheet 18 as the binding sheet extending, i.e. toward the opposite side of the spine portion 16, by the weight of the pocket sheet 18 being in a spread state.

The connecting body 850 has a through hole 858 drilled in the region connected to the binding body and is formed to curve.

The connecting body 850 has a plurality of the rectangular planar shaped through holes 858 drilled which are optionally spaced from one another and flexibility is provided thereto on the whole. In this embodiment, there are 5 through holes drilled, an upper through hole 858a, a lower through hole 858b, middle through holes 858c1, 858c2 and 858c3.

In this embodiment, in the interjacent connecting portion 856, bridge portions 856a and 856b as a pair are crosslinked between the connecting portion on the front cover side 852 and the connecting portion on the back cover side 854 at the upper edge and the lower edge respectively. A bridge portion 856c1 is crosslinked between the upper through hole 858a and the middle through hole 858c1 and a bridge portion 856c4 is crosslinked between the middle through hole 858c3 and the lower through hole 858b and the bridge portion 856c4 is crosslinked in between the middle through hole 858c3 and the lower through hole 858b; therefore, the adhesion region of the interjacent connecting portion 856 and the group of pocket sheets 30 is formed.

Further, a longitudinal bridge portion 856e is formed between the hinge portion on the front cover side 60 and the upper through hole 858a, the lower through hole 858b and the middle through holes 858c1, 858c2 and 858c3, and a longitudinal bridge portion 856f is formed between the hinge portion on the back cover side 62 and the upper through hole 858a, the lower through hole 858b and the middle through holes 858c1, 858c2 and 858c3.

On the connecting body 850, the hinge portion on the front cover side 60 formed between the connecting portion on the front cover side 852 and the interjacent connecting portion 856 and the hinge portion on the back cover side 62 formed between the connecting portion on the back cover side 854 and the interjacent connecting portion 856 are formed parallel to each other.

The height between the spine portion 16 and the front folding portion 24 of the front cover portion 12 and the back folding portion 26 of the back cover portion 14 respectively is formed to be substantially equal or shorter than the height between the hinge portion on the front cover side 60 of the connecting body 850 and the inner surface of the front cover portion 12 and between the hinge portion on the back cover side 62 and the inner surface of the back cover portion 14. The hinge portion in the front cover side 60 and the hinge portion on the back cover side 62 are formed to position adjacent to the end edge of the spine portion 16 in cross direction when closed the cover.

The interjacent connecting portion 856 between the hinge portion on the front cover side 60 and the hinge portion on the back cover side 62 is formed to curve toward the opposite side of the spine portion 16 when opened the front cover portion 12 and also the width between the hinge portion on the front cover side 60 and the hinge portion on the back cover side 62 is formed to be shorter than the width of the spine portion 16.

The connecting portion on the front cover side 852 and the interjacent connecting portion 856 adjacently providing the hinge portion on the front cover side 60 in between bisect at substantially right angles to retain the shape when load is not applied and also the connecting portion on the back cover side 854 and the interjacent connecting portion 856 adjacently providing the hinge portion on the back cover side 62 in between bisect at substantially right angles to retain the shape when load is not applied. When the connecting portion on the front cover side 852 side or the connecting portion on the back cover side 854 side opens corresponding when opened the front cover portion 12 or the back cover portion 14, degree of the angle between the interjacent connecting portion 856 and the connecting portion on the front cover side 852 expands, and the angle between the interjacent connecting portion 856 and the connecting portion on the back cover side 854 expands. When the expansion of those angles become substantially 120 to 130 degrees, and the connecting portion 850 is lifted toward the direction away from the spine portion 16 with the elasticity of the material comprising the connecting portion 850 and the elasticity adjacent to the both ends of the hinge portion on the front cover side 60 and the hinge portion on the back cover side 62 of the both sides.

While preferred embodiments of the present invention have been described above, it is to be understood that variations and modifications will be apparent to those skilled in the art without departing the scope and spirit of the present invention. The scope of the present invention, therefore, is to be determined solely by the following claims.

What is claimed is:

1. A file comprising:
a binding body which is superimposed with a plurality of binding sheets;
a curved retaining portion which is curved toward the direction of the pocket sheets as the binding body extending adhered and connected on the end edge of a group of pocket sheets as the binding body when opened the cover; and
a curved subsidiary portion which fixes its back into an optional form in a region on a front cover side and a region on a back cover side of a spine portion between the front cover portion and the back cover portion; and wherein
the binding body is adjacently provided to the curved retaining portion by forming an arch-shape toward the direction of a front cover portion and back cover portion extending from the inner side of the spine portion; and wherein
the curved retaining portion is connected with the width shorter than the width of the spine portion to the inner side of the curved subsidiary portion at the outer side of the curved retaining portion to enable the end edge adjacently provided on the binding body to curve.

2. The file according to claim 1, wherein the binding body is superimposed with a plurality of binding sheets and connected on the end edge which is connected to the front cover, wherein
the curved retaining portion comprises a front cover portion connected to the binding body between the front cover portion and the back cover portion, wherein
the cover body forms a hinge portion between the front cover side and the back cover side, wherein
said binding body is formed for the end edge of the group of pocket sheets as the binging body connected to the cover body to curve toward the side of the binding sheets extending when opened the cover body, and wherein
said curved subsidiary portion is optionally spaced from the binding body in the cross direction and connected with the width shorter than the width of the spine portion at the outer side of the hinge portion of said front cover portion and the hinge portion of said back cover portion to enable the end edge of the binding body which is connected to the cover to curve.

3. The file according to claim 2, wherein said curved retaining portion comprises: the hinge portion on the front cover side adjacently provided on the front cover portion; the hinge portion on the back cover side adjacently provided on the back cover portion; and an interjacent connecting portion interposing between said hinge portion on the front cover side and said hinge portion on the back cover side, and wherein
said intervenient assembly is formed to curve toward the direction of the binding sheets extending along with the end edge of the binging body connected to the cover by its weight when opened the cover body.

4. The file according to claim 1, wherein said curved retaining portion comprises the hinge portion on the front cover side connected to the front cover portion, the hinge portion on the back cover side connected to the back cover portion and the interjacent connecting portion interposing between the hinge portion on said front cover side and the hinge portion on said back cover side; and wherein
the region on the front cover side leading to the hinge portion on the front cover side and the region on the back cover side leading to the hinge portion on the back cover side bisect at substantially right angles to the interjacent connecting portion when load is not applied and form the interjacent connecting portion toward the direction of the binding sheets as to be lifted with the elasticity adjacent to the hinge portion on the front cover side and the hinge portion on the back cover side when opened the cover.

5. The file according to claim 2, wherein the height between a folding portion of said curved subsidiary portion and the back cover portion is formed substantially the equal or shorter than the height between the hinge portion on the front cover side of said curved retaining portion and the inner surface of the curved subsidiary portion and between the hinge portion on the back cover side and the inner surface of the curved subsidiary portion, wherein
the hinge portion on the front cover side and the hinge portion on the back cover side are positioned adjacent to the end edge in the cross direction of the back cover portion when closed the cover body, wherein
the interjacent connecting portion interposing between the hinge portion on the front cover side and the hinge portion on the back cover side is formed to curve toward the opposite side of the back cover portion when opened the cover body and also the width of between the hinge portion on the front cover side and the hinge portion on the back cover side is formed to be shorter than the width of the back cover portion.

6. The file according to claim 1, wherein the interjacent connecting portion of the curved retaining portion is deformed plastically by hot press onto a synthetic resin sheet body and comprises to be bestowed flexibility by reducing its thickness.

7. The file according to claim 1, wherein the binding body superimposes the plurality of binding sheets and is connected on the end edge which is connected to the cover, wherein
the curved retaining portion is comprised of the end edge connected to said binding body and a connecting body connecting the cover, wherein
the cover body has the front cover portion, the back cover portion and the spine portion between said front cover portion and said back cover portion, forms the folding portion formed to be optionally spaced from the spine portion between the front cover portion and the back cover portion, and in the cover body, the binding sheets are connected via said connecting body and the curved subsidiary portion is comprised between the folding portion and the spine portion and in the spine portion, wherein
said binding body is formed to curve along the end edge of the binging body connected to the cover toward the direction of the binding sheets extending when opened the cover body, and wherein
said curved retaining portion is connected adjacent to the folding portion of said front cover portion and the folding portion of said back cover portion with optionally spacing from the binding body in the cross direction to enable the end edge connected to the cover of the binding body with the short width to curve.

8. The file according to claim 7, wherein the connecting body comprises a connecting portion on the front cover side connected to the side of the front cover portion, a connecting portion on the back cover side connected to the side of the back cover portion and the interjacent connecting portion interposing between said connecting portion on the front cover side and said connecting portion on the back cover side, wherein
said interjacent connecting portion connects the end edge connected to the cover of the binding body and is formed to curve toward the binding sheets extending along with the end edge connected to the cover of the binding body by tension of the connecting portion on the front cover side and the connecting portion on the back cover side when opened the cover body, and wherein
the hinge portion is formed between the connecting portion on the front cover side and the interjacent connecting portion and between the connecting portion on the back cover side and the interjacent connecting portion.

9. The file according to claim 7, wherein said connecting body comprises the connecting portion on the front cover side connected to the side of the front cover portion, the connecting portion on the back cover side connected to the side of the back cover portion and the interjacent connecting portion interposing between said connecting portion on the front cover side and the connecting portion on the back cover side, wherein
the hinge portion on the front cover side and the hinge portion on the back cover side are formed between the connecting portion on the front cover side and the interjacent connecting portion and between the connecting portion on the back cover side and the interjacent connecting portion, and wherein
the connecting portion on the front cover side leading to the hinge portion on the front cover side and the connecting portion on the back cover side leading to the hinge portion on the back cover side bisect at substantially right angles to the interjacent connecting portion when load is not applied and form the interjacent connecting portion toward the direction of the binding sheets as to be lifted with the elasticity adjacent to the hinge portion on the front cover side and the hinge portion on the back cover side when opened the cover.

10. The file according to claim 7, wherein the height between the folding portion of said front cover portion and the folding portion of said back cover portion is formed substantially the equal or shorter than the height between the hinge portion on the front cover side of said connecting body and the inner surface of the front cover portion and between the hinge portion on the back cover side and the inner surface of the back cover portion, wherein
the hinge portion on the front cover side and the hinge portion on the back cover side are positioned adjacent to the end edge in the cross direction of the back cover portion when closed the cover body, and wherein
the interjacent connecting portion between the hinge portion on the front cover side and the hinge portion on the back cover side is formed to curve toward the opposite side of the back cover portion when opened the cover body and also the width of between the hinge portion on the front cover side and the hinge portion on the back cover side is formed to be shorter than the width of the back cover portion.

11. The file according to claim 7, wherein the interjacent connecting portion of the binding body is deformed plastically by hot press onto a synthetic resin sheet body and comprises to be bestowed flexibility by reducing its thickness.

12. The file according to claim 1, wherein the binding sheets comprise pockets combined with thermoplastic resin sheets, wherein
each binding sheet is hot-adhered to another on the end edge connected to the cover thereof, and wherein
the end edge connected to the cover is formed to curve inwardly when opened the binding sheets.

13. The file according to claim 1, wherein said connecting body comprises the sheet body of rigid body comprising thermoplastic synthetic resin, has through-holes drilled in the region connected to the binding body, and is formed to curve.
